(19) United States
(12) Patent Application Publication
(10) Pub. No.: US 2025/0312725 A1
(43) Pub. Date: Oct. 9, 2025

(54) DIRECT AIR CAPTURE SYSTEM WITH CONTINUOUS CARBON-DIOXIDE ADSORPTION

(71) Applicant: 280 Earth, Inc., Palo Alto, CA (US)

(72) Inventors: Jacques Louis Gagne, Palo Alto, CA (US); Amanda Marie Rampertab, Palo Alto, CA (US); Amy Qian, Palo Alto, CA (US); Anand Saxena, Palo Alto, CA (US); Bruce Allen Eisenhauer, JR., Palo Alto, CA (US); Chaokun Gong, Palo Alto, CA (US); Finn Carlsvi, Palo Alto, CA (US); Hannah Elizabeth Darst, Palo Alto, CA (US); Jeremy Aaron Willman, Palo Alto, CA (US); Kelly Scott Jewett, Palo Alto, CA (US); Kevin Wayne Seybert, Palo Alto, CA (US); Luuk Gerhard Henk Sasse, Palo Alto, CA (US); Melissa Marie Ortiz, Palo Alto, CA (US); Robert Harry Nelson, Palo Alto, CA (US); Zoanne Claire Zweber, Palo Alto, CA (US)

(73) Assignee: 280 Earth, Inc., Palo Alto, CA (US)

(21) Appl. No.: 19/098,965

(22) Filed: Apr. 2, 2025

Related U.S. Application Data
(60) Provisional application No. 63/574,219, filed on Apr. 3, 2024.
(60) Provisional application No. 63/730,967, filed on Dec. 12, 2024.

(51) Int. Cl. B01D 53/04; B01D 53/08

(52) U.S. Cl. CPC B01D 53/0407; B01D 53/08; B01D 2257/504

(57) ABSTRACT

An integrated system for adsorbing carbon dioxide (CO₂) in the air is described. The system includes: an adsorber that adsorbs the CO₂ from the air using a sorbent; and a desorber, coupled to the adsorber, that desorbs the adsorbed CO₂ from the sorbent (e.g., in an energy-efficient manner, such as without using steam) into an output of the system. In contrast with other approaches, the system may continuously move the sorbent, as an ensemble, through the system. Thus, the system may concurrently (and continuously) perform adsorption and desorption. Moreover, the sorbent may include a cost-effective and robust free-standing bulk solid. This may allow the sorbent to be used in multiple cycles or transits through the system. Furthermore, after the multiple cycles, the sorbent may be replaced while the system is operating, and the used sorbent may be recycled for subsequent reuse in the system.

### CROSS REFERENCE TO RELATED APPLICATIONS

This application claims priority under 35 U.S.C. 119 (e) to U.S. Provisional Application Ser. No. 63/730,967, entitled “Direct Air Capture System with Continuous Carbon-Dioxide Adsorption,” by Jacques Louis Gagne, et al., filed on Dec. 12, 2024, and to U.S. Provisional Application Ser. No. 63/574,219, entitled “Direct Air Capture System with Continuous Carbon-Dioxide Adsorption,” by Jacques Louis Gagne, et al., filed on Apr. 3, 2024, the contents of both of which are herein incorporated by reference.

### FIELD

The described embodiments relate to a direct air capture (DAC) system with continuous carbon-dioxide (CO₂) adsorption and desorption, and an associated method.

### BACKGROUND

While climate change includes the impacts of many sources, including long-term changes to the Earth's climate, ongoing natural disasters, projected extinctions and record average temperatures have focused attention on so-called global warming. In global warming, the global average temperature has increased more rapidly than previous natural causes because of fossil fuel and biomass use, deforestation, and agricultural and industrial practices. These human activities have increased the concentration of greenhouse gases (such as CO₂) in the atmosphere. Larger amounts of greenhouse gases trap more heat in the Earth's lower atmosphere, resulting in global warming.

In principle, global warming can be mitigated by reducing production of greenhouse gases. However, in practice, attempts at reducing annual greenhouse-gas production have often fallen short of targets. These challenges are compounded by the cost and complexity of removing carbon-dioxide emissions from the economy, which remains largely carbon-based. For example, in spite of extensive research, there are still many essential agricultural and industrial processes that output CO₂ into the atmosphere. Identifying and implementing replacements for these agricultural and industrial processes will take time and will entail significant expense.

Consequently, it is expected that attempts to address global warming will involve a wide variety of technologies and will entail a significant and sustained effort over many decades. An important subset of these technologies will likely include the ability to reduce the concentration of CO₂ in the atmosphere (which is sometimes referred to as ‘carbon capture and storage’ or ‘CCS’).

Existing approaches to CCS are often centered on so-called point sources, such as such as: large fossil fuel-based energy facilities, industries with major CO₂ emissions (e.g., cement production, steelmaking), natural gas processing, synthetic fuel plants and fossil fuel-based hydrogen production plants). This is because point sources have higher CO₂ concentrations, which makes CCS more efficient and cost-effective. While extracting CO₂ from the atmosphere (using membranes, oxyfuel combustion, absorption, multiphase absorption, adsorption, chemical looping combustion, calcium looping, cryogenic techniques, or direct air capture or DAC) is possible, the efficiency and cost of these approaches are typically uneconomical without significant subsidies. The absence of cost-effective and efficient atmospheric carbon-capture technology hinders efforts to address global warming.

### SUMMARY

Embodiments of a system are described. One of more features of the following embodiments may be used in the system, any of the components of the system, a computer system that controls the system, or the method, either separately or in combination.

A system for adsorbing CO₂ from air is described. This system includes: an adsorber that adsorbs the CO₂ from the air using a sorbent; and a desorber, coupled to the adsorber, that desorbs the adsorbed CO₂ from the sorbent into an output of the system. The system continuously moves the sorbent, as an ensemble, through the system. Moreover, the sorbent includes a free-standing bulk solid.

Note that the continuous motion may include steady-state operation of the system. Moreover, the continuous motion may exclude a batch process (e.g., adsorption followed by desorption). Furthermore, the system may perform multiple iterations of the adsorption and the desorption of the CO₂ without ceasing operation of the system, and a given iteration of the multiple iterations may include a cycle of transit of the sorbent, as the ensemble, through the system.

Additionally, the sorbent may not be included in a frame or a package (such as a filter).

In some embodiments, the desorber is separate from the adsorber.

Moreover, the sorbent may be other than or different from a liquid.

Furthermore, the adsorber may adsorb water from the air using the sorbent and the desorber may desorb the adsorbed water from the sorbent into the output. For example, the system may provide the water to a data center or for irrigation. Alternatively or additionally, the system may provide the water as potable water.

Additionally, the adsorber may include a gravity-flow packed bed that moves the sorbent in a direction having a vertical component while flowing the air at a non-zero angle to the direction (such as approximately) 90°. In some embodiments, the adsorber may include a distribution plate that spreads out the sorbent in the gravity-flow packed bed. Moreover, a flow of the sorbent through the gravity-flow packed bed may, at least in part, be controlled by a valve at a bottom of the gravity-flow packed bed. For example, the value may include a rotary valve or a flip valve.

Note that the desorber may include a device having a pressure other than atmospheric pressure. For example, the pressure may include between approximately 0.5 and 5 psi. However, in other embodiments, the pressure may exceed atmospheric pressure. Moreover, the device may be oriented along a vertical direction or a horizontal direction.

In some embodiments, the device may include, at an input to the device, an entry device that supports a differential pressure across the entry device and that allows the free-standing bulk solid pass through the entry device at a controlled rate and, at an output of the device, an output device that supports the differential pressure across the output device and that allows the free-standing bulk solid pass through the output device at the controlled rate. For example, the entry device or the output device may include an airlock. Note that the entry device or the output device may include: a vacuum double rotary disc, a Fetzer valve, a knife gate or a chamber lock. Moreover, the system may heat the sorbent in a first portion of the device to extract water and/or the adsorbed CO₂, and then may cool the sorbent in a second portion of the device.

Furthermore, the system may include a feed subsystem to convey the sorbent, as the ensemble, from an output of the desorber and to an input of the adsorber, and to convey the sorbent, as the ensemble, from an output of the adsorber to an input of the desorber. For example, the feed subsystem may include one or more conveyors (such as a bucket conveyor).

Additionally, the system may include: a storage buffer for extra sorbent for the adsorber (which may be proximate to an input of the adsorber and, more generally, is in the loop with the input of the adsorber); and a second storage buffer for extra sorbent for the desorber (which may be proximate to an input of the desorber and, more generally, is in the loop with the input of the desorber).

In some embodiments, the system may have a variable cycle time for the sorbent to transit through the system.

Note that the system may operate over a range of ambient temperatures greater than 10 C and a range of relative humidity (RH) greater than 7%. For example, the system may operate over ambient temperatures between −40 C and 55 C and relative humidity greater than 7%.

Moreover, the system may operate without environmental control or constraint. Furthermore, operating parameters of the system may be selected based at least in part on a predicted or forecast temperature, and/or a predicted or forecast relative humidity in an external environment of the system. Alternatively or additionally, the operating parameters of the system are selected based at least in part on current environmental conditions in the external environment of the system.

Additionally, after N cycles of the sorbent transiting, as the ensemble, through the system, where N is a non-zero integer, the sorbent may be replaced while the system is operating. The replaced sorbent may be recycled (or rejuvenated). For example, the recycled sorbent may be reused in the system. Alternatively or additionally, the recycled sorbent may be used as a water filter for amines.

In some embodiments, the sorbent may include a substrate and an amine. For example, the substrate may include: amorphous silica, alumina, zeolytes or a polymer. Alternatively or additionally, the sorbent may include: amorphous silica, amino silane and polyethylenimine (PEI), where, during the recycling, the PEI and the amino silane may be burned off and new PEI and amino silane may be coated on the amorphous silica. Note that the sorbent may include a cheylator, an antioxidant and a cross-linker and, during the recycling, a new cheylator, a new antioxidant and a new cross-linker may be coated on the amorphous silica.

Inputs to the system may include the air and electricity, and outputs from the system may include water and the CO₂. Moreover, the inputs may include thermal energy. For example, the thermal energy may be associated with a geothermal source. Alternatively or additionally, the thermal energy may be input from a separate source than the system (such as an industrial process). Note that the thermal energy may be input from a heat pump or heat bags (which are sometimes referred to as ‘solar bags’).

In some embodiments, the system may be used to cool the industrial process. For example, the system may be used instead of cooling towers. Alternatively or additionally, the system may provide cooling to a data center. Note that the system may cool solar panels based at least in part on an operating efficiency of the solar panels.

Moreover, the CO₂ in the output may be sequestered. Alternatively or additionally, the CO₂ in the output may be used to create synthetic fuel, concrete and/or fertilizer. In some embodiments, the CO₂ in the output may be input to a greenhouse.

Furthermore, the free-standing bulk solid may have or may include particles having an irregular or asymmetric shape.

Additionally, a sorbent lifetime may correspond to: a particle size distribution of the free-standing bulk solid, a number of cycles of the sorbent, as the ensemble, transiting the system before the sorbent is replaced or recycled, an amount of sorbent in the system, and/or a material composition of the sorbent.

Note that an amount of CO₂ in the output may be based at least in part on: airflow through the sorbent, a residence time that the sorbent, as the ensemble, is in contact with the air, kinetics of the sorbent (and, thus, the sorbent composition), a material composition of the sorbent, a distribution of particle sizes in the sorbent, a pressure drop in the adsorber, thermal transfer in the system, a lifetime of the sorbent, and/or a concentration of the CO₂ in the air. In some embodiments, the amount of CO₂ in the output also depends on the temperature and/or the relative humidity of the air.

In some embodiments, a concentration of the CO₂ in the air is an ambient concentration or is larger than the ambient concentration. For example, the air may be input from a point source.

Note that the adsorbed CO₂ may be desorbed in the system without applying heat to generate steam for use in the desorption.

Moreover, contact between the sorbent and the air in the system may only occur in the adsorber.

Furthermore, the system may operate without start or stop operations while capturing the CO₂ in the air.

Additionally, the system may have a modular design with shared common components, where the shared common components may exclude the adsorber and the desorber.

In some embodiments, the system may include an integrated filtration filter.

Note that the system may include modified off-the-shelf components, where the modified off-the-shelf components may include at least some common components in the system that are shared in the modular design.

Moreover, the system may preheat water used for desorbing the adsorbed CO₂ based at least in part on a price of electricity at off-peak hours or at night.

Furthermore, the desorber may operate at or below approximately 80 C or 100 C.

Additionally, when in contact with air, the sorbent temperature may be approximately less than 50 C.

In some embodiments, the system may have scheduled and preemptive maintenance following operation for a predefined time interval and the predefined time interval may be at least 50 weeks (without start or stop operations). For example, the scheduled and preemptive maintenance may include two weeks.

Note that the system may include a first heat pump and a second heat pump that circulate heat (or thermal energy) in the system. The first heat pump may upgrade a first heat to a second heat, and the second heat pump may upgrade a third heat to a fourth heat. A difference of the fourth heat and the third heat may be larger than a difference of the second heat and the first heat. In some embodiments, the system may selectively use the first heat pump and/or the second heat pump based at least in part on availability of input thermal energy to the system, a temperature of the input thermal energy, and/or a price of electricity.

Moreover, the CO₂ in the output may have a purity exceeding 99% and an impurity in the output may include air and/or water.

Furthermore, the system may use different types of sorbent having different material properties based at least in part on environmental conditions in an environment of the system.

Another embodiment provides a computer system (which includes one or more computers) for use with the system, e.g., a cloud-based computer system. This computer system may perform counterpart operations to at least some of the aforementioned operations of the system. For example, the computer system may configure and/or manage the system, such as determining, selecting and/or indicating the operating parameters of the system.

Another embodiment provides a computer-readable storage medium for use with the system or the computer system. When executed by the system or the computer system, this computer-readable storage medium causes the system or the computer system to perform at least some of the aforementioned operations or the counterpart operations.

Another embodiment provides a method, which may be performed by the system or the computer system. This method includes at least some of the aforementioned operations or the counterpart operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a block diagram illustrating an example of a system in accordance with an embodiment of the present disclosure.

FIG. 3 is a block diagram illustrating an example of an adsorber in the system of FIG. 1 or 2 in accordance with an embodiment of the present disclosure.

FIG. 4 is a block diagram illustrating an example of a desorber in the system of FIG. 1 in accordance with an embodiment of the present disclosure.

FIG. 5 is a block diagram illustrating an example of heat flow in the system of FIG. 1 or 2 in accordance with an embodiment of the present disclosure.

FIG. 6 is a block diagram illustrating an example of heat flow in the system of FIG. 1 or 2 in accordance with an embodiment of the present disclosure.

FIG. 7 is a block diagram illustrating an example of heat flow in the system of FIG. 1 or 2 in accordance with an embodiment of the present disclosure.

FIG. 8A is a block diagram illustrating an example of a modular design of the system of FIG. 1 or 2 in accordance with an embodiment of the present disclosure.

FIG. 8B is a block diagram illustrating an example of a modular design of the system of FIG. 1 or 2 in accordance with an embodiment of the present disclosure.

FIG. 9 is a block diagram illustrating an example of a computer system in accordance with an embodiment of the present disclosure.

FIG. 10 is a block diagram illustrating an example of a neural network in accordance with an embodiment of the present disclosure.

FIG. 11 is a flow diagram illustrating an example of a method for adsorbing CO₂ from air in accordance with an embodiment of the present disclosure.

FIG. 12 is a block diagram illustrating an example of the system of FIG. 1 or 2 in accordance with an embodiment of the present disclosure.

FIG. 13 is a block diagram illustrating an example of a sorbent flow loop between an adsorber and a desorber in the system of FIG. 1 or 2 in accordance with an embodiment of the present disclosure.

FIG. 14 is a block diagram illustrating an example of a perspective view of an adsorber in the system of FIG. 1 or 2 in accordance with an embodiment of the present disclosure.

FIG. 15 is a block diagram illustrating an example of a side view of an adsorber in the system of FIG. 1 or 2 in accordance with an embodiment of the present disclosure.

FIG. 16 is a block diagram illustrating an example of a heat exchanger in the system of FIG. 1 or 2 in accordance with an embodiment of the present disclosure.

FIG. 17 is a block diagram illustrating an example of sorbent flow in the system of FIG. 1 or 2 in accordance with an embodiment of the present disclosure.

FIG. 18 is a block diagram illustrating an example of a gravity-feed packed bed in the adsorber in the system of FIG. 1 or 2 in accordance with an embodiment of the present disclosure.

FIG. 19 is a block diagram illustrating an example of a baghouse fan and stack in the system of FIG. 1 or 2 in accordance with an embodiment of the present disclosure.

FIG. 20 is a block diagram illustrating an example of sorbent flow in the desorber in the system of FIG. 1 or 2 in accordance with an embodiment of the present disclosure.

FIG. 21 is a block diagram illustrating an example of a plate bank in the desorber in the system of FIG. 1 or 2 in accordance with an embodiment of the present disclosure.

FIG. 22 is a drawing illustrating an example of an entry device or an output device in the desorber in the system of FIG. 1 or 2 in accordance with an embodiment of the present disclosure.

FIG. 23 is a drawing illustrating an example of operation of an entry device or an output device in the desorber in the system of FIG. 1 or 2 in accordance with an embodiment of the present disclosure.

FIG. 24 is a drawing illustrating an example of operation of an entry device or an output device in the desorber in the system of FIG. 1 or 2 in accordance with an embodiment of the present disclosure.

FIG. 25 is a drawing illustrating an example of pressure drop as a function of superficial gas velocity of a sorbent in accordance with an embodiment of the present disclosure.

FIG. 26 is a drawing illustrating an example of aerated bulk density as a function of superficial gas velocity of a sorbent in the system of FIG. 1 or 2 in accordance with an embodiment of the present disclosure.

FIG. 27 is a drawing illustrating an example of gravity-flow packed-bed pressure drop per unit bed height as a function of superficial gas velocity of the sorbent in the system of FIG. 1 or 2 in accordance with an embodiment of the present disclosure.

FIG. 28 is a drawing illustrating a theoretical example of mass-flow behavior of a sorbent in a gravity-flow packed bed in accordance with an embodiment of the present disclosure.

FIG. 29 is a drawing illustrating an example of a sifting-segregation measurement in accordance with an embodiment of the present disclosure.

FIG. 30 is a drawing illustrating an example of a fluidization-segregation measurement in accordance with an embodiment of the present disclosure.

FIG. 31 is a drawing illustrating an example of particle-size distribution, by mass, of the sorbent reference in accordance with an embodiment of the present disclosure.

FIG. 32 is a drawing illustrating an example of particle-size distribution, by volume, of silica gel in accordance with an embodiment of the present disclosure.

FIG. 33 is a drawing illustrating an example of moisture content as a function of target relative humidity of the sorbent in accordance with an embodiment of the present disclosure.

FIG. 34 is a drawing illustrating an example of moisture content as a function of time for the sorbent in accordance with an embodiment of the present disclosure.

FIG. 35 is a drawing illustrating an example of material loss as a function of velocity in accordance with an embodiment of the present disclosure.

FIG. 36 is a drawing illustrating an example of sorbent lifetime in accordance with an embodiment of the present disclosure.

FIG. 37 is a block diagram illustrating an example of the system of FIG. 1 or 2 using input thermal energy in accordance with an embodiment of the present disclosure.

FIG. 38 is a block diagram illustrating an example of the system of FIG. 1 or 2 using input thermal energy associated with a data center in accordance with an embodiment of the present disclosure.

FIG. 39 is a drawing illustrating an example of a user interface in a control subsystem for the system of FIG. 1 or 2 in accordance with an embodiment of the present disclosure.

FIG. 40 is a drawing illustrating an example of a user interface in a control subsystem for the system of FIG. 1 or 2 in accordance with an embodiment of the present disclosure.

FIG. 41 is a drawing illustrating an example of a user interface in a control subsystem for the system of FIG. 1 or 2 in accordance with an embodiment of the present disclosure.

FIG. 42 is a drawing illustrating an example of a user interface in a control subsystem for the system of FIG. 1 or 2 in accordance with an embodiment of the present disclosure.

FIG. 43 is a drawing illustrating an example of the use of the system of FIG. 1 or 2 without input thermal energy in accordance with an embodiment of the present disclosure.

FIG. 44 is a drawing illustrating an example of the use of the system of FIG. 1 or 2 with input thermal energy in accordance with an embodiment of the present disclosure.

FIG. 45 is a drawing illustrating an example of weather analysis at a location in accordance with an embodiment of the present disclosure.

FIG. 46 is a drawing illustrating an example of operating parameters for the system of FIG. 1 or 2 with input thermal energy in accordance with an embodiment of the present disclosure.

FIG. 47 is a drawing illustrating an example of operating parameters for the system of FIG. 1 or 2 with input thermal energy in accordance with an embodiment of the present disclosure.

FIG. 48 is a block diagram illustrating an example of an electronic device in or associated with the system of FIG. 1 or 2 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An integrated system for adsorbing CO₂ in the air is described. The system includes: an adsorber that adsorbs the CO₂ from the air using a sorbent; and a desorber, coupled to the adsorber, that desorbs the adsorbed CO₂ from the sorbent (e.g., in an energy-efficient manner, such as without using steam) into an output of the system. In contrast with other approaches, the system may continuously move the sorbent, as an ensemble, through the system. Thus, the system may concurrently (and continuously) perform adsorption and desorption. Moreover, the sorbent may include a cost-effective and robust free-standing bulk solid. This may allow the sorbent to be used in multiple cycles or transits through the system. Furthermore, after the multiple cycles, the sorbent may be replaced while the system is operating, and the used sorbent may be recycled (or rejuvenated) for subsequent reuse in the system.

By continuously performing adsorption and desorption in an energy-efficient manner, these DAC techniques may provide a robust, economical solution for removing CO₂ from the atmosphere. This may include removing CO₂ from the atmosphere at locations other than point sources (e.g., at lower concentrations of CO₂). Moreover, the system may provide these advantages at scale, thereby allowing significant amounts of CO₂ to be removed from the atmosphere over time. Collectively, these capabilities may allow the system to contribute to mitigating human-induced climate change and, thus, global warming.

While stochastic chemical formulations are used as illustrations of some compounds or materials in the present discussion (such as the sorbent), note that the disclosure may include other formulations of these compounds or materials, including non-stoichiometric chemical formulations.

In the present discussion, the following definitions are used:
‘Adsorption’ should be understood to mean ‘interaction with or chemical bonding of CO₂ and/or water in air to a sorbent.’ For example, adsorption may include adhesion of CO₂ and/or water (and, more generally, an atom, ion or molecule) onto a surface of the sorbent.
‘Alumina’ should be understood to mean ‘aluminum oxide (Al₂O₃)’.
‘Aluminum silicate’ should be understood to mean ‘a compound including aluminum oxide and silicon dioxide (SiO₂)’.
‘Amine’ should be understood to mean ‘a compound or functional group containing a nitrogen atom and a lone pair of valence electrons that are not shared with another atom in a covalent bond.’
‘Amino silane’ should be understood to mean ‘silane (SiH₄) with amino groups as functional groups.’
‘Amorphous silica’ (or amorphous silicon dioxide) should be understood to mean ‘non-crystalline silica.’ Thus, amorphous silica excludes polycrystalline silica, which includes multiple silica crystals having different orientations.
‘Antioxidant’ should be understood to mean ‘a material that inhibits oxidation.’
‘Approximately’ should be understood to mean ‘close to, around or roughly.’ For example, approximately may mean a number or value within 1, 3, 5, 10 or 25% of a particular value.
‘Batch process’ should be understood to mean ‘a technique of completing repetitive jobs or operations.’ For example, a batch process may include performing adsorption followed by desorption. Thus, in this batch process example, adsorption and desorption are not performed concurrently.
‘Bulk solid’ should be understood to mean ‘a material having properties between those of a packed solid and a liquid. Notably, a bulk solid may have different values of particle density (e.g., 1,000-10,000 kg/cm³) and bulk density. Moreover, a bulk solid may be composed of many particles, powder, grains or granules having different sizes (e.g., diameters between 1 nm and 5 mm), particle densities and/or a range of shapes, which are randomly or loosely packed into bulk. In some embodiments, a bulk solid may include particles, powder, grains or granules having different chemical compositions. The ‘nature’ of a bulk solid—its appearance, its ‘feel,’ the way it behaves in various circumstances, etc.—may therefore depend on many factors, but principally upon the size, shape and particle density of the constituent particles. Note that a ‘bulk solid’ is sometimes referred to as ‘bulk material’ or ‘dry bulk.’
‘Cheylator’ should be understood to mean ‘a material in which two or more separate coordinate bonds are formed between a polydentate ligand and a single central metal atom.’
‘Continuous’ should be understood to mean ‘unbroken or without interruption.’ For example, continuous motion, as an ensemble, of a sorbent in the system may mean steady-state motion of the sorbent, in aggregate, through the system.
‘Cross-linker’ should be understood to mean ‘a material having a bond or a short sequence of bonds that link one synthetic or natural polymer chain to another.’
‘Desorption’ should be understood to mean ‘release of the CO₂ and/or the water from the sorbent.’
‘Ensemble’ should be understood to mean ‘as a group’ (as opposed to individually). While individual particles, powder, grains or granules of the sorbent may or may not move continuously in the system, the particles, powder, grains or granules in the sorbent may move, in aggregate or as an ensemble, continuously in the system.
‘Free-standing’ should be understood to mean ‘a material composed of separate (e.g., free of support or attachment) particles, powder, grains or granules.
‘Polyethylenimine (PEI)’ should be understood to mean ‘a polymer with repeating units composed of an amine group and two carbon aliphatic (CH₂CH₂) spacers.’ Polyethylenimine is sometimes referred to as ‘polyaziridine.’
‘Polymer’ should be understood to mean ‘a molecule composed of multiple monomers.’
‘Sorbent’ should be understood to mean ‘a material that adsorbs CO₂ and/or water from air.’
‘Zeolyte’ should be understood to mean ‘a microporous, three-dimensional crystalline solid of aluminum silicate.’

We now describe embodiments of the system. In order to address the need for cost-effective and efficient atmospheric carbon-capture technology (and, thus, to help address global warming), the disclosed system may be designed to provide compelling economics. Notably, the system may be designed for extended operating life (such as 25-30 years). Moreover, the system may operate at scale and may be robust (with a high uptime), so it can perform multiple iterations of carbon capture without (or with reduced) wasted air and/or wasted energy. In the process, the system may achieve extremely low (or even the lowest) unit cost for CO₂ capture (even without external subsidies), thereby enabling CO₂ capture at an arbitrary location (as opposed to only working in conjunction with a point source of air having a concentration of CO₂ exceeding ambient concentration). The disclosed system includes a collection of subsystems. While a given subsystem may not be the best option (which often come at the price of being the most-expensive solution), the system as a whole may provide cost-effective and efficient (e.g., optimal) captured CO₂ per unit time, and thus may provide the aforementioned compelling economics.

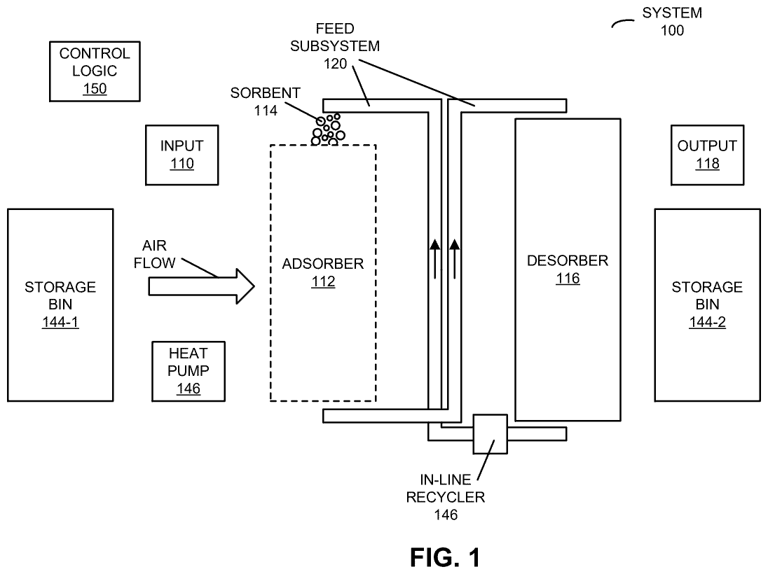

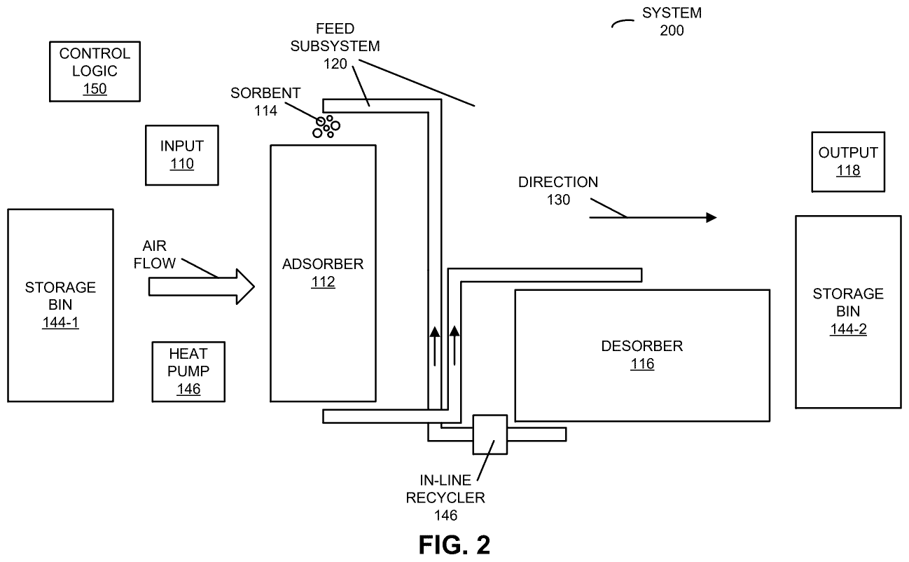

FIG. 1 presents a block diagram illustrating an example of a system 100. This system may perform DAC, in which CO₂ is extracted from the atmosphere at an arbitrary location, as opposed to only working in conjunction with a point source of CO₂. Thus, a concentration of the CO₂ in the air may be an ambient concentration. However, in other embodiments, the concentration of the CO₂ in the air may is larger than the ambient concentration (e.g., the air may be input from a point source, such as flu gas or an output of a smokestack). For example, the CO₂ concentration in the air input to system 100 may be greater than or equal to 10% or 100,000 ppm. In the discussion that follows, system 100 is used as an illustration of the disclosed system. However, in general one or more of the described components and features may apply to other embodiments, such as system 200 in FIG. 2.

System 100 may adsorb CO₂ from air in an input 110 to system 100. This system includes: an adsorber 112 (or, in some embodiments, a means for adsorbing) that adsorbs the CO₂ from the air using a sorbent 114; and a desorber 116 (or, in some embodiments, a means for desorbing), coupled to adsorber 112, that desorbs the adsorbed CO₂ from sorbent 114 into an output 118 of system 100. In some embodiments, desorber 116 is separate or different from adsorber 112. Thus, desorber 116 may be a dedicated (separate) component from adsorber 112 in system 100. Note that system 100 does not show all the components, such as mechanical or electrical couplings (e.g., pipes, valves or electrical wiring), in system 100.

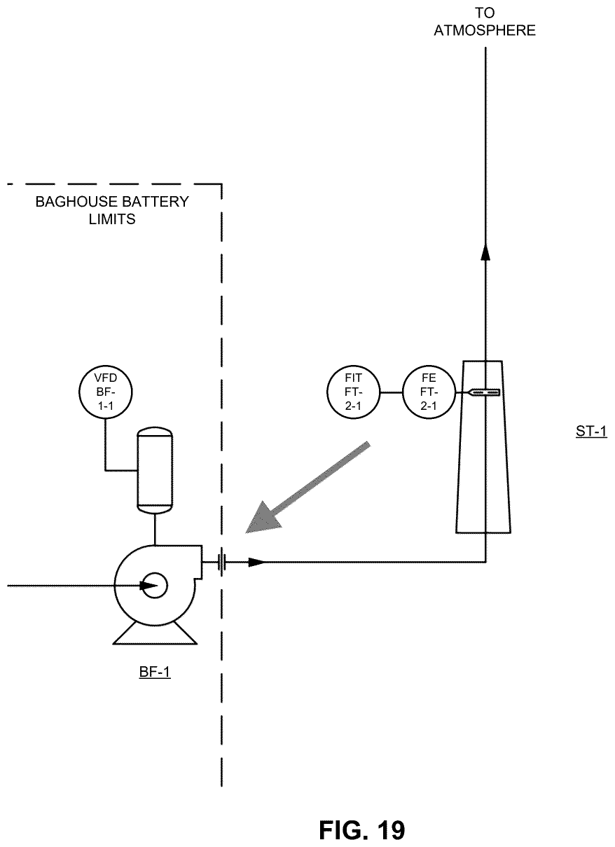

System 100 continuously moves sorbent 114, as an ensemble, through system 100. For example, sorbent 114 may be moved, as the ensemble, in system 100 using a feed subsystem 120 (such as one or more conveyors, such as a bucket conveyor). Feed subsystem 120 may convey sorbent 114 from an output of desorber 116 and to an input of adsorber 112, and may convey sorbent 114, as the ensemble, from an output of adsorber 112 to an input of desorber 116. Thus, system 100 may be a closed-loop system that provides continuous sorbent throughput as an ensemble. As described further below with reference to FIG. 19, in some embodiments system 100 may include an integrated filtration filter (which is sometimes referred to as a ‘baghouse’ or an ‘integrated dust/fines capturing system’) to reduce or eliminate dust produced during operation of system 100 (and, thus, to provide low dust loading).

Moreover, sorbent 114 may include a free-standing bulk solid. Note that sorbent 114 may be other than or different from a liquid. Furthermore, sorbent 114 may not be included in a frame or a package (such as a filter) in system 100. In some embodiments, the free-standing bulk solid may have or may include particles having an irregular or asymmetric shape.

The continuous motion may include steady-state operation of system 100. Moreover, the continuous motion may exclude a batch process (e.g., adsorption followed by desorption). Instead, the adsorption (using a portion of sorbent 114) and the desorption (using a second portion of sorbent 114) may occur concurrently. Furthermore, system 100 may perform multiple iterations of the adsorption and the desorption of the CO₂ without ceasing operation of system 100, and a given iteration of the multiple iterations may include a cycle of transit of sorbent 114, as the ensemble, through system 100. Thus, system 100 may operate without start or stop operations while capturing the CO₂ in the air.

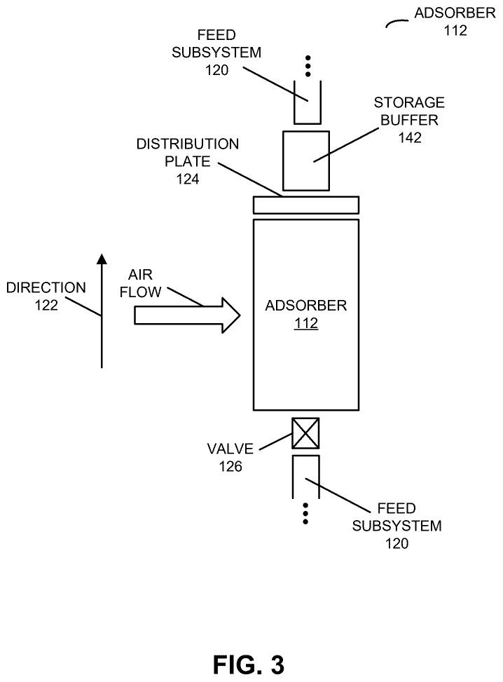

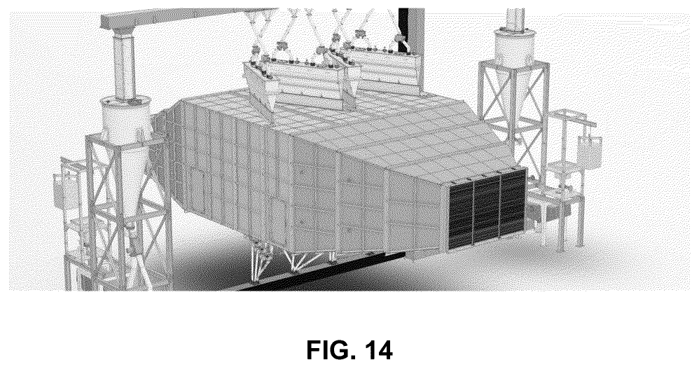

As shown in FIG. 3 (and as further discussed below with reference to FIGS. 14-19), adsorber 112 may adsorb water from the air using sorbent 114 and desorber 116 may desorb the adsorbed water from sorbent 114 into output 118. For example, system 100 may provide the water to a data center or for irrigation. Alternatively or additionally, system 100 may provide the water as potable water. However, this may involve the output water being filtered or being processed, such as in an ozonator to reduce or eliminate amines in the output water.

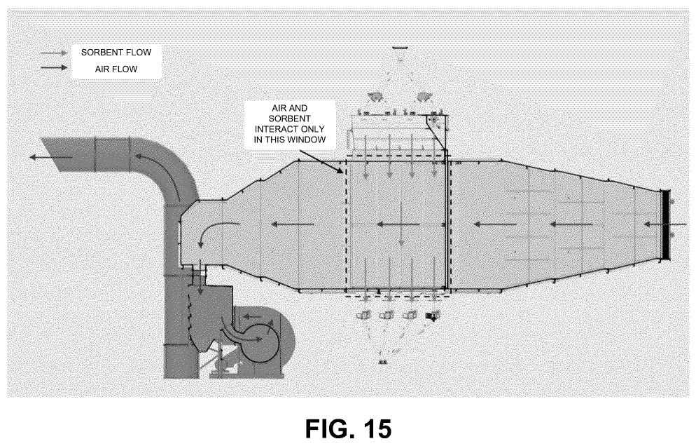

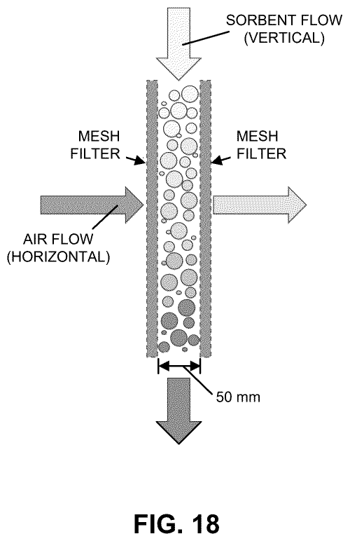

Additionally, adsorber 112 may include a gravity-flow packed bed that continuously moves sorbent 114, as the ensemble, in a direction 122 having a vertical component while (as shown in FIGS. 15 and 18) flowing the air at a non-zero angle to direction 122, such as approximately 90° (thus, adsorber 112 may, in some embodiments, use cross-current flow). In some embodiments, adsorber 112 may include a distribution plate 124 that spreads out sorbent 114 in the gravity-flow packed bed. Moreover, a flow of sorbent 114 through the gravity-flow packed bed may be controlled by a valve 126 at a bottom of the gravity-flow packed bed. (In addition, the flow of sorbent may be related to a sorbet-bed thickness in the gravity-flow packed bed.) For example, value 126 may include a rotary valve or a flip valve. As discussed further below with reference to reducing or eliminating chemical degradation (such as oxidation) of sorbent 114 in system 100, in system 100 contact between sorbent 114 and the air may only occur in adsorber 112.

Note that, in general, adsorbing one ton of CO₂ (1 tCO₂) may involve moving 100k-300k m³/hr of air through adsorber 112. Moreover, a residence time of sorbent 114, as the ensemble, in adsorber 112 may be 20-80 min. For example, the amount of sorbent 114 in adsorber 112 may be 0.2-2.0 t/hr. Furthermore, a linear speed of sorbent 114 in adsorber 112 may be 0.5-2.0 mm/s and an air flow rate may be 0.8-1.2 M m³/hr.

In some embodiments, a pressure drop in sorbent 114 in adsorber 112 is 400-1000 Pa (such as 0.162573 psi). While the target may as small as possible, in general there is a finite (non-zero) pressure drop. This pressure drop may reflect a tradeoff between the energy to move the air through adsorber 112 with the time for the air/sorbent 114 to mix for adsorption. Thus, the pressure drop may reflect the balance between the cost and adsorption performance. As discussed further below, the pressure drop may impact the energy cost in system 100 to capture CO₂.

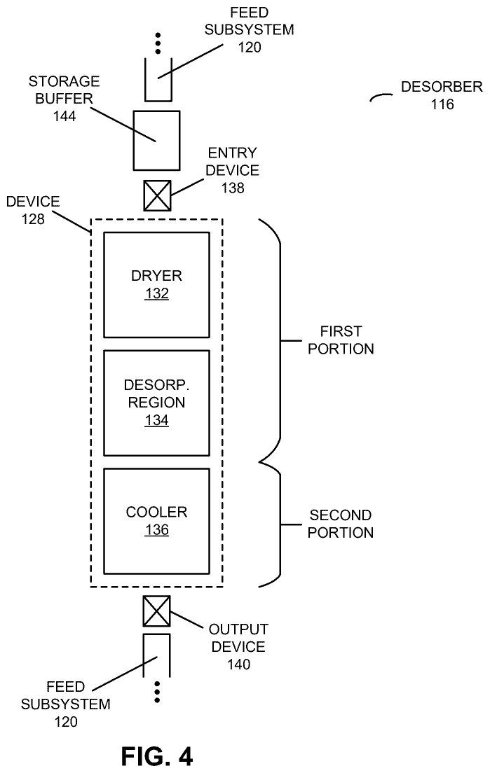

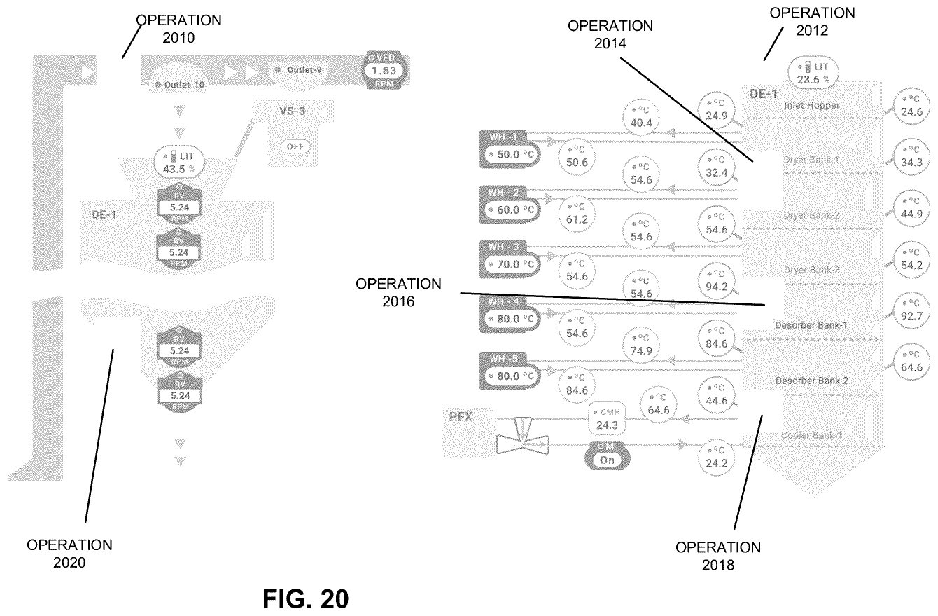

Moreover, as shown in FIG. 4 (and as further discussed below with reference to FIGS. 20-24), desorber 114 may include a device 128 having a pressure other than atmospheric pressure. For example, the pressure may include between approximately 0.5 and 5 psi (and device 128 may be filled with CO₂ and/or water vapor; as discussed further below there may not be oxygen in device 128 to reduce or eliminate chemical degradation of sorbent 114). However, in other embodiments, the pressure may exceed atmospheric pressure. Moreover, device 128 may be oriented along direction 122 in FIG. 1 (such as a vertical direction) or a horizontal direction 130 (as shown in system 200 in FIG. 2). If device 128 is oriented along horizontal direction 130 (FIG. 2), system 200 (FIG. 2) may include a horizontal conveyor belt to transport sorbent 114 from an output of adsorber 112 to an input of desorber 116 (and, thus, device 128).

In some embodiments, device 128 may include: a dryer 132 (to optionally desorb at least some of the adsorbed water in sorbent 114), a desorption region 134 (to desorb the adsorbed CO₂ and to optionally desorb a remainder of the water), and a cooler 136. Moreover, device 128 may include, at an input to device 128, an entry device 138 that supports a differential pressure across entry device 138 and that allows the free-standing bulk solid pass through entry device 138 at a controlled rate and, at an output of device 128, an output device 140 that supports the differential pressure across output device 140 and that allows the free-standing bulk solid pass through output device 140 at the controlled rate. Thus, the controlled rate may include (non-zero) continuous movement of sorbent 114. For example, entry device 138 or output device 140 may include an airlock. Note that entry device 138 or output device 140 may include: a vacuum double rotary disc, a Fetzer valve, a knife gate or a chamber lock. Moreover, system 100 may heat sorbent 114 in dryer 132 (or a first portion of device 128) to desorb at least some of the adsorbed water and/or may heat sorbent 114 in desorption region 134 (which may also be included in the first portion of device 128) to extract the adsorbed CO₂, and then may cool sorbent 114 in cooler 136 (or a second portion of device 128). In some embodiments, desorber 116 (and, in particular, device 128) may desorb the adsorbed CO₂ without applying heat to generate steam for use in the desorption (because steam may cause chemical degradation of an active material(s) in sorbent 114).

For example, dryer 132 may initially heat sorbent 114 to 30-50 C to remove at least some of the adsorbed water. Moreover, desorption region 134 may heat sorbent 114 to 70-90 C (a margin of 10 C may be maintained to account for heat transfer through a bulk-solid heat exchanger in desorber 116). In general, desorber 116 may produce 0.5-2 mol CO₂/kg-sorbent per cycle through system 100, and may produce 0.5-5 tons of water per tCO₂. However, the amount of water produced depends on the temperature and the relative humidity of the air. (While the present discussion uses relative humidity, in other embodiments absolute humidity may be used.) In some embodiments, the average ratio of water to CO₂ may be 2:1 by mass.

Additionally, adsorber 112 in FIG. 3 (or system 100 in FIG. 1 or 200 in FIG. 2) may include a storage buffer 142 (such as a hopper) for extra sorbent for adsorber 112 (which may be proximate to an input of adsorber 112 and, more generally, is in the loop with adsorber 112), and desorber 116 (or system 100 in FIG. 1 or 200 in FIG. 2) may include a storage buffer 144 (such as a hopper) for extra sorbent (which may be proximate to an input of desorber 116 and, more generally, is in the loop with desorber 116). Storage buffer 142 may include a level checker to ensure that there is always sorbent 114 in storage buffer 142. Moreover, storage buffers 142 and 144 may allow for acceleration or deceleration of feed subsystem 120 (and, thus, changes to the speed sorbent 114 is conveyed through system 100) by ensuring that there is always sufficient sorbent 114 available for processing at the inputs to adsorber 112 and desorber 116. Thus, storage buffers 142 and 144 may enable seamless acceleration or deacceleration of sorbent 114 in system 100 (FIG. 1) or 200 (FIG. 2) without the risk of conveyance delay.

Referring back to FIG. 1, in some embodiments system 100 may include bypass storage bins 144 on sides of system 100, such as columns of additional sorbent. In some embodiments, system 100 may have a 140 k tons sorbent load, of which 70 k tons of sorbent 114 may, at a given time, move as the ensemble in system 100. The remainder of the sorbent load may be contained in storage bins 144.

In some embodiments, sorbent 114 may be replaced or swapped out of system 100, while system 100 is operating (or live swapped), with the additional sorbent in storage bins 144, so that sorbent 114 can be recycled (or rejuvenated).

Notably, after N cycles of sorbent 114 transiting, as the ensemble, through system 100, where N is a non-zero integer (such as a number greater than 1,000), sorbent 114 may be replaced while system 100 is operating. Alternatively or additionally, system 100 may have scheduled and preemptive maintenance following operation for a predefined time interval, such as at least 50 weeks (without start or stop operations—and, thus, high uptime). For example, the scheduled and preemptive maintenance may include two weeks. During the scheduled and preemptive maintenance, sorbent 114 may be replaced (e.g., with the additional sorbent), vacuum pumps may be back washed, etc. However, in other embodiments, the preemptive maintenance may occur in two or more time windows during the operating time interval of system 100.

The replaced sorbent may be recycled (or rejuvenated). Moreover, the recycled sorbent may be reused in system 100. As described further below, the recycling may include re-functionalizing sorbent 114 by burning off at least some of sorbent (such as the active material(s)) and recoating sorbent 114 (e.g., with new active material(s)). However, in some embodiments, sorbent 114 may be recycled in system 100, such as using optional in-line recycler 146. Alternatively or additionally, the recycled sorbent may be used as a water filter for amines (such as filtering amines in the water in output 118 from system 100).

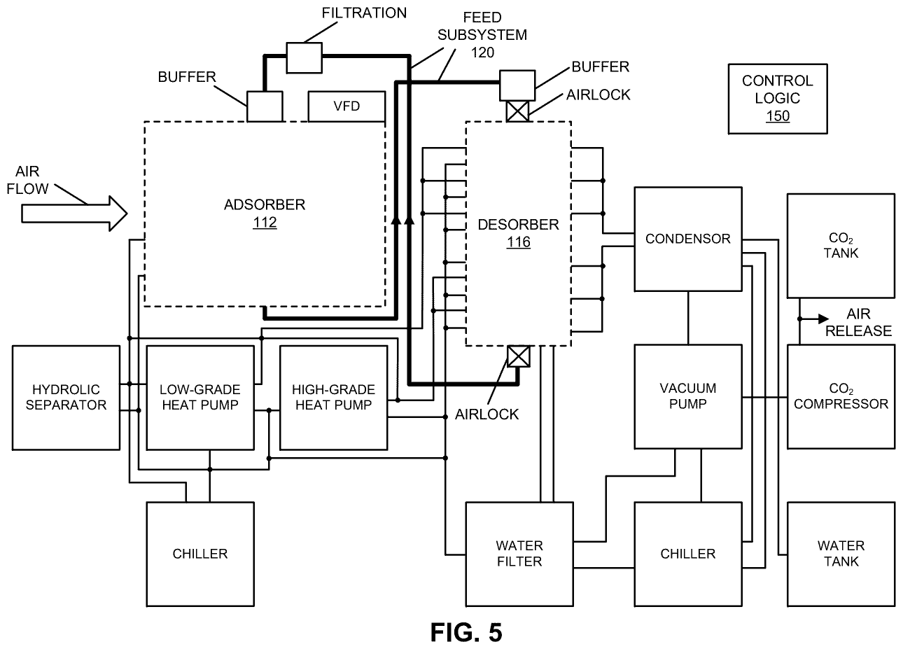

In some embodiments, system 100 may include at least one heat pump 148 to provide heat transfer, such as from input 110. (Other embodiments of one or more heat pumps in system 100 and/or 200 in FIG. 2 are discussed further below with reference to FIGS. 5-7.)

For example, system 100 may selectively use optional input thermal energy in the operation of system 100. Notably, depending on the cost or price of electricity and the availability of the optional input thermal energy, system 100 (such as control logic 150, e.g., an integrated circuit and/or software executed by a processor) may reduce electricity use by using the optional input thermal energy to precondition the air prior to adsorber 112 (e.g., by reducing the relative humidity) and/or to facilitate the heating in dryer 132 and desorption region 134. However, in some embodiments, when the price of electricity is low, the preconditioning of the air and the heating of dryer 132 and/or desorption region 134 may be performed in system 100 using input electricity (and, thus, without the optional input thermal energy).

Thus, inputs to system 100 may include the air (with a concentration of CO₂), electricity (e.g., from an electric grid, geothermal or solar panels) and the optional input thermal energy, and outputs from the system may include water and/or the CO₂. For example, the thermal energy may be associated with a geothermal source. Alternatively or additionally, the thermal energy may be input from a separate source than the system, such as a co-located industrial facility or process. However, in some embodiments, the thermal energy may be input from a heat pump or heat bags (or solar bags), which may heat up water using solar energy or sunlight.

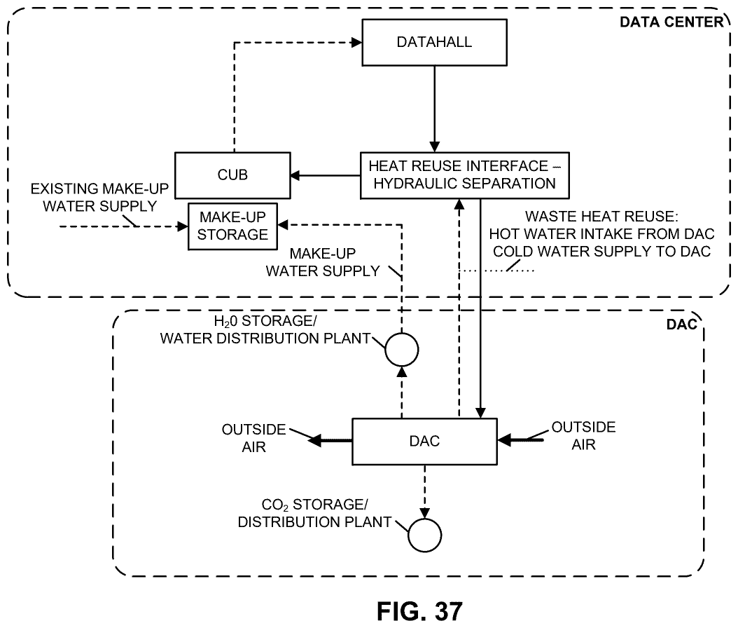

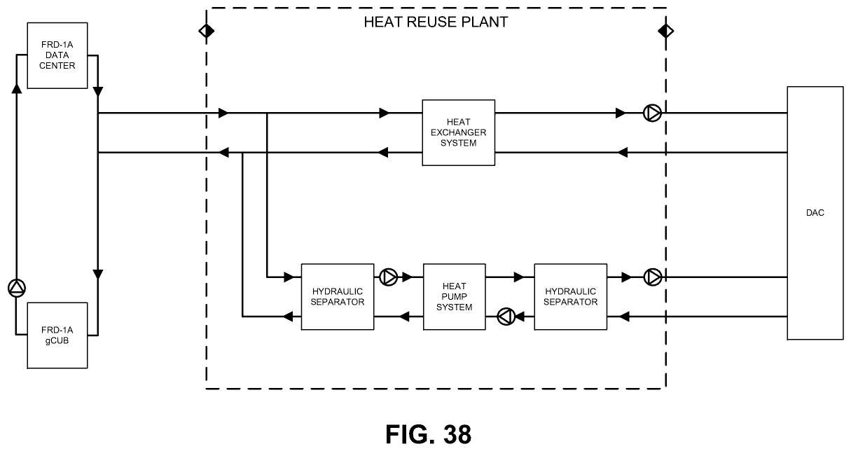

In embodiments where system 100 uses input thermal energy from a co-located industrial facility or process, system 100 may be used to provide uninterrupted (24 hr per day, 7 days per week) cooling to the industrial facility or process. For example, system 100 may be used instead of cooling towers. In some embodiments, as shown in FIGS. 37 and 38, system 100 may provide cooling to a data center. Alternatively or additionally, system 100 may cool solar panels based at least in part on an operating efficiency of the solar panels. Note that current solar panel efficiency may decrease by 0.38% per degree C. above 25 C (77 F), and may increase by 0.38% per degree C. below 25 C.

In some embodiments, the input thermal energy for desorption may include or may come from another source. For example, the input thermal energy for desorption may include: radio waves (with wavelengths between approximately hundreds of kilometers and 1 m), microwaves (with wavelengths between approximately 1 m and 1 mm) and/or Infra-red waves (with wavelengths between approximately 1 mm and 1 μm). In these embodiments, the desorption may occur in a horizontal device in which, e.g., a belt or bucket conveys sorbent 114, or in a vertical device. Note that one or more of the electromagnetic wave parameters (such as the carrier frequency, modulation, amplitude, phase, etc.) may be selectively tuned to target water and/or CO₂ molecules for higher efficiency, faster drying and/or improved desorption. Moreover, when low-grade heat is available, it may be used for an initial drying stage in desorber 116 and use microwaves (or another electromagnetic wave) may be used for subsequent desorption stages in desorber 116 instead of using a heat pump to thermally lift the low-grade heat.

System 100 may be able to flexibly adapt to a wide range of circumstances or environments, including different: environmental conditions, cost of electricity, and/or availability of optional input thermal energy. For example, control logic 150 may dynamically adapt the operating parameters (and, thus, the operation) of system 100 to improve or optimize captured CO₂ and/or water, while reducing or minimizing energy usage and associated cost. Thus, system 100 may dynamically increase or optimize the amount of captured CO₂ per unit cost. For example, system 100 may change or adjust the residence time of sorbent 114 in adsorber 112 in order to optimize CO₂ capture when the price of electricity is reduced. Alternatively or additionally, in some embodiments system 100 may, at off-peak hours or at night, preheat water used for desorbing the adsorbed CO₂ in dryer 132 based at least in part on a price or cost of electricity.

For example, control logic 150 may adjust a variable cycle time for sorbent 114 to transit through the system. In some embodiments, a cycle time or round-trip time for sorbent 114, as the ensemble, to transit through system 100 may be 1-3 hr (such as 2 hr).

Moreover, control logic 150 may allow system 100 to operate over a range or spread of ambient temperatures greater than 10 C and a range of relative humidity greater than 7%. Notably, system 100 may be able to operate over ambient temperatures between −40 C and 55 C (as discussed further below, the upper bound on temperature may be associated with chemical degradation of sorbent 114, notably oxidation) and relative humidity greater than 7%. In some embodiments, system 100 may use different types of sorbent having different material properties or compositions based at least in part on environmental conditions in an environment of system 100. Thus, system 100 may dynamically adapt to changes in environmental conditions, such as temperature and relative humidity variation.

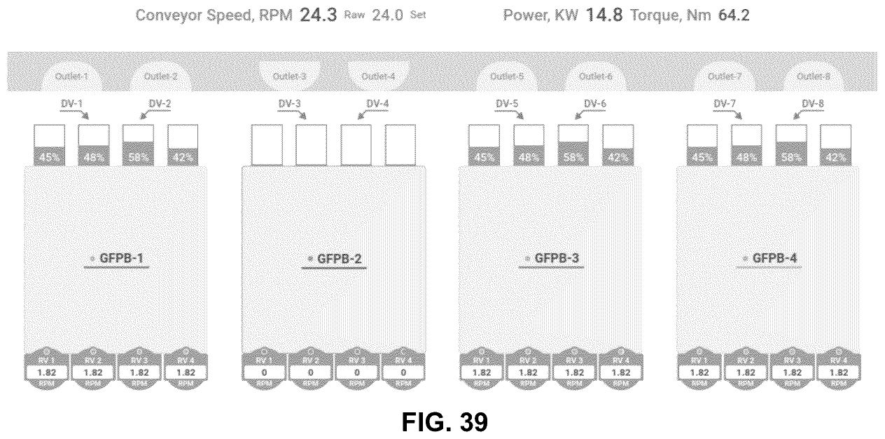

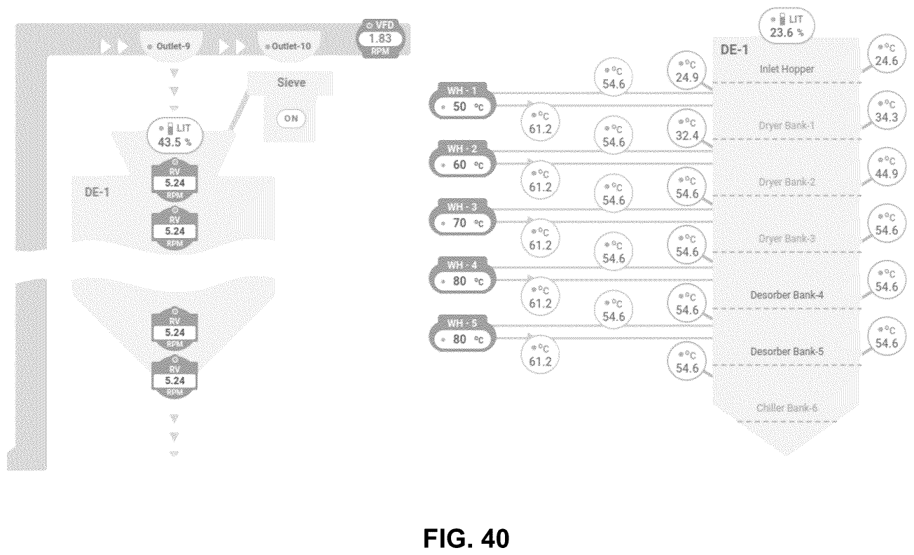

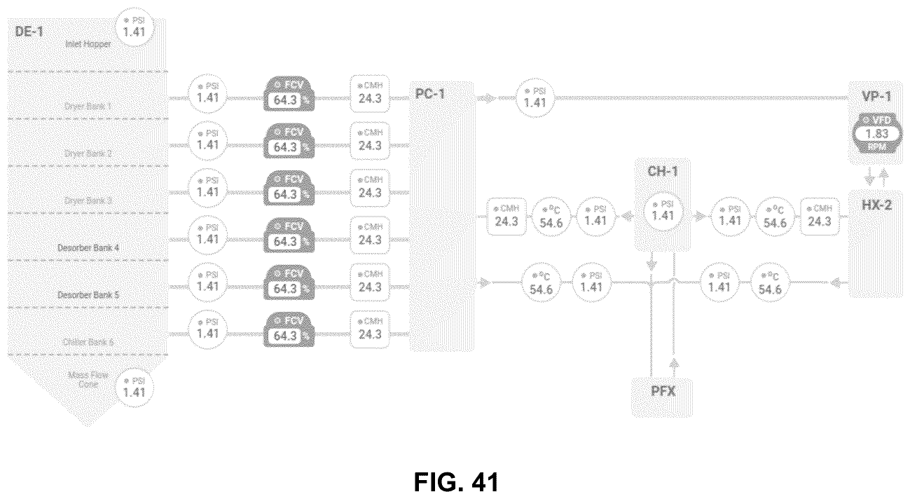

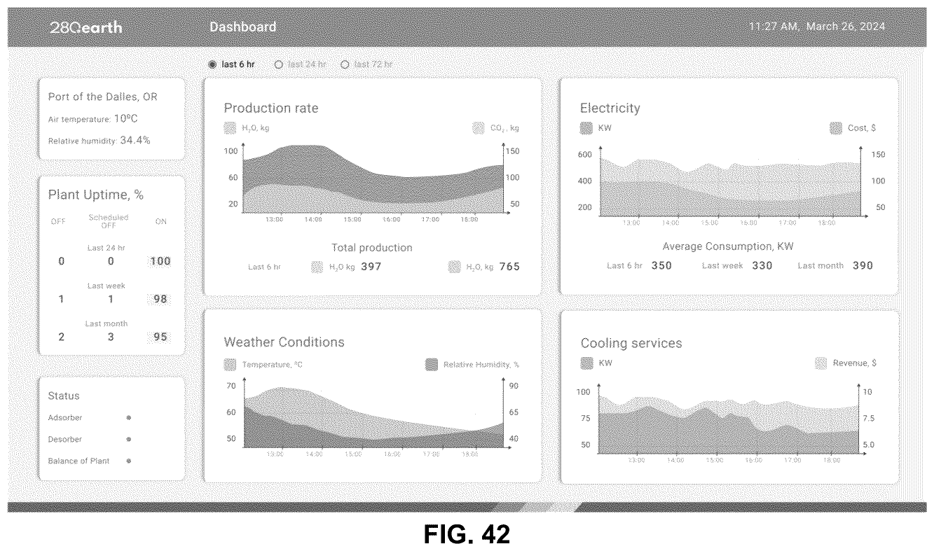

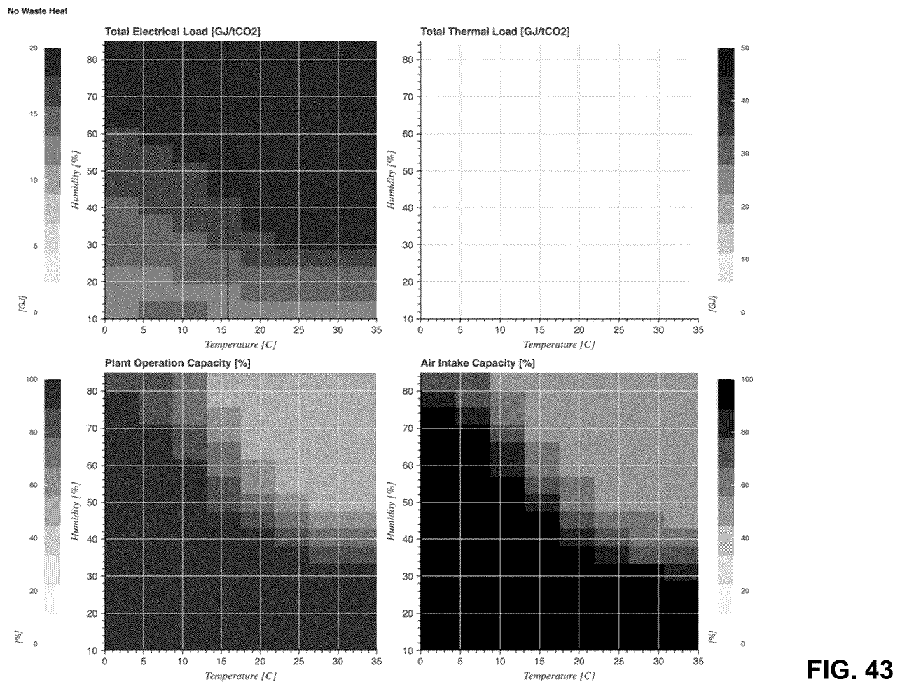

Moreover, system 100 may operate with high availability without environmental control or constraint. Furthermore, as described further below with reference to FIGS. 43-47, control logic 150 may select, generate or modify the operating parameters of system 100 based at least in part on a predicted or forecast temperature, and/or a predicted or forecast relative humidity in an external environment of system 100. Alternatively or additionally, control logic 150 may select, generate or modify the operating parameters of system 100 based at least in part on current environmental conditions in the external environment of system 100. FIGS. 39-42 below illustrate a user interface associated with a control subsystem in system 100.

In some embodiments, the operating parameters may be selected, modified or generated based at least in part on: a price of electricity, input thermal energy, demand for captured CO₂, etc.

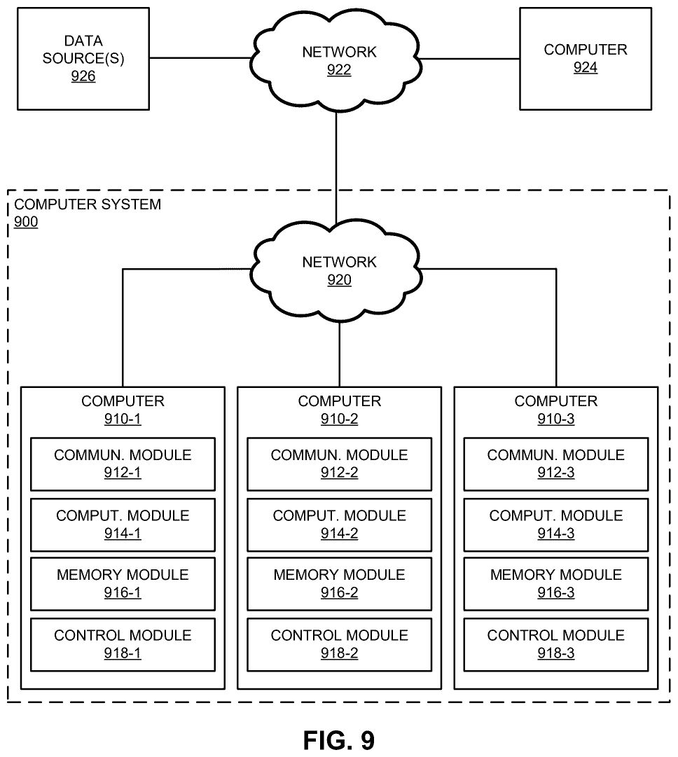

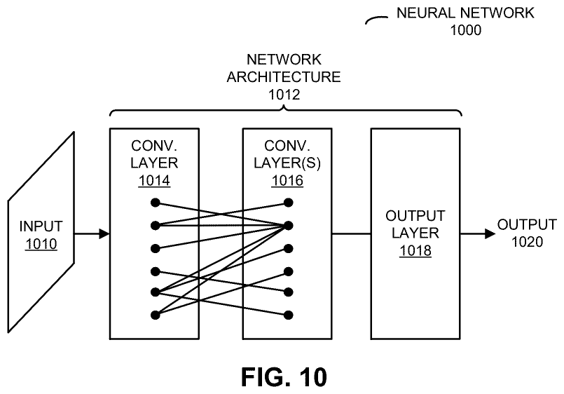

As described further below with reference to FIG. 9, in some embodiments selecting, generating and/or modifying the operating parameters may be performed by a local or a remotely located (with respect to system 100) computer system. Moreover, as described further below with reference to FIG. 10, in some embodiments selecting, generating and/or modifying the operating parameters may be performed by a pretrained machine-learning model, such as a pretrained neural network.

Furthermore, as described further below, sorbent 114 may include a substrate and an amine. For example, the substrate may include: amorphous silica, alumina, zeolytes and/or a polymer. Alternatively or additionally, sorbent 114 may include: amorphous silica, amino silane and PEI. During off-line or in-line recycling, the PEI and the amino silane may be burned off and new PEI and amino silane may be coated on the amorphous silica. Note that sorbent 114 may include a cheylator, an antioxidant and a cross-linker and, during the recycling, a new cheylator, a new antioxidant and a new cross-linker may be coated on the amorphous silica.

A sorbent lifetime may correspond to: a particle size distribution of the free-standing bulk solid, a number of cycles of sorbent 114, as the ensemble, transiting system 100 before sorbent 114 is replaced or recycled, an amount of sorbent 114 in system 100, and/or a material composition of sorbent 114.

CO₂ in output 118 may be used in a variety of applications. For example, the CO₂ may be sequestered. Alternatively or additionally, the CO₂ in output 118 may be used to create synthetic fuel, concrete and/or fertilizer. In some embodiments, the CO₂ in output 118 may be input to a greenhouse. In some embodiments, the CO₂ in output 118 may have a purity exceeding 99% (such as 99.6%) and an impurity in the output may include air and/or water. In some embodiments, the only impurity in the CO₂ may be air.

Note that an amount of CO₂ in output 118 (and, thus, produced by system 100) may be based at least in part on: airflow through sorbent 118 in adsorber 112, a residence time that sorbent 114, as the ensemble, is in contact with the air (in adsorber 112), kinetics of sorbent 114, a material composition of sorbent 114, a distribution of particle sizes in sorbent 114, a pressure drop in adsorber 112, thermal transfer in system 100, a lifetime of sorbent 114, and/or a concentration of the CO₂ in the air. In some embodiments, the amount of CO₂ in output 118 may also depend on the temperature and/or the relative humidity of the air.

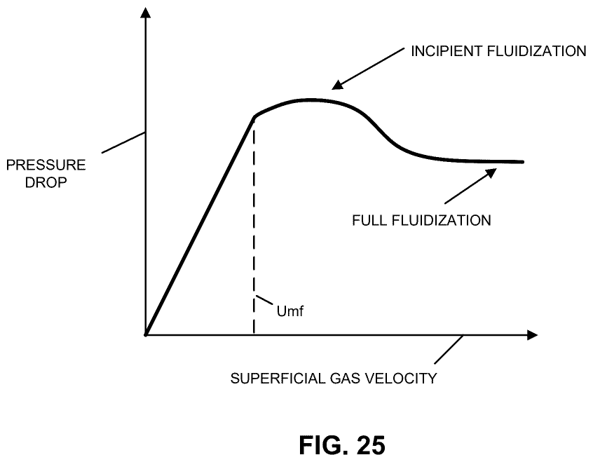

Sorbent 114 may be selected based at least in part: on the pressure drop (and, thus, energy cost) in adsorber 112, CO₂ adsorption and desorption efficiency, sensitivity to chemical degradation, and sensitivity to friability (or mechanical degradation or damage). For example, an initial size or diameter of the granular sorbent particles (prior to a first run through system 100) may be 0.1-5 mm. Properties and characteristics of sorbent 114 are described further below with reference to FIGS. 25-36.

As discussed previously, chemical degradation of sorbent 114 may be associated with oxidation of the active ingredient (such as PEI). This may provide a limit or upper bound on an operating temperature in system 100 (e.g., because sorbent 114 may oxidize at 60 C, the upper bound on the operating temperature of sorbent 114 in system 100 when exposed to oxygen may be 50-55 C). Consequently, in some embodiments, this is why device 128 is operated at a reduced pressure or a vacuum.

Note that, in general, friability may depend on: the particle distribution of sorbent 114, the pressure drop in adsorber 112, thermal heat transfer in system 100, and the chemical composition (and associated degradation mechanism(s)) of sorbent 114. System 100 may include a variety of features or design choices to reduce or eliminate friability of sorbent 114. Consequently, sorbent 114 in system 100 may not be fragile. This may allow the continuous flow, as the ensemble, of sorbent 114 in system 100 (and, thus, may eliminate a need for sorbent 114 to be included or embedded in a frame or a package, such as a filter). Because friability may be difficult to simulate, larger sizes of system 100 (such as a 5,000 tpa system) may mimic or may copy at least some aspects of earlier instances (such as a 500 tpa system).

For example, feed subsystem 120 may include a bucket elevator (instead of air chutes) to transport sorbent 114 vertically. Moreover, vertical drops in system 100 may be limited, e.g., to at most 4-10 ft. Furthermore, surfaces in system 100 may be smooth or may not be rough. Thus, the buckets in the bucket elevator may be coated with plastic finishes (such as polyurethane or polytetrafluoroethylene or PTFE). Similarly, pipes in system 100 may have stainless-steel surface finishes. (While the pipes may not be rough, they may not need to be polished.) Furthermore, a rotary speed of pumps and valves may range from 50-500 rpm for diameters between 4-24 in. Additionally, castings in system 100 may have smooth coatings (such as paint).

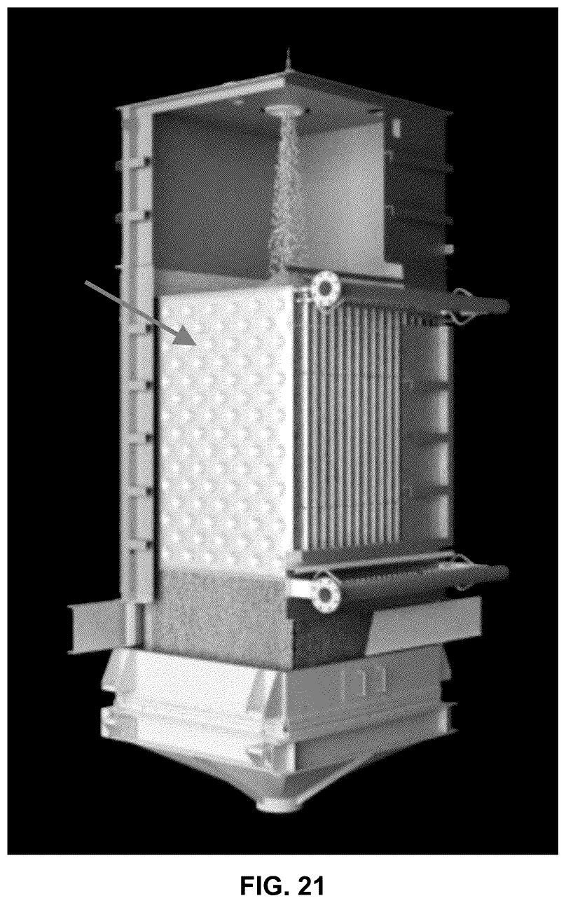

In addition, the terminal velocity of sorbent 114 during the initial loading of system 100 may be constrained. For example, desorber 116 may not be loaded with sorbent 114 when under vacuum. Instead, desorber 116 may be loaded with sorbent 114 with atmospheric pressure in desorber 116. In general, the terminal velocity may depend on the shape of the sorbent particles, the density of air, and the density of sorbent 114. In some embodiments, the terminal velocity of the sorbent is 1-5 m/s. Note that, after the initial loading, the sorbent particles may ‘feel’ the effect of sorbent particles up to a distance of approximately 600 mm, which may constrain the terminal velocity. Moreover, as shown in FIG. 21, desorber 116 may use 16 mm wide plates to control the terminal velocity of the sorbent particles during operation (when device 128 may have a reduced pressure, such as between approximately 0.5 and 5 psi).

Furthermore, friability may be reduced or eliminated by coating sorbent 114 with a crosslinker and/or polyvinyl alcohol (PVA).

As discussed previously, because sorbent 114 may have a finite life span or lifetime, sorbent 114 may be recycled (or rejuvenated) after N cycles through system 100. For example, sorbent 114 may be recycled, e.g., after 3,000 hr (0.75 years) in system 100. The recycling may re-functionalize sorbent 114. Notably, during the recycling, active material(s) (such as PEI) may be burned or baked off of a substrate (such as amorphous silica) or a base material. Then, the substrate may be recoated, e.g., with: amino silane, PEI, an optional cheylator, an antioxidant and/or triformaldehyde. By extending the sorbent lifespan, the recycling may, at least partially, recover the sorbent adsorption capability and may reduce the energy consumption (and, thus, carbon footprint) associated with system 100.

In some embodiments, if sorbent 114 is manufactured from sand (such as silica or silicon dioxide), there may be one or more compounds added to sorbent 114 to deal with the potential presence of iron oxide in the sand, which oxides PEI (and, thus, would otherwise cause chemical degradation of sorbent 114).

Moreover, in some embodiments, system 100 may include a floating auger to push sorbent (e.g., in horizontal direction 130 in FIG. 2) and to distribute sorbent 114. Note that the floating auger may have a high-aspect ratio and may be positioned before adsorber 112.

As discussed previously, there may be one or more heat pumps in the system that circulate heat (or thermal energy). For example, as shown in FIG. 5, which presents a block diagram illustrating an example of heat flow in system 100 (FIG. 1) or 200 (FIG. 2), there may be two heat pumps, one low grade and one high grade. The first heat pump may upgrade a first heat to a second heat, and the second heat pump may upgrade a third heat to a fourth heat. For example, the first heat pump may increase the temperature of heat from 2 to 25 C, and the second heat pump may increase the temperature of heat from 28 or 77 C to 85 C. Thus, a difference of the fourth heat and the third heat may or may not be larger than a difference of the second heat and the first heat. Note that, in some embodiments, a given heat pump may include two or more stages of internal thermal lift. In some embodiments, the system may selectively use the first heat pump and/or the second heat pump based at least in part on availability of input thermal energy to the system, a temperature of the input thermal energy, and/or a price of electricity.

The low-grade heat (LGH) pump and the high-grade heat (HGH) pump may allow the system to be even more efficient with whatever the inputs are (such as the electricity cost and/or optional input thermal energy having a particular temperature). Moreover, the two heat pumps may be independently controlled (e.g., by control logic 150). This may allow controlled ‘blending’ of the heat to maximize utilization and to minimize electricity use. For example, the low-grade heat pump may be turned off when the input thermal energy has a temperature exceeding 40 C and the high-grade heat pump may be turned off when the input thermal energy has a temperature exceeding 85 C.

In FIG. 5, note that a given connection or coupling between components may include one or more independent connections or couplings. Moreover, there may be additional components in FIG. 5 that are not shown, such as valves, blowers or fans, electrical couplings, etc. In some embodiments, control logic 150 may selectively couple or decouple components, such as an input or an output from low-grade heat pump and/or an input or an output from high-grade heat pump. Thus, control logic 150 may selectively use low-grade heat pump and/or high-grade heat pump based at least in part on a temperature of optional input waste heat to the hydraulic separator and/or a price of electricity. Note that one or more of the chillers in FIG. 5 may be optional.

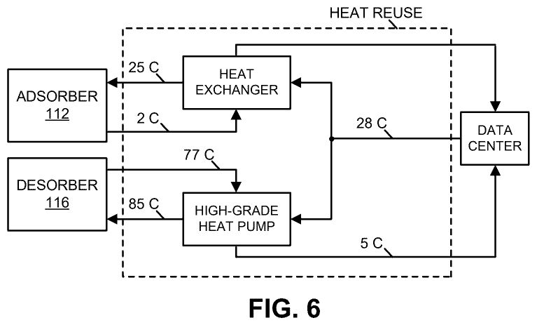

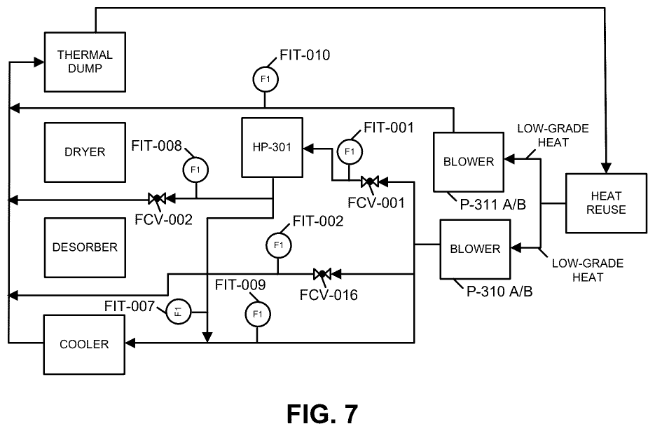

Furthermore, as discussed previously, the system may use waste heat from a data center as the optional input thermal energy. This is shown in FIGS. 6 and 7, which present block diagrams illustrating examples of heat flow in system 100 (FIG. 1) or 200 (FIG. 2). Note that in FIGS. 6 and 7 the flows may be between 0-200 m³/hr.

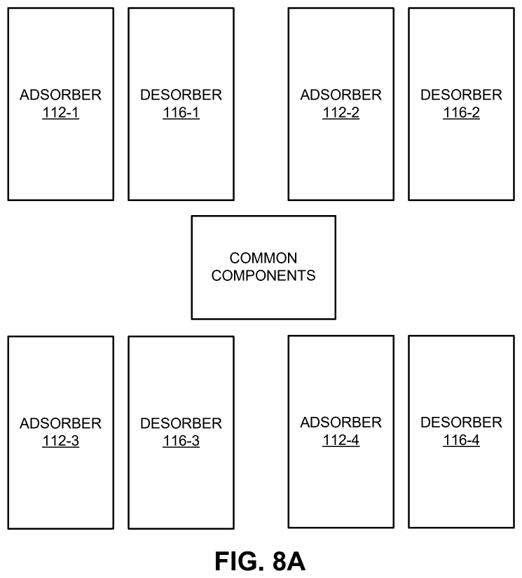

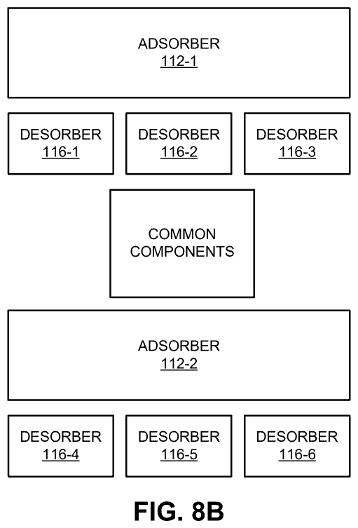

In some embodiments, the system may have a modular design with shared common components. This is shown in FIG. 8A, which presents a block diagram illustrating an example of a modular design of system 100 (FIG. 1) or 200 (FIG. 2). Notably, the system may use modified off-the-shelf components (or customized off-the-shelf or COTS) for low cost, such as the common or shared components. Common components may include: a compressor, a vacuum system, electrical supply, thermal, elevator, software control, waste-heat treatment (such as hydraulic separators, heat exchanger, etc.), storage bins, and/or water purification (which may remove amines, e.g., using reverse osmosis). The exceptions to the common components may include: adsorber 112, desorber 116, vacuum pump(s) and/or optional in-line recycling of the sorbent.

While FIG. 8A illustrates a modular design with multiple pairs of adsorbers and desorbers, in other embodiments different configurations may be used. For example, as shown in FIG. 8B, which presents a block diagram illustrating an example of a modular design of system 100 (FIG. 1) or 200 (FIG. 2), a given adsorber may be paired with multiple desorbers. Note that an adsorber may have different kinetics from a desorber.

In some embodiments, the configurations shown in FIGS. 8A and/or 8B may be implemented in one system or multiple interacting systems that share the common components.

Moreover, as discussed previously, in some embodiments selecting, generating and/or modifying of the operating parameters of the system may be performed by a local or remotely located computer system. This is shown in FIG. 9, which presents a block diagram illustrating an example of a computer system 900. Computer system 900 may include one or more computers 910. These computers may include: communication modules 912, computation modules 914, memory modules 916, and optional control modules 918. Note that a given module or engine may be implemented in hardware and/or in software.

Communication modules 912 may communicate frames or packets with data or information (such as information used to specify environmental conditions, a price of electricity (such as $0.0368/kWh), an amount of available input thermal energy, instructions for a pretrained neural network, and/or control instructions specifying operating parameters for the system) between computers 910 via a network 920 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 912 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3^{rd} Generation Partnership Project of Sophia Antipolis, Valbonne, France), LTE Advanced (LTE-A), a fifth generation or 5G communication protocol, other present or future developed advanced cellular communication protocol, or another type of wireless interface. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 910 (such as computer 910-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 9 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 9 uses one or more bands of frequencies, such as: 900 MHz, 2.4 GHz, 5 GHZ, 6 GHz, 60 GHz, the Citizens Broadband Radio Spectrum or CBRS (e.g., a frequency band near 3.5 GHZ), and/or a band of frequencies used by LTE or another cellular-telephone communication protocol or a data communication protocol. In some embodiments, the communication between the components may use multi-user transmission (such as orthogonal frequency division multiple access or OFDMA) and/or multiple input multiple output (MIMO).

Moreover, computation modules 914 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 916 may access stored data or information in memory that is local in computer system 900 and/or that is remotely located from computer system 900. Notably, in some embodiments, one or more of memory modules 916 may access stored information in the local memory. Alternatively or additionally, in other embodiments, one or more memory modules 916 may access, via one or more of communication modules 912, stored information in the remote memory in computer 924, e.g., via network 920 and network 922. Note that network 922 may include: the Internet and/or an intranet. In some embodiments, the information may include data or information that specifies current or forecast environmental conditions, a price of electricity, an amount of available input thermal energy, etc. (which may be received from one or more data sources 926, via network 920 and network 922 and one or more of communication modules 912). Thus, in some embodiments at least some of the information may have been received previously and may be stored in memory, while in other embodiments at least some of the information may be received in real time from the one or more data sources 926.

While FIG. 9 illustrates computer system 900 at a particular location, in other embodiments at least a portion of computer system 900 is implemented at more than one location. Thus, in some embodiments, computer system 900 is implemented in a centralized manner, while in other embodiments at least a portion of computer system 900 is implemented in a distributed manner. For example, in some embodiments, the one or more data sources 926 may include local hardware and/or software that performs at least some of the operations in the DAC techniques. This remote processing may reduce the amount of information that is communicated via network 920 and network 922. In addition, the remote processing may anonymize the data that is communicated to and analyzed by computer system 900. This capability may help ensure computer system 900 is secure and maintains privacy.

Although we describe the computation environment shown in FIG. 9 as an example, in alternative embodiments, different numbers or types of components may be present in computer system 900. For example, some embodiments may include more or fewer components, a different component, and/or components may be combined into a single component, and/or a single component may be divided into two or more components. Alternatively or additionally, in some embodiments, some or all of the operations in the DAC techniques may be performed by an electronic device, such as a cellular telephone, a tablet, a computer, etc.

In some embodiments, computer system 900 may automate the selecting, generating and/or modifying of operating parameters for system 100 (FIG. 1) or 200 (FIG. 2). Notably, during the DAC techniques, one or more of optional control modules 918 may divide the selecting, generating and/or the modifying of the operating parameters among computers 910. For example, the one or more of optional control modules 918 may obtain the information from one or more of data sources 926 and/or in local and/or remote memory using one or more of memory modules 916. Alternatively, the one or more of optional control modules 918 may generate at least some of the information (e.g., using the same or a different pretrained neural network). Note that the operating parameters may include: plant controls, a type of sorbet, an energy cost (such as price of electricity), weather conditions, energy consumption, a heat source, and/or customer requirements. For example, the operating parameters may specify: energy cost as a function of input thermal energy (such as a waste-heat temperature), a sorbent flow rate and/or an air flow rate in the system.

Then, a given computer (such as computer 910-1) may perform at least a designated portion of the selecting, generating and/or modifying of the operating parameters. Notably, computation module 914-1 may receive or access the information (e.g., in local and/or remote memory using one or more of memory modules 916) that includes content used to select, generate and/or modify the operating parameters, an architecture or configuration of the neural network (including a number of layers, a number of synapses, relationships or interconnections between synapses, activations functions, and/or weights), and/or a set of one or more hyperparameters governing at least the initial training of the neural network (such as a type or variation of stochastic gradient descent, a type of gradient, a learning rate or step size, e.g., 0.01, for the weights in a given layer in the neural network, a loss function, a regularizing term in a loss function, etc.). For example, as described further below with reference to FIG. 10, the neural network may include a convolutional neural network with multiple layers. Each of the layers may include one or more synapses. A given synapse may have associated weights and one or more activation functions (such as a rectified linear activation function or ReLU, ReLU6 in which the rectified linear activation function is modified to have a maximum size or value, a leaky ReLU, an exponential linear unit or ELU activation function, a parametric ReLU, a tanh activation function, or a sigmoid activation function) for each input to the given synapse. In general, the output of a given synapse of layer i may be fed as input into one or more synapse in another layer, such as layer i+1 and/or layer i−1. Based at least in part on the information, computation module 914-1 may implement some or all of the pretrained neural network.

One or more of computation modules 914 may implement the pretrained neural network based at least in part on the architecture or configuration of the neural network. Then, the one or more of computation modules 914 may provide, to the pretrained neural network, input information or content. In response, one or more of computation modules 914 may receive, from the pretrained neural network, an output with additional information that specifies the operating parameters or the modified operating parameters for system 100 (FIG. 1) or 200 (FIG. 2).

For example, when selecting, generating and/or modifying the operating parameters, the input information may include forecast or current: solar data at one or more locations, weather conditions at one or more locations (such as temperature or relative humidity), a price of electricity, an amount of available input thermal energy, a temperature of the input thermal energy, etc. In these embodiments, the output may include the parameters for the automatically selected, generated and/or modified operating parameters.

After completing the selecting, generating and/or modifying of the operating parameters, control module 918-1 may store results, e.g., the operating parameters or the modified operating parameters, in local and/or remote memory using memory module 916-1. Alternatively or additionally, control module 918-1 may instruct communication module 914-1 to communicate results of the operating parameters or the modified operating parameters with other computers 910 in computer system 900 or with computers (not shown) external to computer system 900 (such as in or associated with system 100 in FIG. 1 or 200 in FIG. 2). In some embodiments, control module 918-1 may display or print out at least a portion of the results, e.g., to an operator of computer system 900, so that the operator can evaluate the operating parameters.

In these ways, computer system 900 may improve the selecting, generating and/or modifying of the operating parameters. For example, by automating the revision or updating process, computer system 900 may significantly reduce the cost of selecting, generating and/or modifying the operating parameters. Moreover, computer system 900 may employ learning from the operating parameters for previous or prior successful operation of system 100 (FIG. 1) or 200 (FIG. 2), thereby improving the current operating parameters for system 100 (FIG. 1) or 200 (FIG. 2). Therefore, the DAC techniques may improve the financial impact (such as the return on investment or ROI) and/or reduce the risk associated with operating system 100 (FIG. 1) or 200 (FIG. 2).

As discussed previously, in some embodiments, the DAC techniques may use a pretrained neural network. For example, the pretrained neural network may include a Large Language Model (LLM) or a transformer model (which performs natural language processing to translate, predict and generate natural language, such as text or speech). Transformer model may include a Generative Pre-Trained Transformer, such as ChatGPT (from OpenAI, Inc. of San Francisco, California) or Gemini (from Google LLC, of Mountain View, California). More generally, the pretrained neural network may include a wide variety of neural network architectures and configurations, including: a convolutional neural network, a recurrent neural network, an autoencoder neural network, a perceptron neural network, a feed forward neural network, a radial basis neural network, a deep feed forward neural network, a long/short term memory neural network, a gated recurrent unit neural network, a variational autoencoder neural network, a denoising neural network, a sparse neural network, a Markov chain neural network, a Hopfield neural network, a Boltzmann machine neural network, a restricted Boltzmann machine neural network, a deep belief neural network, a deep convolutional neural network, a deconvolutional neural network, a deep convolutional inverse graphics neural network, a generative adversarial neural network, a liquid state machine neural network, an extreme learning machine neural network, an echo state neural network, a deep residual neural network, a Kohonen neural network, a support vector machine neural network, a neural turing machine neural network, or another type of neural network (which may, at least, include: an input layer, one or more hidden layers, and an output layer). In general, the pretrained neural network (and, more generally, a machine-learning model) may use information specifying current and/or forecast weather or environmental conditions in an environment of the system (such as data corresponding to temperature, relative humidity, barometric pressure, wind direction, wind speed, sunlight, shade, rain, snow, etc.), a price of electricity, an amount of available input thermal energy (e.g., waste heat), a temperature of the input thermal energy, and/or other variables as inputs, and may provide information specifying operating parameters of system 100 (FIG. 1) or 200 (FIG. 2) as outputs.

FIG. 10 presents a block diagram illustrating an example of a neural network 1000. Notably, neural network 1000 may be implemented using a convolutional neural network. This neural network may include a network architecture 1012 that includes: an initial convolutional layer 1014 that provides filtering of inputs 1010; one or more additional convolutional layer(s) 1016 that apply weights; and an output layer 1018 (such as a rectified linear layer) that performs classification (e.g., distinguishing a dog from a cat) and provides output 1020. Note that the details with the different layers in neural network 1000, as well as their interconnections, may define network architecture 1012. These details may be specified by the instructions for neural network 1000. In some embodiments, neural network 1000 may be reformulated as a series of matrix multiplication operations. Note that neural network 1000 may be used to analyze inputs (such as inputs 1010).

In some embodiments of computer system 900 (FIG. 9) and/or neural network 1000, there may be fewer or more components, a position of a component may be changed, at least two components may be combined, and/or a component may be divided into two or more components.

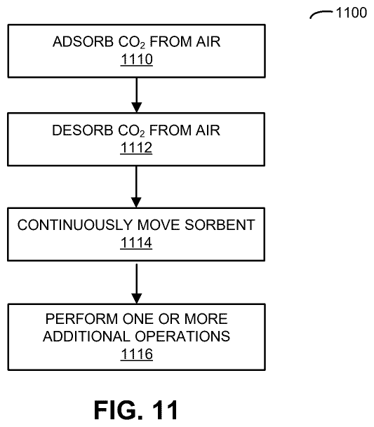

We now describe embodiments of the method. FIG. 11 presents a flow diagram illustrating an example of a method 1100 for adsorbing CO₂ from air, which may be performed by a system, such as system 100 (FIG. 1) or 200 (FIG. 2). During operation, the system, using an adsorber, adsorbs the CO₂ from the air (operation 1110) using a sorbent (operation 1110). Moreover, the system, using a desorber, desorbs the adsorbed CO₂ (operation 1112) from the sorbent into an output of the system. Furthermore, the system continuously moves the sorbent (operation 1114), as an ensemble, through the system. Note that the sorbent includes a free-standing bulk solid.

The continuous motion may include steady-state operation of the system. Moreover, the continuous motion may exclude a batch process (e.g., adsorption followed by desorption). Instead, a portion of the sorbent may be used for the adsorption (operation 1110) and a second portion of the sorbent may concurrently be used for the desorption (operation 1112). Furthermore, the system may perform multiple iterations of the adsorption (operation 1110) and the desorption of the CO₂ (operation 1112) without ceasing operation of the system, and a given iteration of the multiple iterations may include a cycle of transit of the sorbent, as the ensemble, through the system.

Additionally, the sorbent may not be included in a frame or a package (such as a filter).

In some embodiments, the desorber is separate from the adsorber. Thus, the desorber may be an independent component in the system from the adsorber.

Moreover, the sorbent may be other than or different from a liquid.

Note that the adsorbed CO₂ may be desorbed in the system without applying heat to generate steam for use in the desorption.

Furthermore, contact between the sorbent and the air in the system may only occur in the adsorber.

Additionally, the system may operate without start or stop operations while capturing the CO₂ in the air.

In some embodiments, the adsorber may include a gravity-flow packed bed that moves the sorbent in a direction having a vertical component while flowing the air at a non-zero angle to the direction (such as approximately) 90°. Moreover, the adsorber may include a distribution plate that spreads out the sorbent in the gravity-flow packed bed. Furthermore, a flow of the sorbent through the gravity-flow packed bed may be controlled by a valve at a bottom of the gravity-flow packed bed. (In addition, the flow of sorbent may be related to a thickness of sorbent 114 in the gravity-flow packed bed.) For example, the value may include a rotary valve or a flip valve.

Note that the desorber may include a device having a pressure other than atmospheric pressure. For example, the pressure may include between approximately 0.5 and 5 psi. However, in other embodiments, the pressure may exceed atmospheric pressure. Moreover, the device may be oriented along a vertical direction or a horizontal direction.

In some embodiments, the device may include, at an input to the device, an entry device that supports a differential pressure across the entry device and that allows the free-standing bulk solid pass through the entry device at a controlled rate and, at an output of the device, an output device that supports the differential pressure across the output device and that allows the free-standing bulk solid pass through the output device at the controlled rate. For example, the entry device or the output device may include an airlock. Note that the entry device or the output device may include: a vacuum double rotary disc, a Fetzer valve, a knife gate or a chamber lock. Moreover, the entry device and the output device may support continuous flow of the sorbent, as the ensemble, in the system. Furthermore, the system may heat the sorbent in a first portion of the device to extract water and/or the adsorbed CO₂, and then may cool the sorbent in a second portion of the device.

Additionally, the system may have a variable or adjustable cycle time for the sorbent to transit through the system.

Note that the system may operate over a range of ambient temperatures greater than 10 C and a range of relative humidity greater than 7%. For example, the system may operate over ambient temperatures between −40 C and 55 C and relative humidity greater than 7%.

Furthermore, the desorber may operate at or below approximately 80 C or 100 C.

Additionally, when in contact with air, the sorbent temperature may be approximately less than 50 C.

Inputs to the system may include the air and electricity, and outputs from the system may include water and/or the CO₂. Moreover, the inputs may include thermal energy. For example, the thermal energy may be associated with a geothermal source. Alternatively or additionally, the thermal energy may be input from a separate source than the system. Note that the thermal energy may be input from a heat pump or heat bags (or solar bags).

Note that the free-standing bulk solid may have or may include particles having an irregular or asymmetric shape.

In some embodiments, a concentration of the CO₂ in the air is an ambient concentration or is larger than the ambient concentration. For example, the air may be input from a point source.

Moreover, the CO₂ in the output may have a purity exceeding 99% (such as 99.6%) and an impurity in the output may include air and/or water.

In some embodiments, the system performs one or more optional additional operations (operation 1116). For example, the adsorber may adsorb water from the air using the sorbent and the desorber may desorb the adsorbed water from the sorbent into the output. Note the system may provide the water to a data center or for irrigation. Alternatively or additionally, the system may provide the water as potable water.

Moreover, the system may preheat water used for desorbing the adsorbed CO₂ based at least in part on a price of electricity at off-peak hours or at night.

Furthermore, the system may operate without environmental control or constraint. Additionally, operating parameters of the system may be selected based at least in part on a predicted or forecast temperature, and/or a predicted or forecast relative humidity in an external environment of the system. Alternatively or additionally, the operating parameters of the system are selected, generated or modified based at least in part on current environmental conditions in the external environment of the system.

After N cycles of the sorbent transiting, as the ensemble, through the system, where N is a non-zero integer, the sorbent may be replaced while the system is operating. The replaced sorbent may be recycled (or rejuvenated). For example, the recycled sorbent may be reused in the system. Alternatively or additionally, the recycled sorbent may be used as a water filter for amines.

Note that the system may be used to cool an industrial process. For example, the system may be used instead of cooling towers. Alternatively or additionally, the system may provide cooling to a data center. In some embodiments, the system may cool solar panels based at least in part on an operating efficiency of the solar panels.

Moreover, the CO₂ in the output may be sequestered. Alternatively or additionally, the CO₂ in the output may be used to create synthetic fuel, concrete and/or fertilizer. In some embodiments, the CO₂ in the output may be input to a greenhouse.

Furthermore, the system may have scheduled and preemptive maintenance following operation for a predefined time interval and the predefined time interval may be at least 50 weeks (with no start or stop operations). For example, the scheduled and preemptive maintenance may include two weeks.

Note that the system may include a first heat pump and a second heat pump that circulate heat (or thermal energy) in the system. The first heat pump may upgrade a first heat to a second heat, and the second heat pump may upgrade a third heat to a fourth heat. A difference of the fourth heat and the third heat may be larger than a difference of the second heat and the first heat. In some embodiments, the system may selectively use the first heat pump and/or the second heat pump based at least in part on availability of input thermal energy to the system, a temperature of the input thermal energy, and/or a price of electricity.

Moreover, the system may use different types of sorbent having different compositions and/or material properties based at least in part on environmental conditions in an environment of the system.

In some embodiments of method 1100, there may be additional or fewer operations. Furthermore, the order of the operations may be changed, and/or two or more operations may be combined into a single operation. Note that at least some operations in method 1100 may be performed sequentially, concurrently or in parallel with each other.

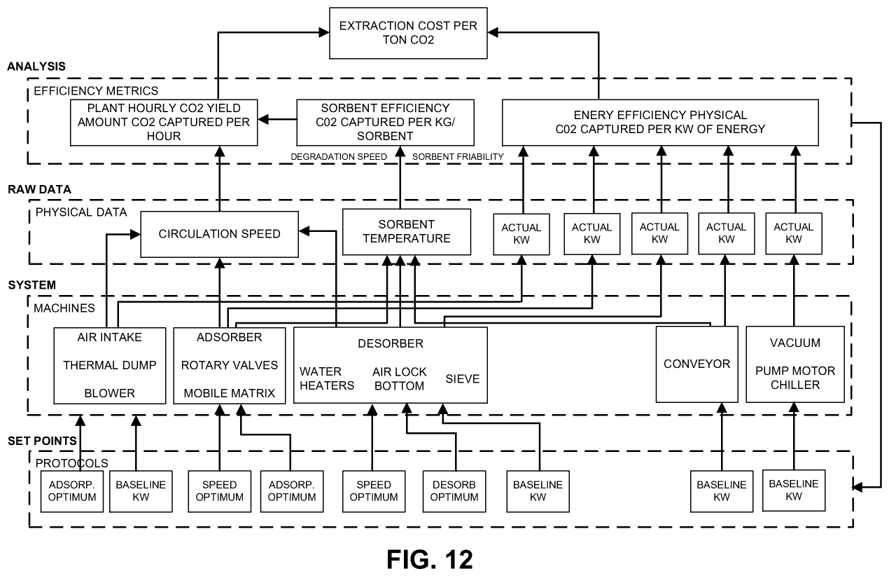

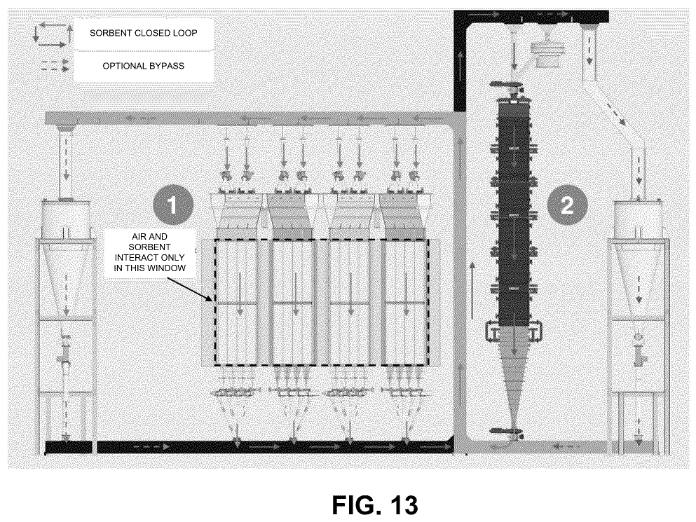

We now further describe embodiments of the system, its components and its operation. FIG. 12 presents a block diagram illustrating an example of system 100 (FIG. 1) or 200 (FIG. 2). Note that system 100 (FIG. 1) or 200 (FIG. 2) in FIG. 12 may include: an air-intake fan, an adsorber, a filtration (dust) filtering (which may optionally be integrated into the adsorber), air-intake heating, a vacuum subsystem, CO₂ compression, a feed subsystem (such as a conveyance), a desorber, one or more heat pumps, heat reuse for a dryer in the desorber, heat reuse for a desorption region in the desorber, plant controls or control logic, plant plumbing, plant electrical, and/or the sorbent. Moreover, FIG. 13 presents a block diagram illustrating an example of a sorbent flow loop between an adsorber and a desorber in system 100 (FIG. 1) or 200 (FIG. 2).

We now further describe embodiments of the adsorber. FIG. 14 presents a block diagram illustrating an example of a perspective view of an adsorber in system 100 (FIG. 1) or 200 (FIG. 2). Moreover, FIG. 15 presents a block diagram illustrating an example of a side view of an adsorber in system 100 (FIG. 1) or 200 (FIG. 2).

The adsorber (AD-1) is the part of the system that adsorbs CO₂ and/or water from the air through its interaction with the sorbent. The CO₂ and/or water are then collected, and may be stored and/or eventually sold. The adsorber may include various components that control how efficiently the sorbent adsorbs CO₂ from the air as both the air and the sorbent flow through the system. Notably, these components may control: the speed, temperature, and relative humidity of the airflow; and the speed of the sorbent flow in the system. (Note that relative humidity may measure water vapor relative to the temperature of the air.) Thus, the adsorber may ensure that the air and the sorbent interact efficiently.

In order to optimize the sorbent residence time (or the time that the sorbent is in contact with the air in the adsorber) and to consume less or the minimum amount of energy as possible when operating the system, the adsorber may control: the amount of airflow (measured in cubic meters per hour or CMH or m³/h); and the amount of sorbent needed for sufficient capacity to adsorb CO₂ from the air (which is measured in pounds per hour or PPH, or kilograms per hour or kg/h). These factors may determine the residence time of the air and the sorbent interaction (or the time the air and the sorbent take to interact). In some embodiments, it may take between 20 to 60 minutes for the CO₂ to adsorb to the sorbent. Moreover, in some embodiments, the residence time may be about 40-60 minutes.

When the sorbent interacts with the air, it may adsorb CO₂ and/or water (e.g., the sorbent may adsorb up to five times more water than CO₂). Both the temperature of the air and its relative humidity may affect how much water is adsorbed. The more water that is adsorbed, the more energy is spent to remove the water. The goal of an optimal residence time may be to spend as little energy as possible to operate the system, while having the shortest possible residence time.

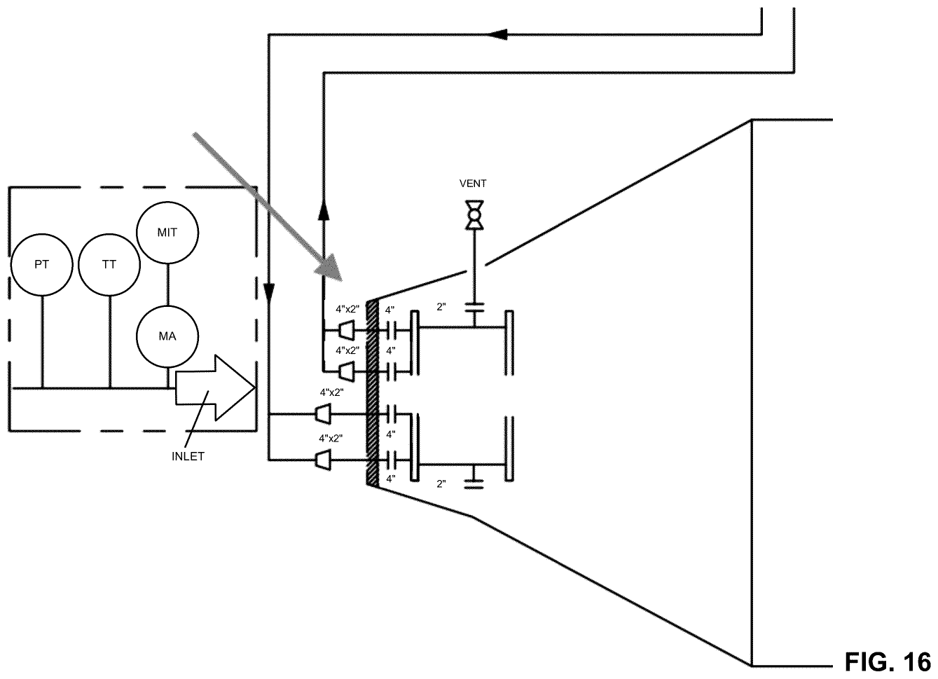

Thus, the adsorber may control the length of time and the speed of the air that interacts with the sorbent to ensure an optimal residence time for CO₂ adsorption. Airflow may enter an inlet of the adsorber at its ambient temperature and relative humidity. A thermal dump in the system may be a water-to-heat exchanger (HX-1) at the inlet of the adsorber that may heat the incoming airflow to control its relative humidity and temperature, which affects how it interacts with the sorbent. The airflow volume may be controlled by a blower (BF-1) at the outlet of a baghouse in the system. This is shown in FIG. 16, which presents a block diagram illustrating an example of a heat exchanger in system 100 (FIG. 1) or 200 (FIG. 2).

As air flows through the inlet, it may enter one or more gravity-fed packed beds (such as four gravity-fed packed beds, GFPB-1 to GFPB-4) where it interacts with the sorbent. Motion of the sorbent through the one or more gravity-fed packed beds is under the influence of gravity. Notably, the sorbent may flow under the influence of gravity through two, e.g., 100-500 μm screens that prevent the material from escaping. The gap between the two screens may be, e.g., 25-75 mm. Then, the sorbent with the captured (adsorbed) CO₂ may be conveyed to the desorber.

Note that a gravity-fed packed bed may include the space in between hoppers where the sorbent and the air are mixed. A packed bed may include a hollow tube, pipe, or another vessel that is filled with a packing material. Moreover, a hopper may include a large container that is used in industrial processes to hold particulate matter and dispense the particulate matter from the bottom of the hopper when needed.

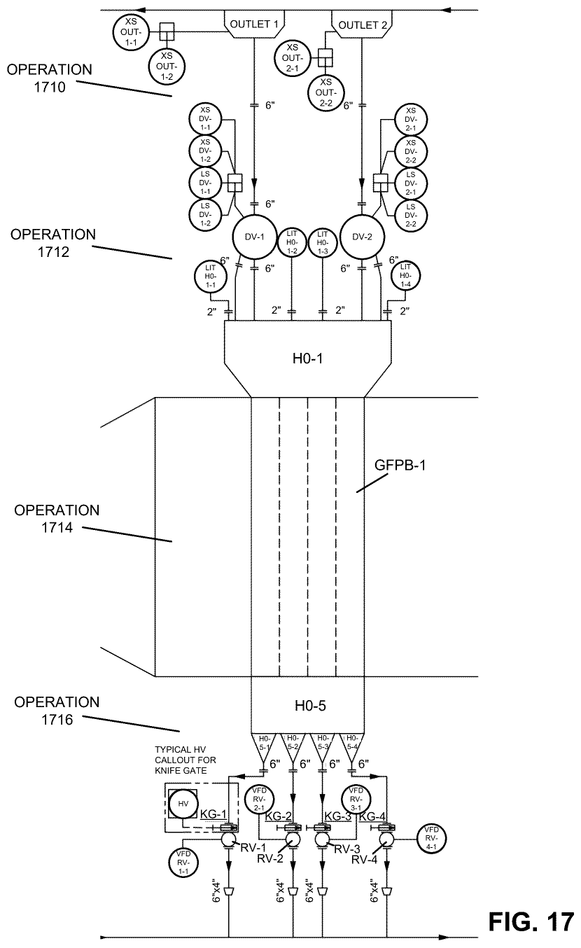

As discussed previously and shown in FIG. 17, which presents a block diagram illustrating an example of sorbent flow in system 100 (FIG. 1) or 200 (FIG. 2), the sorbent may be a chemical compound to which CO₂ from the air attaches. In some embodiments, the adsorber may control the flow of sorbent through values (such as rotary valves, RV-1 to RV-16) below the one or more gravity-fed packed beds to ensure that the sorbent interacts with the air to efficiently adsorb CO₂. Note that a rotary valve is a type of valve in which the rotation (based at least in part on motor output from a variable frequency drive) of a passage or passages in a transverse plug regulates the flow of material through attached pipes.

During the sorbent flow through the adsorber, the sorbent may be conveyed from the desorber (DE-1) to the adsorber (AD-1) using a conveyor (operation 1710). For example, the conveyor may include a bucket conveyor that has one or more outlets (such as eight outlets, OUT-1 to OUT-8) where the bucket conveyor selectively feds into the hoppers (HO-1 to HO-4). Each outlet may have a linear actuator and two switches (such as limit switches, LSOUT-x-1 and LS-OUT-x-2) that control whether buckets of sorbent will dump in that location.

Then, in operation 1712, the sorbent may travel to diverter valves (such as DV-1 to DV-8) where it is sent into one of two chutes (e.g., left or right) to eventually form four piles in the hoppers (HO-1 to HO-4). Note that a given diverter valve may use two digital outputs to control position and two digital inputs to detect when the given diverter valve is positioned left, right, or in between. Thus, an actuator and two limit switches (LS-DV-x-1 and LS-DV-x-2) on each of the diverter valves may control the direction the sorbent will travel in the hopper, such that each pile is roughly equal in size. Level sensors (LIT-HO-1-1 to LIT-HO-4-4) may use a capacitive rod to measure the sorbent level at each of the 16 piles. Next, the sorbent may enter the one or more gravity-fed packed beds.

As shown in operation 1714, the one or more gravity-fed packed beds may be where the sorbent and the air interact for CO₂ and/or water adsorption. This is further illustrated in FIG. 18, which presents a block diagram illustrating an example of a cross-sectional view of the gravity-flow packed bed in the adsorber in system 100 (FIG. 1) or 200 (FIG. 2). Notably, instead of using counter-current flow (which can provide a high concentration gradient and, therefore, greater solute removal), in the one or more gravity-fed packed beds in the discloses system solid (sorbent) and gas (CO₂) flow may be approximately at right angles or approximately 90° (cross-current). (More generally, the solute and the CO₂ flows may be at a finite, non-zero angle between 0 and 90°.) Cross-current flow may be more economical for large flow rates because it causes less pressure drop than counter-current. Moreover, by using cross-current flow, the one or more gravity-fed packed beds may have a low profile and, thus, may provide space savings. In the disclosed adsorber, the one or more gravity-fed packed beds may combine at least approximately cross-current flow with a continuous flow, as an ensemble, of the sorbent through the one or more gravity-fed packed beds. As shown in FIG. 18, note that the concentration of CO₂ may decrease (and, more generally, vary) along the length (e.g., from top to bottom) of the gravity-fed packed bed.

In some embodiments, a horizontal airflow through the one or more gravity-fed packed beds may have a velocity of 0.1-0.5 m/s and a vertical sorbent flow may have a velocity of 0.001-0.01 m/s.

Referring back to FIG. 17, in some embodiments four gravity-fed packed beds may be split into four channels. Each of the channels may be controlled independently to account for the difference in the air pressure coming in through the channels. Note that, when the air moves slowly through the edges of the one or more gravity-fed packed beds and faster through the middle due to differences in the packing density of the sorbent in each channel, there may be more air in the middle channels than on the outer channels. Consequently, when the rotary valves are slowed down in the outer channels, the amount of CO₂ and/or water adsorbed by all channels may be roughly equal.

Furthermore, as shown in operation 1716, the sorbent flow rate may, at least in part, be controlled by the rotary valves below hoppers (HO-5 to HO-8) below the one or more gravity-fed packed beds. The sorbent may flow uniformly through the one or more gravity-fed packed beds and may not stick to the sides. Additionally, the incoming airflow may be controlled to ensure the necessary amount of CO₂ is in contact with the sorbent to meet CO₂ uptake requirements, such as 0.5-2.0 mol-CO₂/kg-sorbent. Note that the cross-section area may be fixed, so that only the fan may control the speed of the air. In addition, once the air has gone through the one or more gravity-fed packed beds, the sorbent may be fully saturated with CO₂ and/or water.

From the hopper (HO-5 to HO-8), the sorbent may move through a funnel and into the rotary valves. A variable frequency drive (VFDRV-X-1), which is a type of motor drive that controls speed and torque of an integrated motor by varying the frequency of the output of the motor, which may be coupled or connected to the rotary valves. The variable frequency drive may determine the rotations per minute (RPM) of the motor to affect the speed of the sorbent flow. For example, a variable frequency drive may provide a motor output that results in three-phase sinusoidal motion of the rotary valve that can alter the speed of the rotary valve. Note that faster sinusoidal motion may indicate that that the rotary valve spins faster. Moreover, a larger current may allow a variable frequency drive to increase the torque provided by the motor.

When the air and the sorbent interact, the sorbent may adsorb the CO₂. Then, as shown in FIG. 19, which presents a block diagram illustrating an example of a baghouse fan and stack in system 100 (FIG. 1) or 200 (FIG. 2), the variable frequency drive-controlled baghouse blower (BF-1) may blow the clean air out of the adsorber, through the baghouse (FT-2), and out of the stack (ST-1). The baghouse may filter fine particles that get trapped in the air to prevent pollution. Moreover, the stack may prevent fast-moving air from being pushed out at a low height.

We now further describe embodiments of the desorber. The desorber (DE-1) is the part of the system that collects CO₂ and/or water from the sorbent through desorption. The CO₂ and/or water may then may be stored and/or eventually sold. The desorber may maintain a target cycle time for the sorbent in the system in order to achieve desorption by controlling: the temperature (e.g., degrees Celsius) of the sorbent; the speed (rpm) and volumetric flow rate of the sorbent flow; the fill level of the sorbent within the desorber; and/or a vacuum level (and, more generally, pressure) within the desorber.

In some embodiments, the desorber (DE-1) may be a bulk solid heat exchanger that includes a vacuum chamber with, e.g., six plate banks designed to remove CO₂ and/or water from the sorbent through desorption.

In order to ensure that CO₂ and/or water are efficiently desorbed from the sorbent, the desorber may include components that control: the temperature of the sorbent; the speed of the sorbent flow; the fill level of the sorbent within the desorber; and/or the flow of gas out of the desorber.

Sorbent that has adsorbed CO₂ and/or water may be conveyed from the adsorber (AD-1) to the desorber. In the desorber, one or more dryer banks (e.g., three) may heat the sorbent to release the water, one or more desorber banks (e.g., two) may heat the sorbent to release CO₂, and a cooler bank may bring the sorbent temperature down to ambient temperatures. Cooling may avoid damaging the sorbent. Then, the sorbent may be conveyed back to the adsorber to complete a cycle or may be placed in storage.

The sorbent flow through the desorber is shown in FIG. 20, which presents a block diagram illustrating an example of sorbent flow in the desorber in system 100 (FIG. 1) or 200 (FIG. 2). In operation 2010, a bucket conveyor (OUT-9 to OUT-10) may carry the sorbent from the adsorber (AD-1) and may dump it into: a buffer hopper before it enters the desorber (DE-1); and/or a sieve to separate out the fine particles in the sorbent before it enters the buffer hopper. Note that a level sensor (LIT DE-1-1) may allow the system (such as control logic) to control the amount of sorbent in the buffer hopper. This buffer may hold, e.g., a five-minute amount of sorbent to adequately fill a rotary airlock, such as a rotary valve (a type of valve in which the rotation of a passage or passages in a transverse plug regulates the flow of material through attached pipes). Notably, from the buffer hopper, the sorbent may enter the inlet rotary airlock (AL-1), where the sorbent flow speed may be maintained before it enters the desorber (DE-1). The sorbent speed within the desorber may be controlled by a rotary airlock at the outlet (AL-2) in operation 2020.

In operation 2012, the sorbent may travel from the rotary airlock to the inlet hopper of the desorber, where it is held at vacuum throughout the desorption process. Note that a level sensor (LIT-3001) may track the level of sorbent for the desorber and may be used to determine the speed of the inlet rotary airlock needed to maintain an acceptable level. The sorbent flow rate within the desorber may be controlled by the speed of a rotary valve, such as rotary airlock (AL-2), at the outlet of the desorber.

Moreover, the sorbent may flow from the inlet hopper to a series of six plate banks that make up the desorber. Pressure sensors (PIT-7001 to PIT-7008) in each plate bank (as well as the inlet buffer and mass flow cone) may measure the vacuum level of the desorber. These plate banks may be held at different temperatures to release CO₂ and/or water from the sorbent. Throughout the plate banks, sensors may track the temperature of the sorbent (TI-3001 to TI-3012) in the bank and the temperature of a, e.g., glycol mixture (TI-5001 to TI-5012) that flows through the plates.

Then, in operation 2014, the sorbent may enter dryer plate banks 1 through 3 where water flows into the plates to maintain a sorbent temperature of, e.g., 40 to 50 C to release water from the sorbent. The temperature of the dryer plate bank may be controlled by control logic, such as software, e.g., a water module-heater control panels (using water heaters WH-01 to WH-3). Note that flow sensors (FIT-5001 to FIT-5006) may measure the volumetric flow rate of the water flowing in and out of the desorber banks and back to their respective water heaters/banks.

In some embodiments, the water may be converted to water vapor and sent to a vacuum system where it may be eventually sent to storage.

Moreover, in operation 2016, the sorbent may enter desorber plate banks 4 and 5, where water flows into the plates to maintain a sorbent temperature of, e.g., 70 to 80 C to release the CO₂ from the sorbent. The temperature of the desorber plate banks may be controlled by control logic, such as software, e.g., the water module-heater control panels (using water heaters WH-4 to WH-5). In some embodiments, the CO₂ may be converted to a gas and sent to the vacuum system, where it may be eventually sent to storage.

Next, in operation 2018, the sorbent may enter the final bank, cooler plate bank 6, where water flows into the plates to cool down the temperature of the sorbent before it exits the desorber at, e.g., 10 to 30 C. The temperature of the cooler plate bank may be controlled by a chiller (CH-1) through a plated heat exchanger (PFX) and a temperature control valve (TCV-5001). (Note that the temperature control valve may determine whether or not the cooler bank uses water that flows from the plate exchanger. If the water does not flow through the plate exchanger, water flow may be cyclical from the cooler bank plate.) The sorbent may set to an acceptable temperature (such as 10-40 C) to prevent damage as it adjusts back to atmospheric pressure. In some embodiments, there may be temperature sensors (TI-7001 to TI-7006) that detect the outlet temperature of the gas exiting the desorber (in general, these gases may be a mixture of air, water vapor, and CO₂).

Furthermore, in operation 2020, the sorbent exits the desorber through the outlet rotary airlock (AL-2) airlock. This rotary airlock may also control the speed of the sorbent throughout the desorber. After the sorbent exits the desorber, it may enter a bucket conveyor, where it is sent back to the adsorber or placed in storage.

Note that the rotary airlock may be a valve that includes two airtight pneumatically powered knife gates, in which sorbent flow is maintained before it enters the desorber while maintaining a vacuum. As discussed previously, the desorber may include at least two rotary airlocks. The inlet rotary airlock for the desorber. may regulate the flow of the sorbent into the desorber. Moreover, the outlet rotary airlock for the desorber may regulate the flow of the sorbent within the desorber.

Vacuum may need to be maintained during the desorption in order to: prevent the vacuum pump(s) from being overworked and expending unnecessary energy; and to prevent the sorbent from being damaged. Notably, if the sorbent is heated while it is not in a vacuum, it may be permanently damaged through oxidization and may no longer be able to adsorb CO₂ as efficiently. Consequently, in the event of an emergency shutdown, a vacuum may be maintained in the desorber if there are any issues with cooling down the sorbent. If the vacuum is lost, then the sorbent must be cooled as quickly as possible, e.g., to be below 30 C to ensure that it is not damaged permanently.

As shown in FIG. 21, which presents a block diagram illustrating an example of a plate bank in the desorber in system 100 (FIG. 1) or 200 (FIG. 2), the desorber (DE-1) may include, e.g., six plate banks that are divided to conserve energy while controlling the sorbent temperatures for CO₂ and/or water desorption. Each plate bank may include pillow plates approximately 0.5 to 1″ wide that circulate a mix of glycol water to facilitate the thermal heat transfer used for sorbent temperature control in the desorber.

Water heaters (WH-01 to WH-05) and the chiller (CH-1) may control the temperature of the glycol mixture that flows (based at least in part on the operation of a pump) into the pillow plates in each bank of the desorber. The inlet and outlet temperature of the glycol mixture in each bank may be monitored by sensors (e.g., TI-5001 to TI-5012). The temperature sensors may be organized by pair, e.g., odd numbers may represent the inlet and even numbers may represent the outlet.

Thermal transfer may occur through conduction and the process may involve heating and cooling the banks that are closely monitored by temperature probes (e.g., TI-3001 to TI-3012) within the desorber. These probes may come in direct contact with the sorbent on opposing sides of each plate bank, ensuring it attains the desired temperature during the desorption process. The communication between the system (such as the control logic) and the desorber may involve passing set points for each water heater, specifying desired temperatures, and establishing a set flow rate for sorbent through the desorber. The desorber may ensure that the sorbent flowing through the desorber achieves the correct temperature with the control interface managed through its designated control logic (such as software). Table 1 provides example values of how each plate bank affects the sorbent temperature as it travels through the desorber.

TABLE 1

| Plate Bank Temperature | Temperature (C.) | Description |
|---|---|---|
| Dryer Plate Bank 1, 2 or | 30-50 | Dryer plate banks 1, 2, and |
| 3 | | 3 are heated to release |
| | | water from the sorbent as a |
| | | water vapor. |
| Desorber Plate Bank 1 or | 60-80 | Desorber plate banks 1 and |
| 2 | | 2 are heated to release CO₂ |
| | | from the sorbent as a gas. |
| Cooler Plate Bank 1 | 10-30 | Cooler plate bank 1 cools |
| | | the sorbent so that it may |
| | | return to atmospheric |
| | | pressure safely. |

Note that each plate bank may include a port that converges and connects to the vacuum pump. In order to achieve even flow to the six ports, a flow control valve (such as a butterfly valve) and flow meter may be placed on the main line connecting the plate banks to the vacuum pump. This may allow for precise adjustment, ensuring balanced flow (e.g., of gas out of each plate bank) and preventing potential drive imbalances among the plate banks.

In some embodiments, the desorber may include an entry device and an output device (such as rotary airlocks AL-1 and AL-2). The entry device may support a differential pressure across the entry device (such as between 1 atmosphere and between approximately 0.5 and 5 psi in the desorber) and the output device may support a differential pressure across the output device (such as between approximately 0.5 and 5 psi in the desorber and 1 atmosphere). For example, the entry device and the output device may include airlocks, such as an inflatable seal spherical valve. These valves may maintain a seal even when there are process fluctuations between pressure and vacuum. Moreover, there may not be sliding contact against the seal as a given valve rotates. Note that the seal may be bidirectional and may selectively provide a full open port. Thus, a given inflatable seal spherical valve may have a long, low-maintenance service life.

The desorber vacuum seals may provide continuous flow of the sorbet (the free-standing bulk solid) through the vacuum seals at a controlled rate. In some embodiments, the desorber vacuum seals include model *** (from Solex Thermal Science, Inc. of Calgary Canada).

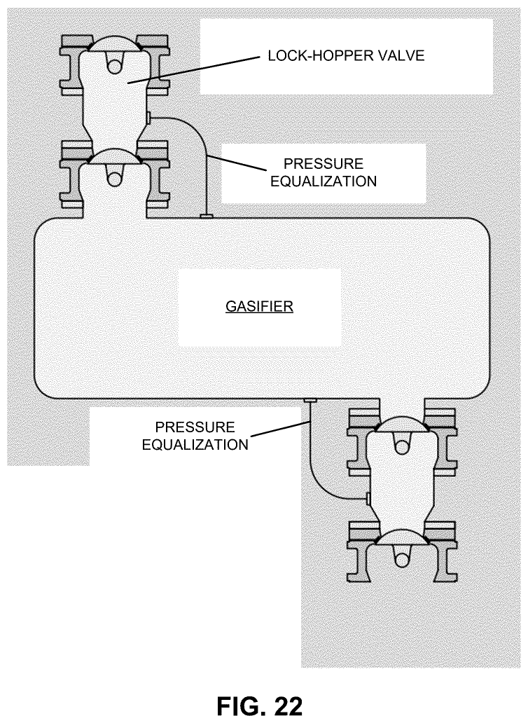

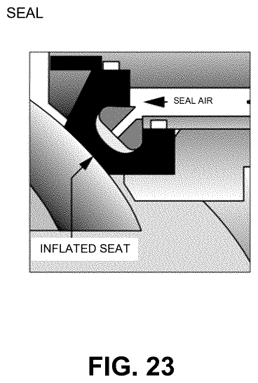

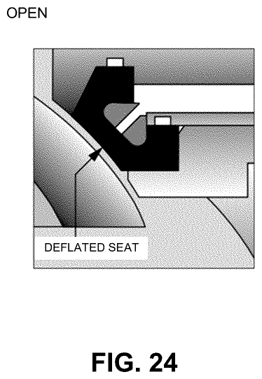

FIG. 22 presents a drawing illustrating an example of an entry device or an output device in the desorber in system 100 (FIG. 1) or 200 (FIG. 2). In FIG. 22, in a typical installation, two roto values may be placed in series and may be opened or closed independently, so that the pressure of vacuum is contained above or below the assembly. Moreover, FIG. 23 presents a drawing illustrating an example of operation of an entry device or an output device in the desorber in system 100 (FIG. 1) or 200 (FIG. 2). Notably, compressed air may enter an inflatable seal assembly and may inflate the seal against a dome. Furthermore, FIG. 24 presents a drawing illustrating an example of operation of an entry device or an output device in the desorber in system 100 (FIG. 1) or 200 (FIG. 2). Notably, compressed air may be released causing the seal to relax and allowing the dome to rotate.

We now further describe the sorbent. The sorbent may include a functionalized material. Notably, the functionalized material may include: multiple porous particles; and a surface modification layer disposed on at least a portion of a surface of at least one of the multiple porous particles, where the surface modification layer may include an adsorbing moiety including one or more amine moieties. In some embodiments, the material may adsorb CO₂ under a first condition and may reversibly desorb adsorbed CO₂ under a second condition.

In some embodiments, the multiple porous particles may include multiple porous silica particles, multiple porous metal-organic framework (MOF) particles, or multiple ion-exchange resin particles. In some embodiments, the multiple porous particles may include a porous silica or silicate, a porous ceramic, a porous metal-organic substrate, a porous polymeric substrate, a porous ceramic/metal oxide together with porous silica, a porous alumina, a metal-organic framework (MOF), or a resin. In some embodiments, the multiple porous particles may include a substrate provided in a precipitated form, a sol-gel form, a fumed form, a calcined form, an agglomerated form, a granulated form, a powder, or a granule.

In some embodiments, the multiple porous particles may include an average dimension or a mean dimension (e.g., a diameter) from about 25 μm to 4 mm (e.g., from 25 μm to 3 mm, 25 μm to 2 mm, 25 μm to 1 mm, or other ranges described herein).

In some embodiments, the multiple porous particles may include multiple pores. In some embodiments, the multiple pores may include a dimension from about 1 to 200 nm, an average pore size from about 30 to 80 nm, and/or a volume greater than about 0.1 mL/g or 0.5 mL/g (e.g., from 0.1 to 5 mL/g).

In some embodiments, the multiple porous particles may include a greatest dimension of at least 25 μm. In some embodiments, multiple pores of the multiple porous particles may include a dimension of at least about 1 nm and/or a volume greater than about 0.5 mL/g.

In some embodiments, the surface modification layer may include 5% to 60% (wt/wt) of a polyamine (e.g., any described herein, such as a small molecule polyamine, a large molecule polyamine, a low molecular weight (MW) polyamine, a high MW polyamine, an oligomeric form of polyamine, or a polymeric form of polyamine) to the multiple porous particles lacking the surface modification layer. In some embodiments, the polyamine may be a large molecule polyamine, a high MW polyamine, or a polymeric form of polyamine. In some embodiments, the polyamine may be any described herein. In some embodiments, the polyamine may be present in an amount of about 5% to 60% (wt/wt) of the polyamine to the multiple porous particles (e.g., an amount of 5% to 50%, 5% to 40%, 5% to 30%, 10% to 60%, 10% to 50%, 10% to 40%, 10% to 30%, 20% to 60%, 20% to 50%, 20% to 40%, 20% to 30%, 30% to 60%, 30% to 50%, 40% to 60%, or 50% to 60% (wt/wt)).

In some embodiments, the surface modification layer may include 5% to 80% (wt/wt) of an aminosilane to the multiple porous particles lacking the surface modification layer. In some embodiments, the aminosilane may include any described herein. In some embodiments, the aminosilane may be present in an amount of about 5% to 80% (wt/wt) of the aminosilane to the multiple porous particles (e.g., an amount of 5% to 70%, 5% to 60%, 5% to 50%, 5% to 40%, 5% to 30%, 10% to 80%, 10% to 70%, 10% to 60%, 10% to 50%, 10% to 40%, 10% to 30%, 20% to 80%, 20% to 70%, 20% to 60%, 20% to 50%, 20% to 40%, 20% to 30%, 30% to 80%, 30% to 70%, 30% to 60%, 30% to 50%, 40% to 80%, 40% to 70%, 40% to 60%, 50% to 80%, 50% to 70%, or 50% to 60% (wt/wt)).

In some embodiments, the multiple porous particles may include a total surface area greater than about 100 m² per dry gram. In some embodiments, the material may adsorb greater than about 0.8 mol of CO₂ per dry kilogram (mol CO₂/kg) or from about 0.5 to 2.5 mol CO₂/kg.

In some embodiments, the material may adsorb CO₂ at a relative humidity in a range from about 0% to 100% or from about 5% to 95%.

In some embodiments, the surface modification layer may include: (i) an amine moiety and a silane moiety, (ii) multiple amine moieties, or (iii) both (i) and (ii). In some embodiments, the surface modification layer may be provided by interacting one or more compounds with at least a portion of the surface of at least one of the multiple porous particles. In some embodiments, the one or more compounds may be selected from the group consisting of an aminosilane and/or a polyamine. In some embodiments, the polyamine may be a small molecule polyamine, a low MW polyamine, a large molecule polyamine, a high MW polymer, an oligomeric polyamine, a polymeric polyamine, or mixtures thereof.

In some embodiments, the first condition may include a first temperature range, and the second condition may include a second temperature range higher than the first temperature range. In some embodiments, the first condition may include a first gas pressure (e.g., that is a partial pressure for CO₂), and the second condition may include a second gas pressure (e.g., that is a partial pressure for CO₂) lower than the first gas pressure. In some embodiments, the first condition may include a first CO₂ concentration, and the second condition may include a second CO₂ concentration lower than the first CO₂ concentration.

In some embodiments, the material may further include an antioxidant moiety, an additive, a hydrophobic silane compound, and/or a hydrophobic polymer (e.g., any described herein).

In some embodiments, a method for forming a functionalized material may include: introducing a first reagent to multiple porous particles and a solvent medium, thereby providing a functionalization mixture, where the first reagent includes at least one adsorbing moiety including one or more amine moieties; removing a functionalized material from the functionalization mixture, where the functionalized material includes the multiple porous particles and a surface modification layer disposed on at least a portion of a surface of at least one of the multiple porous particles, and where the surface modification layer includes the at least one adsorbing moiety; and drying the functionalized material.

In some embodiments, the first reagent may include an aminosilane, where the aminosilane may include at least one amino moiety and at least one silane moiety. In some embodiments, the at least one silane moiety may include an alkoxysilane moiety, a trihalosilane moiety, a dihalosilane moiety, a monohalosilane moiety, a silanetriol moiety, a dialkoxysilanol moiety, a monoalkoxysilanol moiety, or an aminosilane oligomer. In some embodiments, the at least one silane moiety may include any described herein. In some embodiments, the first reagent including the aminosilane may be provided in the presence of a second reagent, and the second reagent may include a polyamine. In some embodiments, the first reagent may be provided to the multiple porous particles, and then a second reagent including a polyamine may be provided to the functionalization mixture.

In some embodiments, the method may further include a second reagent including a polyamine, which may be provided to the functionalization material after removing from the functionalization mixture.

In some embodiments, the first reagent may include a polyamine. In some embodiments, the polyamine may be a small molecule polyamine, a low MW polyamine, a large molecule polyamine, a high MW polymer, an oligomeric polyamine, a polymeric polyamine, or mixtures thereof. In some embodiments, the first reagent including the polyamine may be provided in the presence of a second reagent, and the second reagent may include an aminosilane. In some embodiments, the first reagent may be provided to the multiple porous particles, and then a second reagent including an aminosilane may be provided to the functionalization mixture.

In some embodiments, the first reagent may include a small molecule polyamine or a mixture including multiple small molecule polyamines.

In some embodiments, the functionalization mixture may include 5% to 80% (wt/wt) of the first reagent to the multiple porous particles. In some embodiments, the first reagent may include a polyamine, and the functionalization mixture may include 5% to 60% (wt/wt) of the polyamine to the multiple porous particles. In some embodiments, the first reagent may include an aminosilane, and the functionalization mixture may include 5% to 80% (wt/wt) of the aminosilane to the multiple porous particles. Other ranges can be employed (e.g., any range described herein).

In some embodiments, the solvent medium may include water. In some embodiments, the solvent medium may include a polar aprotic solvent or a neutral aprotic solvent. In some embodiments, the solvent medium may include an organic solvent selected from toluene, hexane, cyclohexane, and tetrahydrofuran. In some embodiments, the solvent medium may include methanol, cyclohexane, hexane, ethanol, water, or a combination thereof.

In some embodiments, the drying may include drying to a hydration threshold of about 5% (wt/wt) of the solvent medium to the functionalized material. In some embodiments, the method may provide a sorbent material including a functionalized material (e.g., any described herein).

In some embodiments, a method for forming a functionalized material may include: introducing a first reagent and a second reagent to water, thereby providing a functionalization mixture; introducing multiple porous particles into the functionalization mixture for a time period, thereby forming a functionalized material; removing the functionalized material from the functionalization mixture; and drying the functionalized material.

In some embodiments, the first reagent may include a polyamine, and the second reagent may include an aminosilane.

In some embodiments, the functionalized material may include the multiple porous particles and a surface modification layer disposed on at least a portion of a surface of at least one of the multiple porous particles, where the surface modification layer may include at least one adsorbing moiety.

In some embodiments, the multiple porous particles may include a quantity of at least 25 kg. In some embodiments, the method may provide a sorbent material including a functionalized material (e.g., any described herein).

In some embodiments, the drying may include drying to a hydration threshold of about 5% (wt/wt) of the solvent medium to the functionalized material. In some embodiments, the drying may be performed in a double cone vacuum dryer, a conveyor belt dryer, or a Nutsche filter dryer.

We now describe characterization of different physical properties of or associated with the sorbent. Notably, measurements were performed at room temperature/humidity conditions (typical variation: 68-72 F and 20%-70% RH). The measurements included: small-scale fluidization measurements to determine if the material is a good candidate for fluidization; moisture-sorption measurements to evaluate the equilibrium moisture content as a function of atmospheric relative humidity at a set temperature; particle-size analysis; compressibility to determine the bulk density versus consolidating pressure relationship; particle density (SG) using a liquid-displacement technique to determine the ‘true’ density of the particles; permeability; dustiness (which provides a measure of dust release as a function of air velocity); attrition measurements to evaluate the propensity of the sorbent for particle degradation by degradation due to gravity impact, degradation as a result of interparticle shear during flow, and degradation due to compression under uniaxial consolidation forces; and sifting and fluidization segregation potential measurements using ASTM measurement techniques (from ASTM of West Conshohocken, Pennsylvania).

### Small-Scale Fluidization

The small-scale fluidization measurement included measuring bulk density and pressure gradient as a function of superficial gas velocity in a 4 in. (10.1 cm) diameter test column. The membrane used for the measurements was Dynapore LFM10, a sintered stainless-steel mesh.

The test column was filled approximately 6.4 in. (160 mm) deep with a measured weight of material and air flow was started. Air flow was increased in stages, allowing flow, pressure, and height to stabilize after each increase. Pressures, column height, and air flow rate were acquired for each equilibrium condition by a data acquisition system. Pressure was measured between two taps on the column, and between the lower tap and atmospheric pressure. Column height was measured by manually adjusting a distance transducer to the material top surface. Air flow was increased until the pressure differential between the two taps remained constant for several readings. Air flow was then reduced in stages until air flow reached zero.

As shown in FIG. 25, which presents a drawing illustrating an example of pressure drop as a function of superficial gas velocity of a sorbent, for materials that fluidize uniformly, the pressure drop first increases with increasing air velocity, reaches a peak, then decreases and eventually levels off. The condition where pressure drop does not change with increased air flow indicates a fluidized state, and the gas velocity at which this occurs is referred to as the complete fluidization velocity. In materials that do not fluidize completely, the pressure drop may never reach a steady level, but continue to change as the air velocity is varied.

Minimum fluidization velocity (Umf) refers to the point of incipient fluidization. It is defined as the intersection of the two parts of the pressure curve, e.g., the line of constant pressure drop corresponding to complete fluidization, and the line of changing pressure drop in a static contact bed.

Typically, there is a difference in the slope of the changing pressure drop portion of the curve between increasing air/gas flow and decreasing flow. The slope of the increasing flow portion is likely to be influenced by the ‘initial’ fill conditions whereas the decreasing flow curve usually has a more uniform fluidized state as its starting point. Consequently, often, instead of using the increasing airflow rate curve, the decreasing flow curve is used in determining the minimum fluidization velocity.

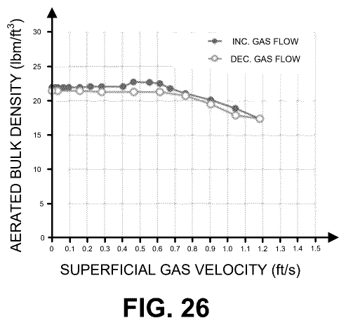

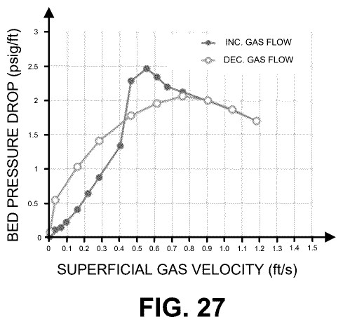

The measurement results for the sorbent at its as-received moisture contents is shown in FIG. 26, which presents a drawing illustrating an example of aerated bulk density as a function of superficial gas velocity of a sorbent in system 100 (FIG. 1) or 200 (FIG. 2). Moreover, FIG. 27 presents a drawing illustrating an example of gravity-flow packed-bed pressure drop per unit bed height as a function of superficial gas velocity of the sorbent in system 100 (FIG. 1) or 200 (FIG. 2).

As shown in FIGS. 26 and 27, the pressure drop starts to level off as the air flow is increased, indicating that the material was able to achieve a fluidized state. The bulk density also decreased with increasing superficial gas velocity. The minimum fluidization velocity is approximately 0.6 ft/s. At 400 standard cubic feet per hour (SCFH), the material appears to be fully fluidized.

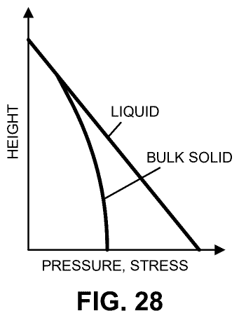

Thus, as shown in FIG. 28, which presents a drawing illustrating a theoretical example of mass-flow behavior of a sorbent in a gravity-flow packed bed, the granular sorbent material used in the system may exhibit mass flow behavior, which minimizes back mixing. Moreover, lateral and vertical forces may be consistent with the Janssen equations in which a large portion of the weight of the sorbent is supported by friction between the sorbent and the walls of a given gravity-flow packed bed, with only a small portion transferred to the bottom of the given gravity-flow packed bed. Lateral load may equalize within, e.g., 200 mm at this scale. Note that the pressure drop across the gravity-flow packed bed may depend on a size and shape of the sorbent material (and, thus, may be similar to static packed beds).

### Summary of Flow Properties

Highlights of the measurement results are discussed below for illustrations of the flow and/or particle characteristics of the sorbent. These results are illustrative of material properties of the sorbent and are not, per se, specific to a particular design of the system.

### Moisture-Sorption Measurements

Moisture-sorption measurements were conducted on small quantities (less than 50 mg) of the sorbent. The isotherm was performed in 10% relative-humidity increments at 40 C (104 F), following an initial drying step (e.g., equilibration at near 0% relative humidity).

A summary of the measurement results is provided in Table 2.

TABLE 2

| | | Adsorption/Desorption | Adsorption/Desorption |
|---|---|---|---|
| | Initial | Moisture at 60% | Moisture at 80% |
| | Moisture | Relative Humidity | Relative Humidity |
| Material | (Dry Basis) | (Dry Basis) | (Dry Basis) |
| Sorbent | 2.9% | 9.75/9.90 | 15.80/16.24 |

The sorbent reached a dry condition in about 2 hours. Above approximately 60% relative humidity, the amount of moisture picked up by the sorbent starts to increase rapidly with increasing relative humidity. The desorption curve of the sorbent closely followed the sorption-curve trend throughout these measurements.

### Particle-Size Analysis

A particle-size distribution was determined for the sorbent using a dry-sieving technique (Ro-Tap, with tapping, 5 minutes total time). The measurement results are provided in Table 3. Note that the weight percentage was retained on a given sieve.

TABLE 3

| | #10 | #12 | #16 | #18 | #20 | #30 | #40 | |
|---|---|---|---|---|---|---|---|---|
| Material | mesh | mesh | mesh | mesh | mesh | mesh | mesh | Pan |
| Sorbent | 3.98 | 13.50 | 43.77 | 13.81 | 12.63 | 12.17 | 0.10 | 0.04 |

### Density Measurements

The bulk density of most bulk solids varies with consolidating pressure. Table 4 provides the ranges of measured bulk densities and particle densities. Note that bulk density was measured using a liquid-displacement technique in water using a graduated cylinder.

TABLE 4

| | Bulk Density Range | Particle Density Range |
|---|---|---|
| Material | (lb/ft³) | (lb/ft³) |
| Sorbent | 20.4-22.1 | 94.1-96.8 |

### Permeability Measurement (Limiting Flow Rates)

An outlet must be sized not only to prevent arching, but also to achieve the required discharge rate. Fine powders or materials containing a significant amount of fine or small particles often exhibit a rate limitation not experienced with coarse materials that readily allow air to pass through them.

A permeability measurement was run to determine critical steady-state discharge rates. Bulk solids with low permeability often have low κ₀ values (in units of ft/s). Air permeability (κ) as defined by Darcy's Law at a temperature of 69 F is a function of the bulk weight density of the sorbent:

$$κ = {κ}_{0} \cdot \frac{{γ}^{- α}}{{γ}_{0}} .$$

For the sorbent with 20.7<bulk density (γ)<22.5 lb/ft³, κ₀=0.8214 ft/s, γ₀=21 lb/ft³, and α=4.86. Note that the permeability measurement results can be used to calculate the critical steady solids discharge rates for a mass flow bin with a given outlet size and an effective head (EH) of fully deaerated material.

### Attrition Measurements

Measurements were conducted on the plus #18 mesh (1 mm) sized material to evaluate the potential for the sorbent to attrit (breaking of particles) as a result of loading into, flow and compression in a silo. After these measurements, samples were collected from each test apparatus. These samples were analyzed for particle-size distribution via sieving.

While the attrition measurements mimicking forces to be experienced in the system, note that the measurements results are qualitative, and may not necessarily equate to the magnitude of attrition that will be experienced in the system. The extent of attrition that will occur is not only a function of the sorbent material and its tendency to attrit, but also the handling equipment (e.g., system design) and process (e.g., transfer rates). It is often possible to handle a highly attriting material in a gentle manner, such that breakage of the material is minimized. Moreover, note that the measurements simulate three of the attrition mechanisms for the system.
Impact attrition: Measurements were performed to assess the potential for particle attrition as a result of impact onto a wall surface or onto a bed of material after a drop of 126 in.
Shear attrition: A measurement was performed to assess the potential for particle attrition during flow through a rotary valve at 798 mm/min. Shear attrition can occur as individual particles are stressed to fracture at particle-to-particle contact points as a result of solids pressure and interparticle motion. In the shear attrition tester, the solids stress and the shear strain (interparticle motion) are simulated.
Uniaxial compaction: Measurements were performed to assess the potential for particle attrition as a result of compression because of the weight of material above within a silo, where interparticle particle motion is the result of compression (and not shear during flow). Four different sets of consolidation pressures were applied onto fresh material for these measurements.

Table 5 provides sieve analysis results of the attrition measurements on plus #18 mesh material. Based on the particle-size distributions, Table 5 is simplified to display the minus #18 mesh material that was generated following each attrition measurement.

TABLE 5

| | | | | | Total (% |
|---|---|---|---|---|---|
| | | | | | Attrite |
| Sorbent | | | | | Below |
| plus #18 | #20 mesh | #30 mesh | #40 mesh | | minus #18 |
| mesh | (850 μm) | (600 μm) | (425 μm) | Pan | mesh) |
| Drop 126 in | 1.28 | 0.17 | 0.02 | 0.01 | 1.48 |
| Onto Bed | | | | | |
| Drop 126 in | 2.03 | 0.27 | 0.04 | 0.03 | 2.37 |
| Onto Plate | | | | | |
| Uniaxial | 1.28 | 0.14 | 0.03 | 0.03 | 1.48 |
| 176 lb/ft² | | | | | |
| Uniaxial | 0.67 | 0.48 | 0.01 | 0.00 | 1.16 |
| 601 lb/ft² | | | | | |
| Uniaxial | 1.04 | 0.17 | 0.05 | 0.01 | 1.27 |
| 1482 lb/ft² | | | | | |
| Uniaxial | 1.76 | 0.57 | 0.20 | 0.15 | 2.68 |
| 2363 lb/ft² | | | | | |
| Rotary | 1.06 | 0.27 | 0.08 | 0.06 | 1.47 |
| Shear | | | | | |
| Attrition | | | | | |

As shown in Tables 6 and 7, additional attrition measurements were performed on plus #35 mesh (½ mm) sized sorbent particles while mimicking the forces experienced by the sorbent when cycling through the system. The measurement results show less than 1% attrition per cycle. Note that after measuring the particle-size distribution, the ½ mm fraction (pan) was removed at the start of each run and, therefore, there was a slight reduction in mass after each run.

TABLE 6

| Test Protocol | Attrition-Measurement Technique |
|---|---|
| 1. Drop out of bucket elevator | 6 ft. drop impact test onto 45° angled |
| to heat exchange hopper | plate |
| 2. Rotary valve with 3 ft. | Rotary shear: 15° at 60 lb/ft² and 60° at |
| effective head | 5 lb/ft² |
| 3. Peak pressure in desorber | Uniaxial compression at approximately |
| | 100 lb/ft² |
| 4. Shear in hopper | Rotary shear: 5° at 60 lb/ft², 5° at 20 |
| | lb/ft², 10° at 5 lb/ft², 30° at no applied |
| | weight |
| 5. Rotary valve with 3 ft. | Rotary shear: 15° at 60 lb/ft² and 60° at |
| effective head | 5 lb/ft² |
| 6. Drop out of bucket elevator | 6 ft. drop impact test onto 45° angled plate |
| to distributor chute | |
| 7. Drop out of chute to | 4 ft. drop impact test onto 45° angled plate |
| distributor | |
| 8. 2″ wide packet bed flow | Rotary shear: 3 lb/ft² at 2 mm/s for 50 |
| (shear) against 35 mesh (½ | min (or 5 m in 50 min) |
| mm) screen | |

Check attrition of sample using a sieve to determine the particle-size distribution (remove -½ mm) and repeat two more times

TABLE 7

| | #10 | #12 | #16 | #18 | #20 | #30 | #35 | |
|---|---|---|---|---|---|---|---|---|
| | mesh | mesh | mesh | mesh | mesh | mesh | mesh | |
| | (2 | (1.7 | (1.2 | (1000 | (850 | (600 | (500 | |
| Material | mm) | mm) | mm) | μm) | μm) | μm) | μm) | Pan |
| As | 4.22 | 14.66 | 44.59 | 13.34 | 11.76 | 11.01 | 0.27 | 0.14 |
| Received | | | | | | | | |
| Run 1 | 3.28 | 14.50 | 44.58 | 13.45 | 11.86 | 11.42 | 0.44 | 0.47 |
| Run 2 | 2.37 | 14.99 | 44.78 | 13.36 | 11.97 | 11.77 | 0.51 | 0.24 |
| Run 3 | 1.92 | 13.69 | 45.05 | 13.90 | 12.32 | 12.32 | 0.55 | 0.24 |

### Segregation Measurements

Segregation measurements were performed to evaluate the potential for the sorbent to segregate by the sifting and fluidization mechanisms. These measurements are ‘stress tests’ specifically designed to induce segregation. Note that the measurement results are qualitative, and do not necessarily equate to the magnitude of segregation that will be experienced in the system. The results generated cannot be held to any acceptance criteria for in-process material or final product. The extent of segregation that will occur is not only a function of the sorbent and its tendency to segregate, but also the handling equipment (e.g., hopper and transfer chute design) and process (e.g., transfer rates). It is possible to handle a highly segregating sorbent in a correct manner, such that component variations of the final product are minimized.

Note that the measurements simulate two of the common segregation mechanisms experienced by many blends. Other less common segregation mechanisms exist but are not considered here, as they do not typically occur under normal manufacturing settings.

### Sifting Segregation

Sifting segregation, which is a process by which smaller particles move through a matrix of larger ones, is the most common method for segregation. Four conditions must exist for sifting to occur:
A difference in particle size between the individual components. This ratio can be as low as 1.3:1. In general, the larger the ratio of particle sizes, the greater the tendency for particles to segregate by sifting.
A sufficiently large mean particle size. Sifting segregation can occur with a mean particle size in the 50 μm range and can become a dominant segregation mechanism if the mean particle size is above 100 μm.
Free-flowing material. This allows the smaller particles to sift through the matrix of larger particles. With cohesive materials, the fine particles are bound to one another and do not enter the voids among the coarse particles.
Interparticle motion. This can be caused during formation of a pile, by vibration, or by a velocity gradient across the flowing material.
   All four of these conditions must exist for sifting segregation to occur. If any one of these conditions does not exist, the mix will not segregate by this mechanism.

In materials having a range of particle sizes, sifting segregation may significantly impact product quality and handleability. As an illustration of the segregation mechanism, consider a pile formed by a falling stream of material. If sifting segregation takes place, the finer particles will tend to sift through the larger particles and concentrate under the point of impact. As the concentration of fine particles builds up in the center of the pile, the coarser particles will tend to roll or slide to the edges of this pile.

### Sifting-Segregation Measurements

The sifting-segregation measurement is performed by center filling a small funnel flow bin, which consists of a cylinder section above a conical hopper. The material is then discharged and split into sequential samples. If sifting segregation occurs either during filling or discharge, then the fine-particle content of the discharging material will vary from beginning to end.

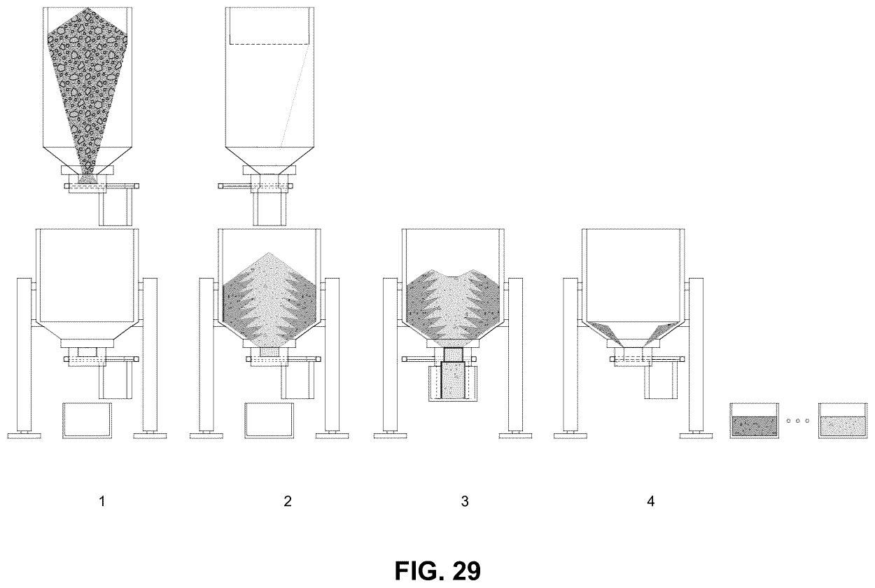

As shown in FIG. 29, which presents a drawing illustrating an example of sifting-segregation measurements, the sifting-segregation measurement sequence may include the operations of:
1) The blend is placed in mass flow bin.
2) The sorbent is discharged from a fixed height, dropping into a funnel flow bin. This transfer of sorbent will promote segregation if the sorbent is prone to segregate due to sifting.
3) The sorbent is discharged from funnel flow bin. The discharge pattern will cause sorbent from the center to discharge first, and sorbent from near the walls to discharge last.
4) Collected samples are measured for segregation.

### Sifting-Segregation Measurement Results

Particle-size distributions using sieving, were determined on the samples discharged at the beginning (sample D), center (sample E), and end (sample F) of the measurements. The reference sample (sample G) was not subjected to any segregation tests, but it was handled (riffled) in a similar manner as the segregated samples. The calculated d10, d50, and d90 sizes are provided in Table 8.

TABLE 8

| Sub-Sample | d₁₀ (μm) | d₅₀ (μm) | d₉₀ (μm) |
|---|---|---|---|
| Beginning (Sample D) | 674 | 1060 | 1680 |
| Center (Sample E) | 778 | 1240 | 1790 |
| End (Sample F) | 878 | 1470 | 1960 |
| Reference (Sample G) | 796 | 1300 | 1860 |
| Segregation Ratio | | 32% | |

One method for assessing the segregation potential is to calculate a ‘Segregation Ratio.’ When evaluating the size distribution, this can be defined as the absolute difference in the d50 measurement between the beginning (sample D, which is typically finer) and end (sample F, which is typically coarser) samples, normalized by the reference sample (sample G), as shown in Table 8. A higher value for this ‘Segregation Ratio’ is indicative of a higher sifting-segregation potential.

Note that materials may be classified into one of three categories (‘low,’ ‘moderate’ and ‘high’), based at least in part on assay differences between points in the testers. Those materials that have assay differences less than 5% between the ‘beginning’ and ‘end’ samples generally have ‘low’ segregation tendencies; those between 5 and 15% have ‘moderate’ segregation tendencies, while those with assay differences above 15% have “high” segregation tendencies, with regards to assay variations. For the particle-size measurements, differences less than 25% typically have a ‘low’ potential, 25% to 50% a ‘moderate’ potential, and above 50% a ‘high’ potential for segregation. These empirical classifications are for illustration and do not consider the handling process.

When evaluating the segregation-measurement results based on assay, the segregation ratio is defined as the compositional difference between the beginning and end samples, normalized by the reference sample. For the purpose of calculating the segregation ratio, the results for the samples are averaged.

It is not uncommon to observe a difference in the segregation tendencies of a blend when comparing conclusions formed based on particle size with those based on assay. To some degree, sampling error and data scatter may contribute to these differences. However, in some cases, the segregation of a blend based on particle size may not result in compositional changes, and vice versa.

Based on these measurements, the potential for the sorbent to segregate because of a sifting mechanism is high.

### Fluidization-Segregation Measurements

Fluidization can cause vertical segregation, e.g., horizontal layers of fine and coarse material. Fine powders generally have a lower permeability than coarse materials and therefore tend to retain air longer. Thus, when a hopper is being filled, the coarse particles are driven into the bed while the fine particles remain fluidized near the surface. This can also occur after tumble blending if the material is fluidized during blending. Air entrainment often develops in materials that contain a significant percentage of particles below 100 μm. Fluidization segregation is likely to occur when fine materials are pneumatically conveyed, filled or discharged at high rates, or if gas counterflow is present.

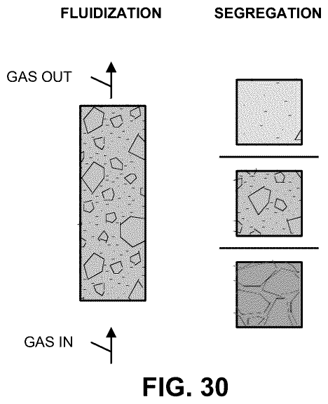

The fluidization-segregation measurement is performed by first fluidizing a column of sorbent by injecting air at the bottom. After the column is thoroughly fluidized, the air is turned off and the sorbent is allowed to deaerate. The column is then split into three equal sections (top, middle, and bottom), and each section is measured for segregation. This is shown in FIG. 30, which presents a drawing illustrating an example of a fluidization-segregation measurement.

### Fluidization-Segregation Measurement Results

Particle-size distributions, using sieving, were determined on the samples collected from the top (sample A), middle (sample B), and bottom (sample C) of the test column. The reference sample (sample G) was not subjected to any segregation tests, but it was handled (riffled) in a similar manner as the segregated samples. The calculated d10, d50, and d90 sizes are provided in Table 9.

TABLE 9

| Sub-Sample | d₁₀ (μm) | d₅₀ (μm) | d₉₀ (μm) |
|---|---|---|---|
| Top (Sample A) | 656 | 931 | 1460 |
| Middle (Sample B) | 949 | 1380 | 1870 |
| Bottom (Sample C) | 1090 | 1500 | 1950 |
| Reference (Sample G) | 796 | 1300 | 1860 |
| Segregation Ratio | | 44% | |

One method for assessing the segregation potential is to calculate a ‘Segregation Ratio.’ When evaluating the size distribution, this can be defined as the absolute difference in the d50 measurement between the bottom (sample C, which is typically coarser) and top (sample A, which is typically finer) samples, normalized by the reference sample (sample G), as shown in Table 9. As noted previously, a higher value for this ‘Segregation Ratio’ is indicative of a higher fluidization-segregation potential.

When evaluating the segregation-measurement results based on assay, the segregation ratio is defined as the compositional difference between the bottom and top samples, normalized by the reference sample. For the purpose of calculating the segregation ratio, the results for the samples are averaged.

As noted previously, it is not uncommon to observe a difference in the segregation tendencies of a blend when comparing conclusions based on particle size with those based on assay. To some degree, sampling error and data scatter may contribute to these differences. However, in some cases, the segregation of a blend based on particle size may not result in compositional changes, and vice versa.

Based on these results, the potential for the sorbent to segregate because of a fluidization mechanism is even higher than sifting.

### Compressibility

Bulk weight density (γ) at a temperature of 69 F is a function of the major consolidating pressure (σ₁):

$$γ = {γ}_{m} \cdot {( 1 + \frac{{σ}_{1}}{{σ}_{m}} )}^{{β}_{m}}$$

for 20.9<γ<22.1 lb/ft³, where γₘ=21 lb/ft³, σₘ=805.2 lb/ft³, βm=0.0383, and γ_{loose fill}=20.4 lb/ft³.

### Particle-Size Distribution

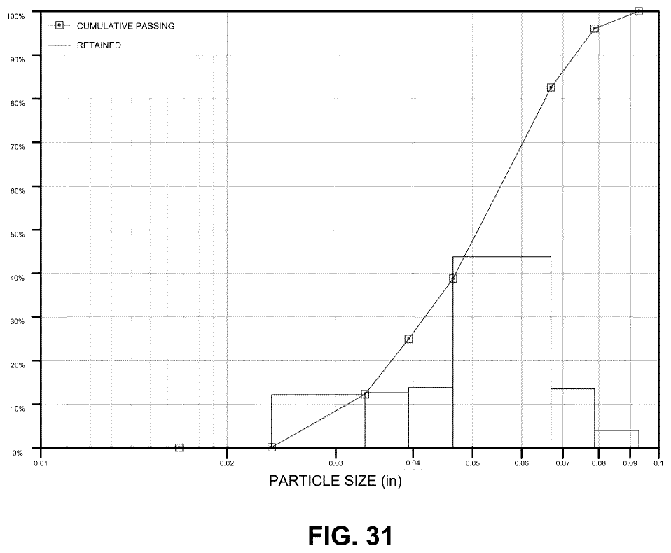

FIG. 31 presents a drawing illustrating an example of particle-size distribution, by mass, of the sorbent reference. Unless noted otherwise, the moisture content of the sorbent was 1.5%. Table 10 provides the retained particle size and percentage for the reference via the Ro-Tap, with tapper, and Table 11 provides the particle sizes.

TABLE 10

| | | |
|---|---|---|
| Sieve | Size | Retained (%) |

| | | | |
|---|---|---|---|
| ASTM #10 | 2 | mm | 3.98 |
| ASTM #12 | 1.7 | mm | 13.50 |
| ASTM #16 | 1.18 | mm | 43.77 |
| ASTM #18 | 1000 | μm | 13.81 |
| ASTM #20 | 850 | μm | 12.63 |
| ASTM #30 | 600 | μm | 12.17 |
| ASTM #40 | 425 | μm | 0.10 |
| Pan | 0 | μm | 0.04 |

| | |
|---|---|
| Total | 100.00 |
| Sieving Yield | 99.40 |
| Initial Total Mass | 30.379 g |

TABLE 11

| Particle | Size (in) |
|---|---|
| p₁₀ | 0.0313 |
| p₂₀ | 0.0369 |
| p₅₀ | 0.051 |
| p₈₀ | 0.0655 |
| p₉₀ | 0.0732 |

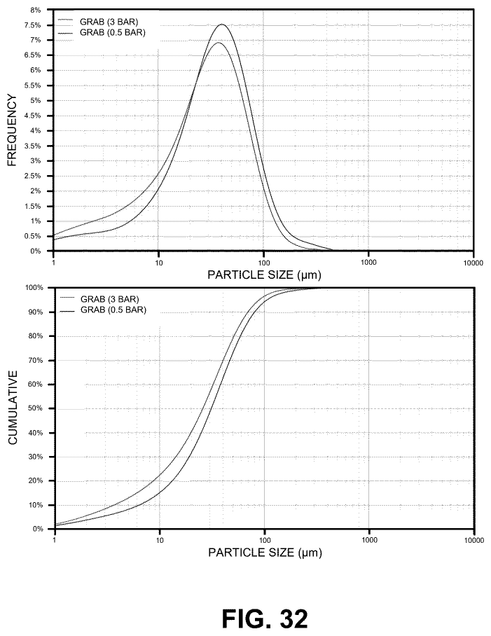

FIG. 32 presents a drawing illustrating an example of particle-size distribution, by volume, of silica gel, which may be similar to a substrate in the sorbent. Measurements were performed with a dispersant pressure of 0.5 bar (dry dispersion). The results in FIG. 32 are the average of three laser-diffraction measurements based on the Mie theory of light scattering to determine the particle-size distribution. Note that the volume-weighted mean is 40.6 μm, the surface-weighted mean is 11.1 μm, and the span is 2.39. Moreover, d₁₀ is 6.4 μm, d₅₀ is 31.2 μm, and d₉₀ is 81.1 μm.

### Sorption

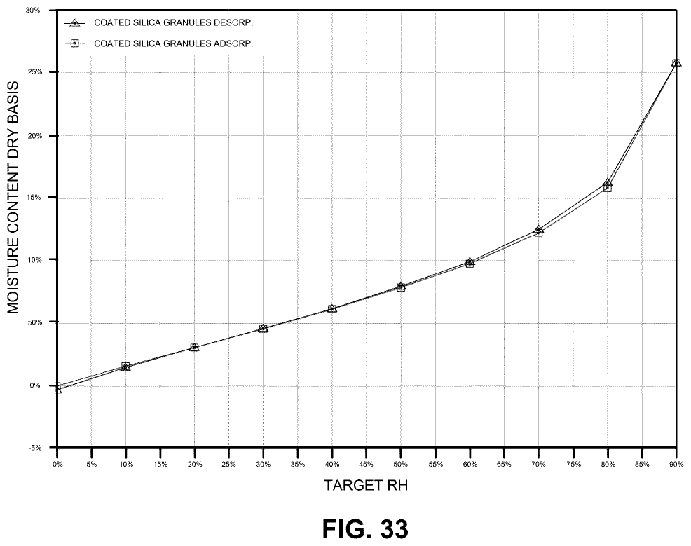

Measurements were performed on the sorbent at 40 C with a single cycle 0-90% relative humidity using 10% steps. The testing was performed with 51.9705 mg of reference material, dried to 50.5196 mg, resulting in a 2.8719% moisture content for the sample initially loaded into the tester. FIG. 33 presents a drawing illustrating an example of moisture content as a function of target relative humidity of the sorbent (which is sometimes referred to as an isotherm curve). Table 12 provides the measured adsorption, desorption and hysteresis as a function of the target relative humidity.

TABLE 12

| Target Relative | | | |
|---|---|---|---|
| Humidity (%) | Adsorption (%) | Desorption (%) | Hysteresis (%) |
| 0.0 | 0.0000 | 0.3183 | −0.3183 |
| 10.0 | 1.5893 | 1.4719 | −0.1174 |
| 20.0 | 3.0721 | 3.0620 | −0.0101 |
| 30.0 | 4.5635 | 4.5907 | 0.0271 |
| 40.0 | 6.1249 | 6.1528 | 0.0279 |
| 50.0 | 7.8535 | 7.9454 | 0.0918 |
| 60.0 | 9.7494 | 9.9012 | 0.1518 |
| 70.0 | 12.2191 | 12.5000 | 0.2809 |
| 80.0 | 15.8015 | 16.2401 | 0.4386 |
| 90.0 | 25.7415 | 25.7415 | 0.0000 |

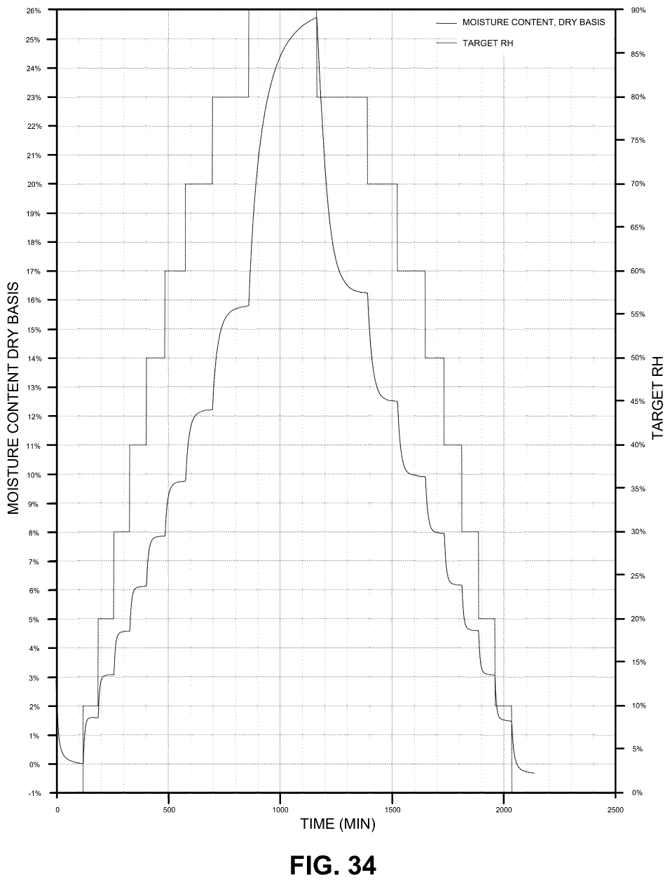

The kinetics of adsorption at 104 F are shown in FIG. 34, which presents a drawing illustrating an example of moisture content as a function of time for the sorbent.

### Dustiness

A dustiness measurement was performed by blowing air through a column of material at 69 F, and measuring the mass of material removed from the column. This provides a relative measure of dustiness that can be correlated with field experience.

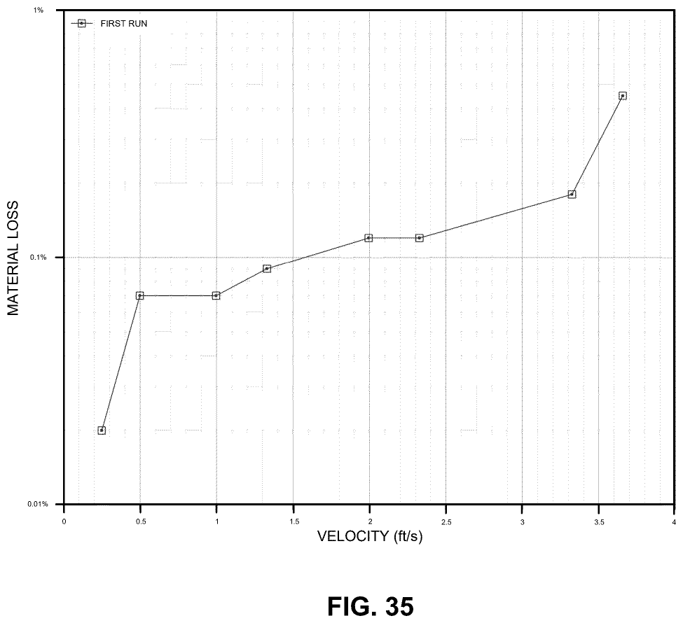

The first measurement run results are shown in FIG. 35, which presents a drawing illustrating an example of material loss as a function of velocity. Table 13 provides dustiness measurements with a maximum particle size of 0.0929 in.

TABLE 13

| Air Velocity (ft/s) | Time Elapsed (s) | Remaining (%) | Lost (%) |
|---|---|---|---|
| 0.00 | 2 | 100.00 | 0.00 |
| 0.249 | 61 | 99.98 | 0.02 |
| 0.499 | 61 | 99.93 | 0.07 |
| 0.998 | 70 | 99.93 | 0.07 |
| 1.33 | 60 | 99.91 | 0.09 |
| 2.00 | 60 | 99.88 | 0.12 |
| 2.33 | 64 | 99.88 | 0.12 |
| 3.33 | 61 | 99.82 | 0.18 |
| 3.66 | 63 | 99.55 | 0.45 |

### Chemical Cycling

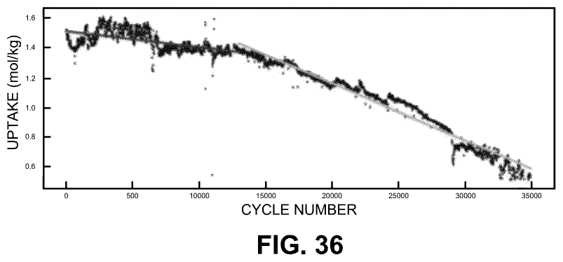

In order to confirm that the sorbent can transit multiple times through the system (and, thus, can experience multiple adsorb/desorb cycles), the impact of chemical cycling on the sorbent was tested. Notably, the sorbent was tested in up to 3,516 adsorb/desorb cycles. This is shown in FIG. 36, which presents a drawing illustrating an example of sorbent lifetime. Based on these measurements, a sample starting with 1.25 mol/kg uptake will have 0.65 mol/kg of uptake after 2,500 cycles.

The sorbent lifetime may be improved by: reducing attrition (and, thus, increasing the number of cycles the sorbent can be used in the system); and reducing amine loss (e.g., because of oxidation or vapor loss). For example, attrition may be improved: using cross-linking (such as covalently linking amine and hydroxyl groups); improving mechanical strength (which may include the use of an iron chelating agent); increasing the carrier or substrate particle strength of the sorbent; and/or using a continuous sorbent manufacturing process with less mechanical stress. Moreover, amine loss may be improved by using amine polymers and/or an anti-oxidant in the sorbent.

By using a low-cost sorbent that can be cycles multiple times through the system, the system and the sorbent may be designed to change the economics of DAC. As summarized in Table 14, as the system is scaled from 500 ton to 1 M ton of captured CO₂, the cost of captured CO₂ is expected to be dramatically reduced. This capability is forecast to make the disclosed DAC system a major component in the suite of technologies that will address global warming.

TABLE 14

| Size | 500 Ton | 5,000 Ton | 1M Ton |
|---|---|---|---|
| Cost/kg | $20-30/kg | $10-20/kg | $10/kg |
| Mol CO₂/kg | 0.5-1.1 | 1.0-1.5 | 1.2-2.0 |
| Adsorb/Desorb Cycles | 2,000-3,000 | 3,000-4,000 | 4,000-6,000 |

In Table 14, note that the environmental conditions are at standard atmosphere at sea level. Moreover, note that the sorbent lifetime is dependent on the rate of cycles in the system and the amount of sorbent in the system.

We now further discuss sorbent recycling and/or disposal. Silica particles are often agglomerated into various sizes. Moreover, recycling and attrition characteristics of the sorbent may be linked via density and particle size. In general, there will be a finite number of times the same silica particles in the sorbent can be recycled.

The goals of recycling include matching the density and particle-size distribution of original or initial sorbent material while maintaining CO₂ uptake. In some embodiments, the sorbent may be recycled and recoated on-site with the system (e.g., using an agglomerator/double-cone reactor). In some embodiments, the system nay recoat the sorbent in-line as the sorbent transmits through the system (and, thus, without first removing the sorbent from the system). For example, the sorbent may be recoated with active material (such as an amine containing polymers or molecules) every 100-1,000 cycles of operation. This may rejuvenate the sorbent. Moreover, prior to or during the recoating, the sorbent may be agglomerated (e.g., using polymers), so that the size of the sorbent particles is restored to specification. Notably, smaller sorbent particles (such as those having diameters less than 500 μm) may be agglomerated into sorbent particles having diameters between 0.5-2 mm. Alternatively, the base material may be reduced to dust and then re-agglomerizated to the proper or specified particle-size distribution. This may extend the usable operational life or lifetime of the sorbent.

Alternatively or additionally, the sorbent may be disposed of. Disposal goals may include finding a second life for at least a portion or component of the sorbent. For example, spent sorbent may be reused in building materials, feedstock, tires, resin fillers, etc.

In some embodiments, ‘old’ or used sorbent may be used as a filter for amines (e.g., in the output water from the system).

We now further discuss uses of the output(s), such as water and/or the captured CO₂. The captured CO₂ output or provided by the system may be 99.6% pure at atmospheric pressure and temperature (the impurity may be air). In the short term, the captured CO₂ may be sequestered. For example, the captured CO₂ may be mineralized in concrete, e.g., using the CarbonCure technique (from CarbonCure Technologies, Inc. of Halifax, Canada). Notably, CO₂ may be injected into concrete during mixing to form calcium carbonate (CaCO₃). This approach may reduce cement content by 4-6% with the same compressive strength. In some embodiments, the captured CO₂ may be used in ready-mix or precast concrete.

Moreover, the captured CO₂ may be sequestered, e.g., using saline aquifer storage in an existing Class VI well. For example, Archer Daniels Midland (or ADM of Chicago, Illinois) provides saline aquifer storage. ADM has been operating Class VI wells for more than 10 years and they have confirmed capacity for the captured CO₂ volumes that will be produced by the system. The captured CO₂ may be transported to Illinois by rail (with lower costs and emissions compared to trucking).

In the medium term, the captured CO₂ may be sequestered using saline aquifer storage, e.g., in Wyoming. In this regard, a Class VI application was approved in December 2023. Injection is set to begin in 2025. Another option is mineralization, e.g., in Hermiston, Oregon. In this regard, Class VI site characterization is in progress.

In the long term, the captured CO₂ may be mineralized and/or put to a beneficial use in conjunction with third party locations off-site and/or on-site with the system. For example, the system may be co-located with a synthetic fuel production facility. The capture CO₂ may be used as feedstock, and their waste heat may offset the energy costs of the system.

Note that prior to such uses of the captured CO₂, the captured CO₂ may be stored on-site with the system using refrigerated CO₂ storage.

The output water may be used to provide irrigation, to make-up water used by co-located industrial facilities, and/or to provide purified water for potable applications.

We now further discuss the use of input thermal energy, such as waste heat. FIG. 37 presents a block diagram illustrating an example of system 100 (FIG. 1) or 200 (FIG. 2) using input thermal energy. Notably, input energy and the DAC system produces captured CO₂ and/or water. The input energy may include electricity (which may be from renewable sources, such as solar power) and/or thermal energy. In some embodiments, the input thermal energy may include waster heat from an industrial process and/or a data center.

This capability has numerous potential positive impacts on sustainability projects, including: contributing to a water replenishment strategy; providing climate neutral cooling; and/or providing a heat reuse strategy. Note that the ability to provide cooling even in severe climate conditions (e.g., at temperatures where cooling towers cannot operate effectively), the system may facilitate achieving CO₂ reduction targets.

FIG. 38 presents a block diagram illustrating an example of system 100 (FIG. 1) or 200 (FIG. 2) using input thermal energy associated with a data center. Note that process fluids are not exchanged in FIG. 38. Instead, there is only thermal exchange with clear hydraulic separation. For example, the heat transfer may use a hydraulic separator or hot air. The system may provide 2-10 MW_{TH}. Also, the system may generate water. In addition, the system can operate at environmental temperatures above 25 C, which is above the temperature where cooling towers may have significantly reduced capabilities or may no longer work.

We now describe embodiments of a user interface in a control subsystem. FIGS. 39-42 present drawings illustrating examples of user interfaces in a control subsystem for system 100 (FIG. 1) or 200 (FIG. 2).

We now describe embodiments of operating parameters for the system in different configurations and/or with different environmental conditions. FIG. 43 presents a drawing illustrating an example of the use of system 100 (FIG. 1) or 200 (FIG. 2) without input thermal energy. This may occur when the system starts up or when a thermal source is unavailable. Because there is no input thermal energy, the water heaters in the system may be run using input electricity.

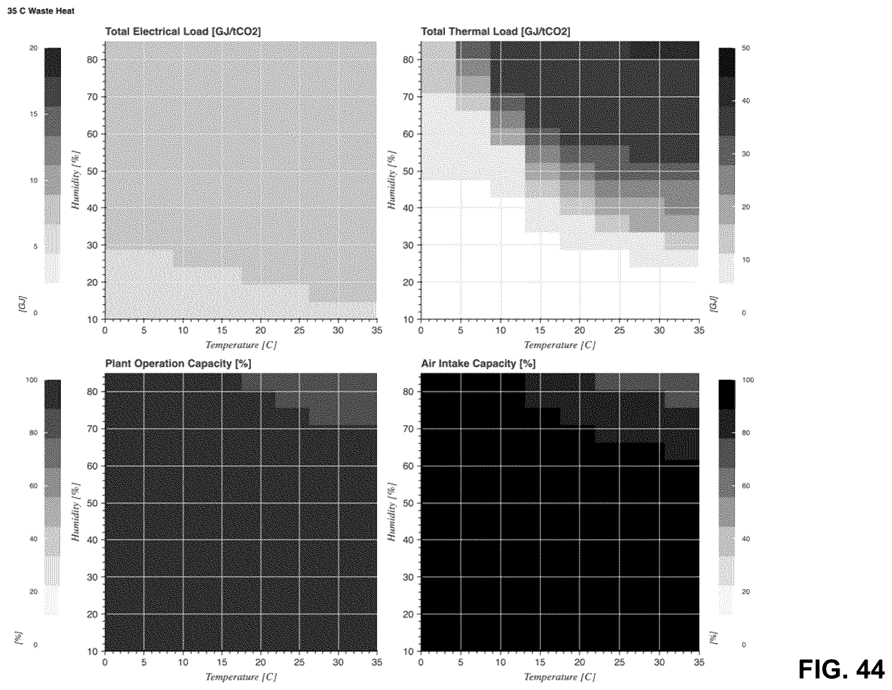

FIG. 44 presents a drawing illustrating an example of the use of system 100 (FIG. 1) or 200 (FIG. 2) with input thermal energy (such as data-center waste heat). Thus, FIG. 44 illustrates operating parameters for the system when it integrates waste heat utilization from a data center. The electricity load used by the system for a 25,000 tons per year (tpa) use case may be approximately 8 GJ/tCO₂. However, under these conditions, the system may support a 25 GJ/tCO₂ cooling load, e.g., for a data center. This capability may allow the system to operate at 100% capacity irrespective of the weather conditions.

In some embodiments, the system may use 5-11 GJ/tCO₂. For example, energy may be used to: heat air to remove water; heat the sorbent to desorb CO₂ and/or water; move the sorbent in the system; and move the air in the system (which is how the pressure drop in the adsorber is tied to the operating cost of the system). With input thermal energy (such as high-quality heat or high-quality low-grade heat), the energy consumption may be 5 GJ/tCO₂, with the balance of the energy provided by the high-quality heat. Alternatively, with no input thermal energy, the energy consumption may be 11 GJ/tCO₂. Note that low-grade heat may have a temperature less than 100 C (i.e., without steam), and high-quality low-grade heat may have a temperature between 65-100 C.

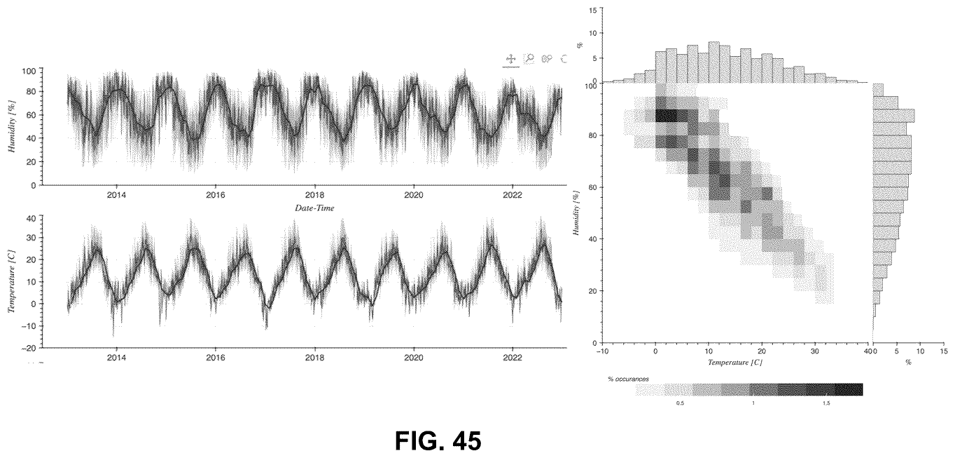

As discussed previously, weather analysis and/or weather forecasts may be used to select or generate operating parameters for the system. FIG. 45 presents a drawing illustrating an example of weather analysis at a location.

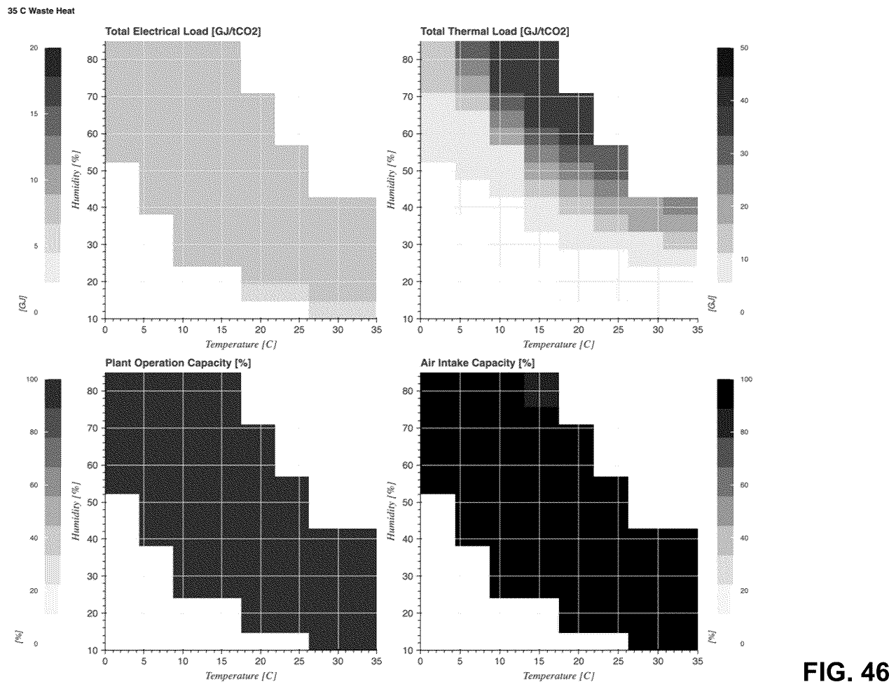

FIG. 46 presents a drawing illustrating an example of operating parameters for system 100 (FIG. 1) or 200 (FIG. 2) with input thermal energy (such as data-center waste heat) at a particular location.

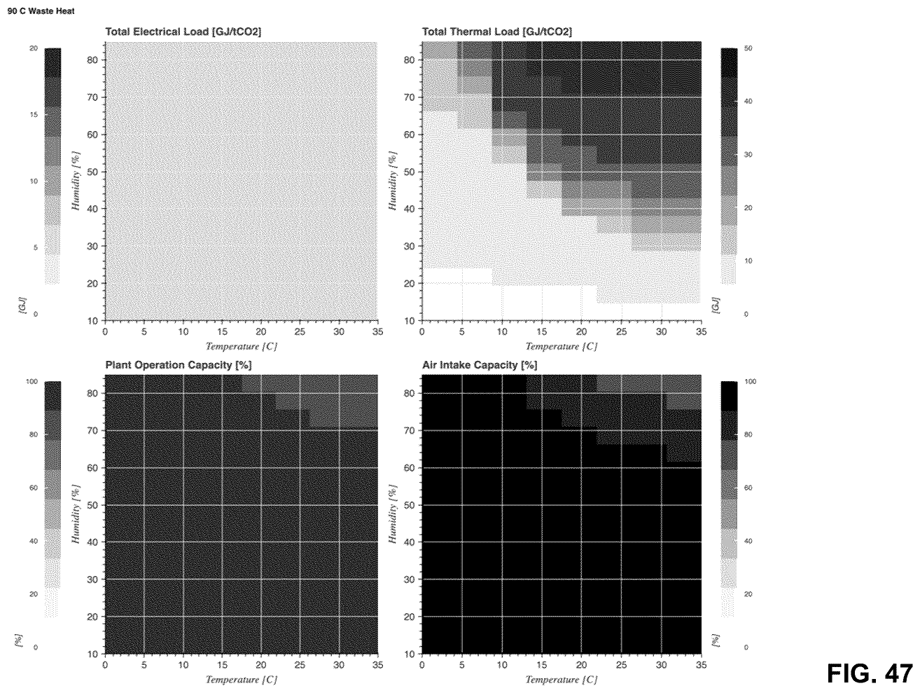

The impact of high-quality waste heat as an input to the system is shown in FIG. 47, which presents a drawing illustrating an example of operating parameters for system 100 (FIG. 1) or 200 (FIG. 2) with input thermal energy. Notably, in FIG. 47, the system integrates waste heat having a temperature of 90 C. The electricity load for the system at 1 M+ tpa may be approximately 5 GJ/tCO₂. In these embodiments, the system may support or provide a 25 GJ/tCO₂ cooling load.

The system may be agnostic to the type of sorbent or the particle-size distribution of the sorbent. Thus, the system may accommodate a wide variety of types of sorbent with minor adjustments (such as the filter opening sizes, conveyance rates, etc.). In some embodiments, different types of sorbent may be used in the system based at least in part on the environmental conditions. For example, a sorbent with lower adsorption of water may be used in environments that routinely (such as more than 50% of the time) have high relative humidity (such as greater than 80 or 90%).

Note that the system may operate at 100% capacity independent of the weather conditions. In general, the CO₂ adsorption by the system may be weakly dependent (such as +5%) on changes in the external temperature. The system may have a stronger dependency on changes in the relative humidity. For example, higher relative humidity may increase the adsorption of CO₂, and lower relative humidity may (relatively) decrease the adsorption of CO₂. Moreover, at higher relative humidity there may be more water adsorbed by the sorbent than a lower relative humidity. In order to level out or reduce this dependence, the system may use more heating of the air (e.g., in a thermal dump) before adsorption in order to condition the air. This additional heating may impact the energy budget (and, thus, the energy/tCO₂) of the system under these environmental conditions.

The preceding embodiments may include fewer or additional features or components. Moreover, two or more features or components may be combined into a single feature or component, a single feature or component may be divided into two or more features or components, and/or a position of a feature or a component may be changed.

In some embodiments, the thermal dump may be obtained from Kelvion GmbH (of Bochum Germany), Alfa Laval, Inc. (of Lund, Sweden), SPX Corp. (of Charlotte, North Carolina), or GEA Refrigeration Technologies (of Berlin, Germany). Moreover, the heat exchanger(s) may be obtained from Alfal Laval, Inc., Coperion GmbH (of Stuttgart, Germany), or Danfoss LLC (of Baltimore, Maryland). The adsorber may use a custom design. Furthermore, the rotary valves in the adsorber may be obtained from Carolina Conveying, Inc. (of Canton, North Carolina), ACS Valves (of Caledonia, Canada), Schenck USA Corp. (of Deerpark, New York), or Rotolok USA, Inc. (of Monroe, North Carolina). The conveyor may be obtained from Ryson International, Inc. (of Yorktown, Virginia), Flexicon Corp. (of Bethlehem, Pennsylvania) or HAF Equipment Corp. (of Minneapolis, Minnesota). Additionally, the desorber may be obtained from Solex Corp. (of Dixon, California), FIC S.p.A. (of Mese, Italy) or Carrier Vibrating Equipment, Inc. (of Louisville, Kentucky). The airlocks in the desorber may be obtained from Roto-Disc, Inc. (of Erlanger, Kentucky), Wm. W. Meyer & Sons, Inc. (of Libertyville, Illinois), Rotolok, or Schenck USA Corp. Note that the heat pump(s) may be obtained from Mitsubishi Electric US, Inc. (of Cypress, California), Carrier Global Corp. (of Palm Beach Gardens, Florida), or Johnson Controls Corp. (of Milwaukee, Wisconsin).

In first embodiments, the sorbent may include a functionalized material. Thus functionalized material may include: multiple porous particles; and a surface modification layer disposed on at least a portion of a surface of at least one porous particle in the multiple porous particles. Each porous particle in the multiple porous particles may have a porosity of 50 nm to 150 nm and a diameter of 0.5 mm to 4 mm. The surface modification layer may include: an amine moiety and a silane moiety, where the amine moiety includes polyethylenimine. Moreover, during use in the system, the functionalized material may adsorb atmospheric CO₂ under a first condition (such as a first range of temperatures) and reversibly desorb adsorbed CO₂ under a second condition (such as a second range of temperatures and/or pressure less than atmospheric pressure at sea level).

In second embodiments, a functionalized material may include: multiple porous particles; and a surface modification layer disposed on at least a portion of a surface of at least one porous particle in the multiple porous particles. Each porous particle in the multiple porous particles may have a porosity of 90 Å to 200 Å and a diameter of 0.5 mm to 4 mm. The surface modification layer may include an amine moiety and a silane moiety, where the amine moiety includes polyethylenimine and, during operation, the functionalized material adsorbs atmospheric CO₂ under a first condition (such as a first range of temperatures) and reversibly desorb adsorbed CO₂ under a second condition (such as a second range of temperatures and/or pressure less than atmospheric pressure at sea level).

In the functionalized material in the first or the second embodiments, each porous particle in the multiple porous particles may include silicon dioxide or silicon oxide.

The first or the second embodiments may be used to remove atmospheric CO₂ from air by direct air capture. Moreover, in the first or the second embodiments, the at least one porous particle may include: an antioxidant; a crosslinker; and/or a chelating agent. The cross-linker and/or chelator may increase strength and adherence of the sorbent/silica formulation.

Note that the first or the second embodiments may include: a pore size between 1 nm and 200 nm, with an average pore size between 30-80 nm; a pore volume greater than 0.5 ml/g; and. In some embodiments, the pore size may be between 0.5 ml/g to 5 ml/g. Note that the Brunauer-Emmett-Teller (BET) surface area may be larger than 100 m²/g.

A method of forming a functionalized material may include: attaching a first reagent and a second reagent to a surface of each porous particle in multiple porous particles, thereby obtaining a functionalized material. The first reagent may include an amine moiety that includes polyethylenimine, and the second reagent may include a silane moiety. Moreover, each porous particle in the multiple porous particles may have a porosity of from 90 Å to 200 Å, and each porous particle in the multiple porous particles may have a diameter of 0.5 mm to 4 mm. The functionalized material may be used to remove atmospheric CO₂ from air by direct air capture.

Each porous particle in the multiple porous particles may include silicon dioxide or silicon oxide. Moreover, the at least one porous particle may include: an antioxidant; a crosslinker; and/or a chelating agent.

In some embodiments, desorption of adsorbed CO₂ from the sorbent may, at least in part, be facilitated using electromagnetic waves in a band of frequencies. For example, carrier frequencies of the electromagnetic waves may be in a microwave band of frequencies, such as: a band of frequencies between 300 MHz and 300 GHz; between 500 MHz and 10 GHz; at 2.45 GHz; and/or at 980 MHz±50 MHz. Notably, this microwave desorption may use electromagnetic waves to heat at least a portion of the sorbent (such as a coating on the sorbent particles) to desorb the adsorbed CO₂ and/or water. Thus, microwave-based desorption may be used in a reduced-pressure environment to regenerate amine-based sorbents by heating the sorbent to temperatures necessary for the sorbent to discharge entrained CO₂ and/or water. The microwave desorption may be more energy efficient than heating the whole sorbent (including the substrate). Moreover, the microwave desorption may allow higher local temperatures, faster cycle times, a reduced heat of desorption, and/or a reduced activation temperature.

In some embodiments, microwave desorption may operate in a continuous-wave mode. Alternatively, in some embodiments, microwave desorption may operate in pulsed mode or a gated mode, such as turning the microwaves on every, e.g., 0.25-10 min, for a duration, e.g., of up to 2 min. in each cycle. Alternatively, microwave desorption may occur in less than 20 min. using a continuous-wave mode. The temperature increase of the sorbent when exposed to microwaves (continuous wave, pulsed or gated) may be between 60 and 85 C. Temperature control and temperature uniformity may need during microwave desorption to prevent sorbent degradation and/or thermal runaway. Moreover, 10-20% of the mass of the sorbent (including CO₂ and water) may be removed in each cycle. Furthermore, up to 0.3 mol/kg CO₂ uptake may be achieved during the microwave drying, and the water content may be reduced from 9.7% wt. to 1.2% wt. during the microwave drying. Additionally, the microwave power may be less than 2,000 W.

Note that in some embodiments, microwave desorption may be used in desorber 116 (FIG. 1 or 2). Alternatively or additionally, microwave desorption may be used separately from desorber 116 (FIG. 1 or 2). For example, microwave desorption may be used in an enclosed vessel or component in the system, with free-flowing sorbent. This component may have a vertical or a horizontal orientation with a vacuum or a pressure less than atmospheric pressure at sea level. In some embodiments, the microwave desorption may be implemented in an inner or internal stage in desorber 116 (FIG. 1 or 2). Note that the sorbent may be transported into the component using a moving conveyor belt.

Moreover, in some embodiments, graphite or carbon nanotubes may be included in the substrate (such as silica) to act or function as an antenna for the microwaves. Thus, graphite or carbon nanotubes may facilitate absorption of the microwaves in the sorbent. For example, the graphite or carbon nanotubes may have aspect ratios of 50 to 10,000, such as 2 mm by 100 nm. More generally, the graphite or carbon nanotubes may be long, flat sheets within particles having diameters between 20 μm and 2 mm.

Alternatively or additionally, in some embodiments, the sorbent: may include inert particles; may have different porosity than the first or the second embodiments described previously; and/or may include metal and/or magnetic particles (such as iron particles). Note that one or more of such additives to the sorbent may be attached or coupled to the substrate using polymer binders, thereby spatially positioning the one or more additives in the sorbent particles.

In general, one or more of the aforementioned additives in the sorbent may improve: the thermal conductivity of the sorbent; the microwave absorption of the sorbent; and/or may facilitate inductive heating of the sorbent. These physical properties of the sorbent may facilitate desorption of CO₂ and/or water at lower temperatures and/or in a more energy-efficient manner. For example, using microwave desorption, the disclosed system may desorb CO₂ and/or water at room temperature or near to room temperature.

Moreover, in some embodiments, the microwave carrier frequency may be tuned (one-time, as-need or dynamically) to increase desorption of CO₂ at a given temperature of desorber 116 (FIG. 1 or 2). Thus, microwave desorption may be used in one or more of the preceding embodiments of the system to reduce the time and/or the energy needed to desorb CO₂ and/or water from the sorbent.

While the preceding discussion disclosed the use of microwave or inductive desorption, in other embodiments radiative desorption or heating may be used in desorber 116 (FIG. 1 or 2) or in a separate component from desorber 116 (FIG. 1 or 2). For example, a laser outputting power in an infrared band of frequencies (such as carrier frequencies between 300 GHz to 400 THz or wavelengths between 780 nm and 1 mm) may be used for radiative desorption or heating of the sorbent.

In some embodiments, water may be added into desorber 116 (FIG. 1 or 2), where desorber 116 (FIG. 1 or 2) has a controlled operating temperature and a pressure less than ambient. The added water may improve the regeneration process and range of CO₂ and water release from an amine-based sorbent, thereby maximizing the rate of CO₂ and water capture.

Moreover, a pressure equalizer may be used to balance the ambient and vacuum-controlled sides of a pressure-lock system attached to desorber 116 (FIG. 1 or 2) for the purpose of capturing CO₂ directly from the atmosphere.

Furthermore, adsorber 112 (FIG. 1 or 2) may use or may include preconditioning with heat or water, cycling air draw, friction-reducing coatings, non-vertical (slanted) alignment, and/or kitted manufacturing approaches.

While the preceding discussion illustrated the sorbent with a silica-based substrate, in other embodiments the substrate may be based at least in part on a polymer. The polymer substrate may convey the amines to capture CO₂ directly from the atmosphere or ambient air.

In some embodiments, the sorbent may include a functionalized material. This functionalized material may include: a plurality of porous particles; and a surface modification layer disposed on at least a portion of a surface of at least one porous particle in the plurality of porous particles. The plurality of porous particles may have: a distribution of porosities from 100 nm to 200 nm; and a distribution of diameters of greater than 0.8 mm and less than 3 mm. For example, the pore size may be 3-40 nm, 5-30 nm or up to 100 nm with an open, interconnected pore structure. Moreover, the average particle diameter may be in the range of 100-800 μm. Alternatively or additionally, a unit diameter of a bead-shaped adsorbent may be, e.g., 3 mm. Furthermore, the surface modification layer may include an amine moiety and a silane moiety, where the amine moiety includes polyethylenimine. Additionally, the functionalized material may adsorb atmospheric CO₂ under a first condition and reversibly desorb adsorbed CO₂ under a second condition. Note that each porous particle in the plurality of porous particles may include silicon dioxide or silicon oxide.

In some embodiments, the functionalized material may remove atmospheric CO₂ from air by DAC.

Moreover, the at least one porous particle may include: an antioxidant; a crosslinker; a chelating agent; and/or a reinforcement polymer coating.

Furthermore, in method for forming a functionalized material, a first reagent and a second reagent may be attached to a surface of at least one porous particle in a plurality of porous particles, thereby obtaining a functionalized material. The first reagent may be an amine moiety that includes polyethylenimine, and the second reagent may be a silane moiety. Note that the plurality of porous particles may include: a distribution of porosities from 100 nm to 200 nm; and a distribution of diameters of greater than 0.8 mm and less than 3 mm. For example, the pore size may be 3-40 nm, 5-30 nm or up to 100 nm with an open, interconnected pore structure. Moreover, the average particle diameter may be in the range of 100-800 μm. Alternatively or additionally, a unit diameter of a bead-shaped adsorbent may be, e.g., 3 mm. The functionalized material may be used to remove atmospheric CO₂ from air by DAC.

Additionally, the at least one porous particle may include: an antioxidant; a crosslinker; a chelating agent; and/or a reinforcement polymer coating.

Note that the plurality of porous particles may include silicon dioxide or silicon oxide.

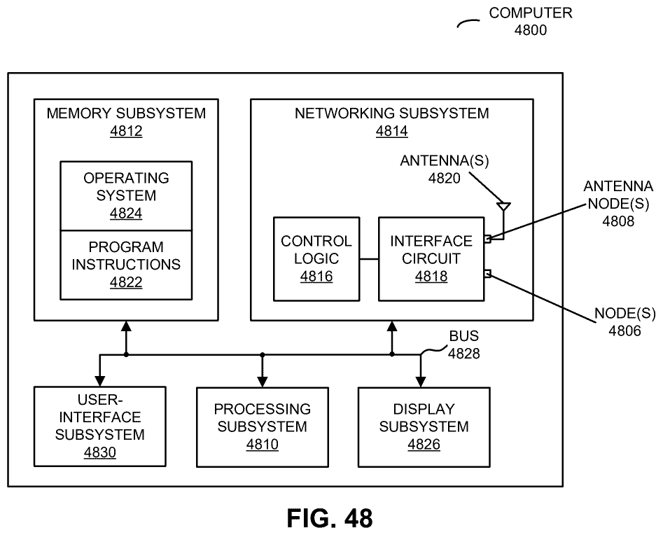

We now describe embodiments of an electronic device (such as a computer or computer system), which may perform at least some of the operations in the DAC techniques. FIG. 48 presents a block diagram illustrating an example of a computer 4800 in or associated with system 100 (FIG. 1) or 200 (FIG. 2), e.g., in a computer system (such as computer system 900 in FIG. 9). For example, computer 4800 may include: one of computers 910 (FIG. 9). This electronic device may include processing subsystem 4810, memory subsystem 4812, and networking subsystem 4814. Processing subsystem 4810 includes one or more devices configured to perform computational operations. For example, processing subsystem 4810 can include one or more microprocessors, ASICs, microcontrollers, programmable-logic devices, GPUs and/or one or more DSPs. Note that a given component in processing subsystem 4810 is sometimes referred to as a ‘computation device’.

Memory subsystem 4812 includes one or more devices for storing data and/or instructions for processing subsystem 4810 and networking subsystem 4814. For example, memory subsystem 4812 can include dynamic random access memory (DRAM), static random access memory (SRAM), and/or other types of memory. In some embodiments, instructions for processing subsystem 4810 in memory subsystem 4812 include: program instructions or sets of instructions (such as program instructions 4822 or operating system 4824), which may be executed by processing subsystem 4810. Note that the one or more computer programs or program instructions may constitute a computer-program mechanism. Moreover, instructions in the various program instructions in memory subsystem 4812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 4810.

In addition, memory subsystem 4812 can include mechanisms for controlling access to the memory. In some embodiments, memory subsystem 4812 includes a memory hierarchy that includes one or more caches coupled to a memory in computer 4800. In some of these embodiments, one or more of the caches may be located in processing subsystem 4810.

In some embodiments, memory subsystem 4812 is coupled to one or more high-capacity mass-storage devices (not shown). For example, memory subsystem 4812 can be coupled to a magnetic or optical drive, a solid-state drive, or another type of mass-storage device. In these embodiments, memory subsystem 4812 can be used by computer 4800 as fast-access storage for often-used data, while the mass-storage device is used to store less frequently used data.

Networking subsystem 4814 includes one or more devices configured to couple to and communicate on a wired and/or wireless network (i.e., to perform network operations), including: control logic 4816, an interface circuit 4818 and one or more antennas 4820 (or antenna elements). (While FIG. 48 includes one or more antennas 4820, in some embodiments computer 4800 includes one or more nodes, such as antenna nodes 4808, e.g., a metal pad or a connector, which can be coupled to the one or more antennas 4820, or nodes 4806, which can be coupled to a wired or optical connection or link. Thus, computer 4800 may or may not include the one or more antennas 4820. Note that the one or more nodes 4806 and/or antenna nodes 4808 may constitute input(s) to and/or output(s) from computer 4800.) For example, networking subsystem 4814 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 4814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, computer 4800 may use the mechanisms in networking subsystem 4814 for performing simple wireless communication between electronic devices, e.g., transmitting advertising or beacon frames and/or scanning for advertising frames transmitted by other electronic devices.

Within computer 4800, processing subsystem 4810, memory subsystem 4812, and networking subsystem 4814 are coupled together using bus 4828. Bus 4828 may include an electrical, optical, and/or electro-optical connection that the subsystems can use to communicate commands and data among one another. Although only one bus 4828 is shown for clarity, different embodiments can include a different number or configuration of electrical, optical, and/or electro-optical connections among the subsystems.

In some embodiments, computer 4800 includes a display subsystem 4826 for displaying information on a display, which may include a display driver and the display, such as a liquid-crystal display, a multi-touch touchscreen, etc. Moreover, computer 4800 may include a user-interface subsystem 4830, such as: a mouse, a keyboard, a trackpad, a stylus, a voice-recognition interface, and/or another human-machine interface.

Computer 4800 can be (or can be included in) any electronic device with at least one network interface. For example, computer 4800 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 4800, in alternative embodiments, different components and/or subsystems may be present in computer 4800. For example, computer 4800 may include one or more additional processing subsystems, memory subsystems, networking subsystems, and/or display subsystems. Additionally, one or more of the subsystems may not be present in computer 4800. Moreover, in some embodiments, computer 4800 may include one or more additional subsystems that are not shown in FIG. 48. Also, although separate subsystems are shown in FIG. 48, in some embodiments some or all of a given subsystem or component can be integrated into one or more of the other subsystems or component(s) in computer 4800. For example, in some embodiments program instructions 4822 are included in operating system 4824 and/or control logic 4816 is included in interface circuit 4818.

Moreover, the circuits and components in computer 4800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 4814 and/or computer 4800. The integrated circuit may include hardware and/or software mechanisms that are used for transmitting signals from computer 4800 and receiving signals at computer 4800 from other electronic devices. Aside from the mechanisms herein described, radios are generally known in the art and hence are not described in detail. In general, networking subsystem 4814 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware and/or in software. For example, at least some of the operations in the DAC techniques may be implemented using program instructions 4822, operating system 4824 (such as a driver for interface circuit 4818) or in firmware in interface circuit 4818. Thus, the DAC techniques may be implemented at runtime of program instructions 4822. Alternatively or additionally, at least some of the operations in the DAC techniques may be implemented in a physical layer, such as hardware in interface circuit 4818.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the DAC techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A system, comprising:
an adsorber configured to adsorb carbon dioxide from air using a sorbent; and
a desorber, coupled to the adsorber, configured to desorb the adsorbed carbon dioxide from the sorbent into an output of the system, wherein the system is configured to continuously move the sorbent, as an ensemble, through the system, and
wherein the sorbent comprises a free-standing bulk solid.

2. The system of claim 1, wherein the continuous motion comprises steady-state operation of the system.

3. The system of claim 1, wherein the continuous motion excludes a batch process.

4. The system of claim 1, wherein the system is configured to perform multiple iterations of the adsorption and the desorption of the carbon dioxide without ceasing operation of the system; and
wherein a given iteration of the multiple iterations comprises a cycle of transit of the sorbent, as the ensemble, through the system.

5. The system of claim 1, wherein the sorbent is not included in a frame or a package.

6. The system of claim 1, wherein the desorber is separate from the adsorber.

7. The system of claim 1, wherein the sorbent is other than a liquid.

8. The system of claim 1, wherein the adsorber is configured to adsorb water from the air using the sorbent and the desorber is configured to desorb the adsorbed water from the sorbent into the output.

9. The system of claim 8, wherein the system is configured to provide the water to a data center or for irrigation.

10. The system of claim 8, wherein the system is configured to provide the water as potable water.

11. The system of claim 1, wherein the adsorber comprises a gravity-flow packed bed configured to move the sorbent in a direction having a vertical component while flowing the air at a non-zero angle to the direction.

12. The system of claim 11, wherein the adsorber comprises a distribution plate configured to spread out the sorbent in the gravity-flow packed bed.

13. The system of claim 11, wherein a flow of the sorbent through the gravity-flow packed bed is controlled by a valve at a bottom of the gravity-flow packed bed.

14. The system of claim 13, wherein the value comprises a rotary valve or a flip valve.

15. The system of claim 1, wherein the desorber comprises a device having a pressure other than atmospheric pressure.

16. The system of claim 15, wherein the device is oriented along a vertical direction or a horizontal direction.

17. The system of claim 15, wherein the pressure comprises between approximately 0.5 and 5 psi.

18. A method for adsorbing carbon dioxide from the air, comprising:
by a system:
adsorbing, using an adsorber in the system and a sorbet, the carbon dioxide from the air, wherein the sorbent comprises a free-standing bulk solid; and
desorbing, using a desorber in the system, the adsorbed carbon dioxide from the sorbent into an output of the system, wherein the system continuously moves the sorbent, as an ensemble, through the system.

19. The method of claim 18, wherein the continuous motion comprises steady-state operation of the system.

20. The method of claim 18, wherein the method comprises performing multiple iterations of the adsorption and the desorption of the carbon dioxide without ceasing operation of the system; and
wherein a given iteration of the multiple iterations comprises a cycle of transit of the sorbent, as the ensemble, through the system.
